(19) United States
(12) Patent Application Publication
(10) Pub. No.: US 2011/0287961 A1
(43) Pub. Date: Nov. 24, 2011

(54) EXPRESSION ANALYSIS OF CORONARY ARTERY ATHEROSCLEROSIS

(75) Inventors: David M. Seo, Pinecrest, FL (US); Pascal J. Goldschmidt, Miami, FL (US); Jennifer Clarke, Miami, FL (US)

(73) Assignee: University of Miami, Miami, FL (US)

(21) Appl. No.: 13/124,220

(22) PCT Filed: Oct. 14, 2009
(86) PCT No.: PCT/US09/60663

§ 371 Date: Aug. 12, 2011

Related U.S. Application Data
(60) Provisional application No. 61/105,191, filed on Oct. 14, 2008.

(51) Int. Cl. C40B 30/04; C40B 40/06

(52) U.S. Cl. 506/9; 506/16

(57) ABSTRACT

This invention relates, e.g., to a method for screening a subject for the presence of coronary atherosclerosis, said method comprising measuring the expression level of at least 5 of the genes of Table 2 in a biological sample obtained from said subject, wherein an elevated level of expression of said 5 genes compared to a control level measured in a population of normal subjects is indicative of an increased probability of the subject having significant subclinical coronary atherosclerosis. Methods for deciding on a treatment modality, based on a diagnostic procedure of the invention, are also described, as are kits for carrying out a method of the invention.

The instant application contains a Sequence Listing which has been submitted via EFS-Web and is hereby incorporated by reference in its entirety. Said ASCII copy, created on Oct. 14, 2009, is named 39532281.txt, and is 51,965 bytes in size.

This application claims the benefit of the filing date of provisional patent application 61/105,191, filed Oct. 14, 2008, which is incorporated by reference in its entirety herein.

### BACKGROUND INFORMATION

According to statistics from the American Heart Association, the death rates from atherosclerotic coronary heart disease (CHD) decreased by a third from 1994 to 2004. This remarkable reduction in mortality is attributed to technological advances in the acute treatment of myocardial infarction, preventive interventions such as statin, antihypertensive and antiplatelet medications and lifestyle modifications, particularly smoking cessation¹. Nevertheless, CHD remains the single leading cause of mortality and morbidity in the United States taking the lives of over 450,000 individuals annually and leave countless others with chronic heart failure². The aging of our population and the increasing prevalence of metabolic syndrome, obesity and diabetes portends acceleration in the enormous health burden from CHD in the coming years. The rising burden will occur in a health care system that is ill equipped to bear the ever increasing costs of diagnosing, treating and managing CHD.

One approach to reducing the burden of CHD is through the development of prospective preventive genomic medicine that identifies subsets of higher risk individuals to target for preventive interventions. Through the use of new molecular markers, higher risk individuals would be identified to receive preventive CHD interventions that ordinarily would not be availed to them under current medical guidelines. For an asymptomatic patient, a standard method for determining a prevention regimen is to categorize them as low, intermediate or high CHD risk using global risk assessment tools such as the Framingham Risk Score (FRS)³⁻⁶. Currently, there is considerable understanding of how to manage patients with low and high CHD risk^{4,7,8}. However, the majority of adults over the age of 20, which comprises 40% of the U.S. population, are within the intermediate CHD risk group⁹. The intermediate risk person, defined as having at least one major risk factor or a family history of premature CHD but no clinical evidence of coronary atherosclerosis, has a 10-20% risk for a CHD event in 10 years⁴. Current treatment guidelines do not advocate widespread diagnostic or intensive medical preventive treatments for this risk category^{4,7,10}. Nonetheless, within this risk group, there are likely to be a substantial number of patients whose individual CHD risk is much higher and would benefit from additional preventive interventions. Indeed, a number of expert panels have advocated for the development and study of novel approaches to further stratify individuals at intermediate CHD risk and identify a higher risk subset for more aggressive preventive strategies^{4,7,8,10}.

There is a need to identify new biomarkers that can be used for identifying a higher risk subset among the intermediate CHD risk category, and to establish susceptibility for the presence of coronary atherosclerosis.

### DESCRIPTION OF THE DRAWINGS

FIG. 1 shows Gene Network 1—The top gene network identified by the Ingenuity Pathways Analysis included 10 of the candidate genes. The gene network represents biological processes of cell growth and proliferation and cell-to-cell signaling.

The candidate genes are indicated by shading.
glutamate receptor, ionotrophic, AMPA 3 GRIA3
Kruppel-like factor 5 (intestinal) KLF5
follistatin FST
Fibronectin 1 FN1
integrin, beta 7 ITGB7
Fibronectin leucine Rich Transmembrane Protein 2 FLRT2
Complement component receptor 2 CR2
integrin, alpha 11 ITGA11
indolethylamine N-methyltransferase INMT
AE binding protein 2 AEBP2

FIG. 2 shows Gene Network 2—The second most significant gene network identified by the Ingenuity Pathways Analysis involved the biological process of cell cycle signaling and contained 8 of the candidate genes.

The candidate genes are indicated by shading.
neuronal pentraxin receptor NPTXR
zinc finger and BTB domain containing 16 ZBTB16
forkhead box G1/forkhead box G1A FOXG1B/A
cullin 5 CUL5
SRY (sex determining region Y)-box 6 SOX6
membrane associated guanylate kinase 1 MAGI1
myosin VA (heavy polypeptide 12, myoxin) MYO5A
galanin receptor 2 GALR2

### DESCRIPTION

The present inventors have identified biomarkers that can be used for identifying a higher risk subset among the intermediate coronary artery atherosclerosis risk category. The markers were identified by analyzing gene expression from samples (e.g., whole blood) from subjects, and correlating the expression of particular markers with susceptibility for the presence of coronary atherosclerosis. Coronary artery atherosclerosis is sometimes referred to herein as CHD (coronary heart disease) and sometimes as CAD (coronary artery disease).

In one aspect, the invention uses gene expression profiling of a biological sample (e.g. whole blood) to predict the presence of CAD. Thus, a method of screening a subject for the presence of coronary atherosclerosis, based on the expression levels of a selected set of genes in a bodily tissue, particularly whole blood, is provided. In one embodiment, a set of about 69 genes has been identified which are diagnostic or predictive (Tables 2 and 3).

For each marker in these tables for which genes have been identified, a unique Gene Symbol is provided, as well as the full name of the gene. Either of these identifiers is adequate to unambiguously identify these genes. Furthermore, the sequence (and the corresponding SEQ ID number) of a nucleic acid corresponding to each marker (e.g., a transcribed RNA, a cDNA or a genomic sequence) is also provided, as is at least one further indication of a publically available annotation concerning the gene (e.g., the cluster number, target sequence cluster description, Entrez Gene ID or other representative public ID, and/or probe set ID, which is available from the Affymetrix web site). Some of the sequences were obtained from the GenBank database (at the world wide web site ncbi.nlm.nih.gov/Genbank), and the GenBank Accession Numbers (e.g., NM_ numbers) are also provided in the table. Note that the sequences that are presented herein are correct as of the day of filing of this application. However, in GenBank, sequences are periodically updated by the NCBI to correct errors. As the sequences are curated, and new sequences replace previous sequences that contained errors, the replacement is described in the COMMENT section of the GenBank entry. Sequences that are subsequently corrected are encompassed by the present application. At any given time, only a single sequence is associated with each GenBank Accession Number. There is no indefiniteness, variability or uncertainty as to the sequence that is associated with any particular accession number at the time this application was filed. The sequences, and the GenBank accession numbers with which they are associated, are hereby incorporated by reference.

TABLE 2

| Predictor | | | | Entrez Gene | Representative |
|---|---|---|---|---|---|
| Name | ProbesetID | Gene Title | Gene Symbol | ID | Public ID |
| cluster_32 | 235238_at | rai-like_protein | RaLP | 399694 | NM_053017 |
| cluster_32 | 1555179_at | immunoglobulin_heavy_variable_7- | IGHV7-81 | 28378 | NM_032923 |
| | | 81 | | | |
| cluster_32 | 244278_at | — | — | — | BC032733 |
| cluster_32 | 1569962_at | Kazrin | KIAA1026 | — | BC021739 |
| cluster_32 | 1552524_at | ADP-ribosyltransferase_5 | ART5 | 116969 | W73431 |
| cluster_32 | 1555224_at | hypothetical_LOC554201 | LOC554201 | 554201 | BC043011 |
| cluster_32 | 244285_at | Chromosome_6_open_reading_frame_102 | C6orf102 | — | BC037834 |
| cluster_32 | 1558199_at | fibronectin_1 | FN1 | 2335 | BC039433 |
| cluster_32 | 207658_s_at | forkhead_box_G1B******* | FOXG1B | 2290 | BC041477 |
| | | forkhead_box_G1A | | | |
| cluster_32 | 204359_at | fibronectin_leucine_rich_transmembrane_protein_2 | FLRT2 | 23768 | AL110259 |
| cluster_32 | 217440_at | MRNA; _cDNA_DKFZp566A193_(from_clone_DKFZp566A193) | — | — | AK058123 |
| cluster_32 | 244775_at | Immunoglobulin_superfamily, | IGSF4C | — | AL831897 |
| | | _member_4C | | | |
| cluster_11 | 1563121_at | LOC440380 | — | — | AK093987 |
| cluster_11 | 244254_at | Transcribed_locus, | | | |
| | | _weakly_similar_to_NP_005474.1_chromatin_assembly_factor_1, | — | — | AL832577 |
| | | _subunit_A_(p150); | | | |
| | | _chromatin_assembly_factor_I_(150_kDa)_[Homo_sapiens] | | | |
| cluster_11 | 237398_at | Rho_guanine_nucleotide_exchange_factor_(GEF)_12 | ARHGEF12 | — | Y11718 |
| cluster_11 | 224061_at | indolethylamine_N- | INMT | 11185 | BC032004 |
| | | methyltransferase | | | |
| cluster_11 | 217041_at | neuronal_pentraxin_receptor | NPTXR | 23467 | BC014494 |
| cluster_11 | 244767_at | Transcribed_locus | — | — | NM_013231 |
| cluster_11 | 1569290_s_at | glutamate_receptor, _ionotrophic, | GRIA3 | 2892 | AL567411 |
| | | _AMPA_3 | | | |
| cluster_67 | 231992_x_at | CDNA_clone_IMAGE: | — | 493754 | NM_007281 |
| | | 5278284 | | | |
| cluster_67 | 234521_at | olfactory_receptor, _family_51, | OR51I2 | 390064 | NM_006006 |
| | | _subfamily_I, _member_2 | | | |
| cluster_67 | 230819_at | KIAA1957 | KIAA1957 | 126567 | NM_004471 |
| cluster_67 | 1563145_at | hypothetical_protein_MGC39681 | MGC39681 | 283197 | AF132818 |
| cluster_67 | 242411_at | ADP-ribosylation_factor- | ARL10A | 285598 | AF080586 |
| | | like_10A | | | |
| cluster_67 | 228422_at | CDNA_clone_IMAGE: 5300488 | — | 375323 | AB032968 |
| cluster_67 | 209211_at | Kruppel- | KLF5 | 688 | AL049268 |
| | | like_factor_5_(intestinal) | | | |
| cluster_67 | 216126_at | — | — | — | AK022418 |
| cluster_67 | 205475_at | scrapie_responsive_protein_1 | SCRG1 | 11341 | AF070602 |
| cluster_67 | 223474_at | chromosome_14_open_reading_frame_4 | C14orf4 | 64207 | AL162057 |
| cluster_67 | 238515_at | Nudix_(nucleoside_diphosphate_linked_moiety_X)- | FLJ31265 | — | Z22957 |
| | | type_motif_16 | | | |
| cluster_67 | 228854_at | Transcribed_locus | — | — | AL049342 |
| cluster_67 | 204995_at | cyclin- | CDK5R1 | 8851 | NM_017669 |
| | | dependent_kinase_5, _regulatory_subunit_1_(p35) | | | |
| cluster_67 | 205883_at | zinc_finger_and_BTB_domain_containing_16 | ZBTB16 | 7704 | NM_016364 |
| cluster_67 | 219963_at | dual_specificity_phosphatase_13 | DUSP13 | 51207 | NM_025005 |
| cluster_67 | 233126_s_at | thioesterase_domain_containing_1 | THEDC1 | 55301 | AF109681 |
| cluster_75 | 215515_at | Kin_of_IRRE_like_(Drosophila) | KIRREL | — | AI932310 |
| cluster_75 | 1567540_at | sperm_associated_antigen_10 | SPAG10 | 4240 | AF128846 |
| cluster_75 | 233958_at | Clone_IMAGE: 112577_mRNA_sequence | — | — | BF438173 |
| cluster_75 | 215326_at | p21(CDKN1A)- | PAK4 | 10298 | AL540045 |
| | | activated_kinase_4 | | | |
| cluster_75 | 235184_at | AE_binding_protein_2 | AEBP2 | 121536 | AI492388 |
| cluster_75 | 226847_at | follistatin | FST | 10468 | BF448201 |
| cluster_75 | 222899_at | integrin_, alpha_11 | ITGA11 | 22801 | AI039029 |
| cluster_75 | 242883_at | otospiralin | OTOS | 150677 | AW303321 |
| cluster_75 | 232577_at | hypothetical_protein_LOC145945 | LOC145945 | 145945 | AK024371 |
| cluster_75 | 239693_at | Sorting_nexing_24 | SNX24 | 28966 | AK024323 |
| cluster_75 | 243288_at | — | — | 56950 | AL137758 |
| cluster_10 | 241451_s_at | Transcribed_locus | — | — | AI500353 |
| cluster_10 | 1560692_at | hypothetical_protein_LOC285878 | LOC285878 | 285878 | AK001844 |
| cluster_10 | 219650_at | FLJ20105_protein | FLJ20105 | 54821 | AF143330 |
| cluster_10 | 1560511_at | — | — | — | AF137396 |
| cluster_10 | 1561055_at | CDNA_clone_IMAGE: 5303550 | — | — | AI580966 |
| cluster_10 | 1562455_at | Aryl-hydrocarbon_receptor_nuclear_translocator_2 | ARNT2 | — | BF676462 |
| cluster_10 | 217417_at | myosin_VA_(heavy_polypeptide_12, | MYO5A | 4644 | AI807169 |
| | | _myoxin) | | | |
| cluster_10 | 232418_at | leucine_zipper_transcription_factor- | LZTFL1 | 54585 | R58954 |
| | | like_1 | | | |
| cluster_10 | 241542_at | SRY_(sex_determining_region_Y)- | SOX6 | — | AA890487 |
| | | box_6 | | | |
| cluster_10 | 231333_at | — | — | — | BF687577 |
| cluster_8 | 236810_at | Integrin, _beta_7 | ITGB7 | — | AI272805 |
| cluster_8 | 211226_at | galanin_receptor_2 | GALR2 | 8811 | BF508746 |
| cluster_8 | 1563881_at | — | — | — | AW016576 |
| cluster_8 | 1564070_s_at | CDNA_FLJ36668_fis, _clone_UTERU2003926 | — | — | AA693937 |
| cluster_8 | 230393_at | Cullin_5 | CUL5 | 8065 | AI743173 |
| cluster_8 | 232881_at | GNAS1_antisense | SANG | 149775 | AW772596 |
| cluster_24 | 220718_at | hypothetical_protein_FLJ13315 | FLJ13315 | 80072 | AW135582 |
| cluster_24 | 244097_at | Complement_component_(3d/ | CR2 | 1380 | AA815055 |
| | | Epstein_Barr_virus)_receptor_2 | | | |
| cluster_24 | 216214_at | Clone_24504_mRNA_sequence | — | — | BE465298 |
| cluster_24 | 1553747_at | hypothetical_protein_MGC16025 | MGC16025 | 85009 | AW627953 |
| cluster_24 | 240342_at | tripartite_motif- | TRIM61 | 391712 | BE220569 |
| | | containing_61 | | | |
| cluster_24 | 237000_at | Transcribed_locus | — | — | AA505135 |
| cluster_24 | 1566030_at | — | — | — | AW135556 |

TABLE 3

| Predictor | Probe | | Target Sequence |
|---|---|---|---|
| Name | Set ID | Target Sequence | Cluster Description |
| cluster_ | 235238_ | Atatgtatgcacggatgtcactttttaaggccatattgcattgataacaagctaa | /FEA = EST |
| 32 | at | aagcacaactaaaatttcacatgctaacgacaacttgaatgaactgctggggc | /CNT = 17 |
| | | agtggtatgtgcctttcaacttgataanttgggggacattttcatattgggagatt | /TID = |
| | | aattctaagtatcttcatgttctatgactatagaaccatttgccaaaaaaaaaag | Hs.219907.00.01 |
| | | cttttcttgctacaaaaaataagcaattttcttgagccttattgactttattacatttt | |
| | | ctgtttagcagcatttttcactgcaatgttaaaataaatatgacattgaattcgaa | |
| | | ctgtgtgtatgtcagtgganatcaaatcaaaagccactaacatggctgtctgttt | |
| | | cactggactgtcccatttgctggttaaaaggattggggcccaaatcctctggc | |
| | | ctagcatttctcagtgtttgctattcagactgtctaaatacagcatgtgacaagct | |
| | | gaagaagccaaatctancagtcatttctgatttcattatattctccccct | |
| | | (SEQ ID NO: 1) | |
| cluster_ | 1555179_ | Gacgggtgctcataagagatccttaacttgcccattttaatgggttttccagaa | /TID = |
| 32 | at | gatgtgagaagccactttgttagcaaagcatgccaaagccatgccctgctcc | iHs.375094.1 |
| | | agacacatgtgagcccatttcctgctctttgcttaactgacaagctctcatcagt | /CNT = 2 |
| | | gcacctgggttaatttcacatcaggtacaggaatatgttctaaaggaaagctaa | /FEA = FLmRNA |
| | | ttttataatagcaattcctgcttaataaccttcagcttcattgtttttgtgtaatctatc | /FL = |
| | | aacaaattatgttagttcaaggttctcaatgggagtttctaataaatagaaggga | gb: BC032733.1 |
| | | tgtatagaagttcccctaattaaaacaattgtgaacacaatcttggtattcagct | |
| | | gtgtctccacccttcttaccattcaccacaaagtaattctcacttctggaagctg | |
| | | ggttcatttt | |
| | | (SEQ ID NO: 2) | |
| cluster_ | 244278_ | Catggggatcagtgtgggctgtgctggtcaaggagggcttccagggagag | /FEA = EST |
| 32 | at | gcaactganggattcactgcaattgttccttgagaagatgaggatcaggtcg | /CNT = 3 |
| | | ggaattggaaacatctgagggctcaattcaacctggcttctaaaacgaacatg | /TID = |
| | | gtgaacatagatcaactactgaacttcttttaacctctggcatcctatctgtgaat | Hs.192809.00.01 |
| | | tgtggggaggaaacagggtccacccgctgctgcacaagaggggtgtgtgc | |
| | | agaccgtcaccttgtgtctgctgtagcaggagacccctggccatgcgggact | |
| | | gaacccatgattgcagctgatcttactctgtct | |
| | | (SEQ ID NO: 3) | |
| cluster_ | 1569962_ | Gggaggtcctcgcacatgaccttgtctggtagctgcagtttgtccctcgtntg | /TID = |
| 32 | at | tgccacactttgnaccancaccttcaacagctacctattgaggcccnatctag | iHs.352252.1 |
| | | gtgctggtgcnatcnatggttctgtcttgacatctgggacagcaggctttcctg | /CNT = 3 |
| | | gagcctcatgtacctgccttcccacacaagctcagaggagcagtttagcattt | /FEA = mRNA |
| | | ctcagtgactcggggtcaccctgggaacagtcatctttgtactttagaaaatgg | |
| | | cagctg | |
| | | (SEQ ID NO: 4) | |
| cluster_ | 1552524_ | Ggactctgtccgcttgggccagtttgcctccagctccctggataaggcagtg | /TID = |
| 32 | at | gcccacagatttggtaatgccaccctcttctctctaacaacttgctttggggccc | iHs.125680.2 |
| | | ctatacaggccttctctgtctttcccaaggagcgcgaggtgctgattcccc | /CNT = 9 |
| | | (SEQ ID NO: 5) | /FEA = FLmRNA |
| | | | /FL = |
| | | | gb: NM_053017.1 |
| | | | gb: BC014577.1 |
| cluster_ | 1555224_ | Ggttttacttctaatgcttccatcggaggacaacaatggttacattgacttaaga | /TID = |
| 32 | at | tctgatgcaaatgtttaccttttggggtctgtcataccatgaagcaaacagaca | iHs.374705.1 |
| | | gaaaagaaggaaacagatggcacactgaaaattaggataagttaagaagaa | /CNT = 2 |
| | | tgtaataagcggacaaccgacaaaggagggtgggaatgcagggcaaccg | /FEA = FLmRNA |
| | | caagggctcatacagtgctgggtgaggaggacccctgacgggagctgaga | /FL = |
| | | tctttggtgaaggacacaactggtcagtacaaccctgcagggcaaggagctg | gb: BC021739.1 |
| | | cagaaacaactatccaaaccccacacctctccctcaccttgatctcccatgttc | |
| | | cacttcggctgaaccaaaccaaaagccagagggcaaggaagccatgtgtg | |
| | | aaaactgtgctac | |
| | | (SEQ ID NO: 6) | |
| cluster_ | 244285_ | Gccccgtggtcactgaaaagccagaatgaatattcttcctttcggaataaaaa | /FEA = EST |
| 32 | at | ttgagctgtggaagttttgtttgctttgatgaattacttccaggctgctgtttatttg | /CNT = 3 |
| | | gagagcaaagctccccagctgcagggtgggtagaggctgcggtcactccc | /TID = |
| | | ctcgtcaatgctggttcctgttcctgaggccgagagaactcctgacagcaga | Hs.253425.00.01 |
| | | gtgggcatatcttggtagancagcttttcaagacagtgtggcccagtgggga | |
| | | gagagcagaaaacctgggttatgctggctctgccatttatcagctgtgtaacct | |
| | | tgggcaagtgatacaacctctgtgtgcctcagtttcctttcctcacctgtccaca | |
| | | ggggatcataatcttggccctgcatgccttacaggagcgtt | |
| | | (SEQ ID NO: 7) | |
| cluster_ | 1558199_ | Gtatcctagtgacagcataaaccctagaggtgacagtctgtattattgcttttcg | /TID = |
| 32 | at | cttctcttttctgcttctgttgggagccagttttcttcttacgccgcattacagaga | iHs.424388.1 |
| | | gaacgtcaaatttagcagccatatctgccatagggtccaaataaagagacaat | /CNT = 12 |
| | | aaaaacattattctctcttttttggatggaatactgcgtgaaatggttatccataca | /FEA = mRNA |
| | | aagatactttatgtagaatagaaaaaggaggccgggtgcagtggctcacaca | |
| | | tgtaatcctagtgctttgggaggctaagccgggagcactgattgaggccagg | |
| | | agttcatgatcagcctgggcaatgaagtgagaccccgtctctacaaaaaaata | |
| | | tgaaaaaattagcgaggtgtggtgacacatgcctgtagtcccagctactcaag | |
| | | aggctgaggtagaggatcacttgagcctacgagttcaaggctgcagtgagct | |
| | | atgataactccactgcactgccgcctggatgacacagagagaccgtttcta | |
| | | (SEQ ID NO: 8) | |
| cluster_ | 207658_ | Tgagttacaacgggaccacgtcggcctaccccagccaccccatgccctac | /FEA = FLmRNA |
| 32 | s_at | agctccgtgttgactcaaaactcgctgggcaacaaccactcctcctccaccg | /FL = |
| | | ccaacgggctgagcgtggaccggctggtcaacgggggaatcccgtacgcc | gb: NM_004471.1 |
| | | acgcaccacctcacggccgccgcgctaaccgcctcggtgccctgcggcct | /CNT = 4 |
| | | gctggtgccctgctctgggacctactccctcaacccctgctccgtcaacctgc | /TID = |
| | | tcgcgggccagaccagttactttttcccccacgtcccgcacccgtcaatgact | Hs.169277.00.01 |
| | | tcgcagagcagcacgtccatgagcgccagggccgcgtcctcctccacgtcg | |
| | | ccggcaggcccccctcgacccctgccctgtgagtctttaagaccctctttgcc | |
| | | aagttttacgacgggactgtctgggggactgtctgattatttcacacatcaaaat | |
| | | caggggtcttcttccaaccctttaatacattaacatccctgggaccagactgta | |
| | | agtgaacgttttacacacatttgcattg | |
| | | (SEQ ID NO: 9) | |
| cluster_ | 204359_ | Ccttctctgatttcttcagcagggtcaaaagacagttactagcaatggggaat | /FEA = FLmRNA |
| 32 | at | gcttgtcactgtggagaaagagttttgtatatgtctgataccgttgttataacaaa | /FL = gb: AB007865.1 |
| | | acaaatttttttactatagttttttgttttctacctgcacacccaccagaagagcac | gb: AF169676.1 |
| | | aaagcaaggccattgcaacaggcatttaaaaattattatcaaacatgcacatg | gb: NM_013231.1 |
| | | cttgtacacacacacacacacacacacaaacaggggcatttgtaaaggtgtc | /CNT = 86 |
| | | cctggaatgtaagatttataatgtttaaggcaaggtgaaggcattgccaagtgt | /TID = |
| | | gtgtcgctcataggactagtgtatattcactgaaagttaacctgatgatttgttat | Hs.48998.00.02.00.01 |
| | | tgtttgaaccatatgctgatttgcttctggtttctgtttagtgtgttctctctgataag | |
| | | gggctgaaagattctgcatcacacatcctctgagacctaccatgtcgcacact | |
| | | ttgttaatgacaaacttcactctacactatacagtaccttgt | |
| | | (SEQ ID NO: 10) | |
| cluster_ | 217440_ | Aagtcagctaattgttatgtgtcatttctttctagattttgtagtttttgtttgtttgttt | /FEA = mRNA |
| 32 | at | tacattcaatgatttagaagatttggggcttattgtggtttcttaaatattataactc | /CNT = 1 |
| | | tatttcaaaactattctgctatgttgagctatcttatttcatactgtattttaatatgtt | /TID = |
| | | aggacagttctctccttacgactttcttttgcaaaaattttctagctacactcatttg | Hs.274506.00.01 |
| | | gatattcttcatgatgaactctgagataattttaacacattccaaaagacatatttt | |
| | | tgagacttattagaattttgttaaagatactgatttatttccaaagaattacagaat | |
| | | ctaatcttttcatctatgtatctctattgaagcatttgttta | |
| | | (SEQ ID NO: 11) | |
| cluster_ | 244775_ | Aaaatggcgcaaatgcaccccatctcccccgattcctgctggntgggcaag | /FEA = EST |
| 32 | at | atggggaaatggcgcaaatgcaccccatctcccccatctccccatcttgccc | /CNT = 6 |
| | | aggaactccaagacatcaagatttcacgatttttaagacgtcaagatgctagc | /TID = |
| | | atgctaacaccatcacggttctagaactttaaaggtgtcaagattctaaagcctt | Hs.197583.00.01 |
| | | ctggattctagaatcctgtagatgtcagcattctaaagtaccatcaggttctttat | |
| | | ttactggattcattagttccaggattctatgagcctggtgtttagcc | |
| | | (SEQ ID NO: 12) | |
| cluster_ | 1563121_ | Ggcatttccattccagagtgcatcacttcaaaccttacattcctgaggctgttc | /TID = iHs.383803.1 |
| 11 | at | gtcgaaggcttctcacatctaaactgcagttcatttattgcagagccctgttcac | /CNT = 2 |
| | | atgggttctcagagacgttttcattctcgcttctcaccacgctggagatgagaa | /FEA = mRNA |
| | | ctagatgtggttttctagatacagtctacatttccctttgaatctggaagtccggc | |
| | | ttcaaggtgatccacaaacatccgagaaggaaagaaacttagaggtaaatga | |
| | | ttcaatgattcttaaaacctgactgtggcactcttctccaaatacctctgttctcct | |
| | | ccatatttctcagcccctttgaagaggcaggcccatgggatgaattctgacca | |
| | | atggatttggctaagatttaagagccagtgcaccatccttcagctaactcttctc | |
| | | tccacctgctgcaaggacataaacatttcaatggcacaaagatagagcacctt | |
| | | gaattgttactgcaaagaagacatcttttctggagagtcacccaa | |
| | | (SEQ ID NO: 13) | |
| cluster_ | 244254_ | Cctcctgagaacatgccctgacagaatgaccaatcntggtgtatgtgtgtag | /FEA = EST |
| 11 | at | aatgattagattatccccaagcaaatatcagatacttgaatgtactaagatttctg | /CNT = 3 |
| | | ggtatagtatactttgtcctccttcacaggcatcctcagaggtttggaaagtttn | /TID = |
| | | atataggatgcttgattagtcctttctgatatttgtaaacatttcccaataaagctg | Hs.244339.00.01 |
| | | catattcatctgtcctttaataaagcactattgaaatatgatgacatatagggaaa | |
| | | gcctgtttgtgctctacaggcttgtgaaaaggtgctagaatcaaatacttgaaa | |
| | | atgagttgaaacatcagagacaccccataagccatatgtggcatgggcatct | |
| | | gaacctaatg | |
| | | (SEQ ID NO: 14) | |
| cluster_ | 237398_ | Ttaaccttacctgctttccaagagagattttatgttttcttggttttttttttttgtttgt | /FEA = EST |
| 11 | at | ttgtttgtttttagggtagggtcttgtagaatgcaatggtgcaattatagctcact | /CNT = 6 |
| | | ncngcctccaacttctgggttcaagtgatcctcccaccttgttttttgttttttgttt | /TID = |
| | | tgtcttgtttttttggtngagacagggttttgctgtgttccccaggctgctgtcaa | Hs.24598.00.01 |
| | | actcctgggctcacccatctcngcctcctaaagcgctgggattacaggcacg | |
| | | agccactatacctggccaagattttatattttctaattgcttcacatactgaatgg | |
| | | aaaatagcatgacagttataacagaagtaaagaaagtcacatgagagtccac | |
| | | cacctaaaatataacttcct | |
| | | (SEQ ID NO: 15) | |
| cluster_ | 224061_ | Catggaacatgcttaatctaaacaatgatttgttgttcacctgaaattcaaattta | /FEA = FLmRNA |
| 11 | at | gctgggtgtcctgtatttcatctggcaaccctacttcagacccaggtgtaaggt | /FL = |
| | | acatggatgtgctttggtcaaggaataggccaaggcagagatccatgcctgc | gb: AF128847.1 |
| | | atgactcagtgggtttggtgcacaggcacacacctccacttgttatataacctg | gb: AF128846.1 |
| | | tttgtgtaagttcatacttggtctgagccactgttgtctgtaaaaggtaattgtcct | gb: NM_006774.2 |
| | | gctaatgctgtacaggggctcttggggttcggctcagctcaacatggcttgac | /CNT = 6 |
| | | atggtgggcacactggcgcccagtaagag | /TID = |
| | | (SEQ ID NO: 16) | Hs.204038.00.01 |
| cluster_ | 21704l_ | Acaactccagtgcagtgccaggtgggcaggctcccactgttcacttgagac | /FEA = mRNA |
| 11 | at | gctcctccccactcaggtggggacaggggacacactcgcagggcagggc | /CNT = 1 |
| | | attctggaggtgtgggtacaggtgaggggaaatgggaggcacagccagga | /TID = |
| | | gtggggcaggagggaaggccagtgcgtgggcaggctgaggagggaatat | Hs.91622.00.02 |
| | | gacccccctcaagtccccaaagtggcaggcaagggaggggccctggatga | |
| | | ggtggcccctcatgccttggccctccccttgcagacatcgaaggcagcctttg | |
| | | ttgcacccccaaaggcctccaccaacttgtcttcccagggaaggacgttgcc | |
| | | cagcagtggcgcagtgcagttggcaatgcccaggacctgggctggtgtcag | |
| | | ggcgtggtcccacaggttaaactgggcaatgtcaccgacaaaggcctgggt | |
| | | ggcatcaaaccggccacccagggtatcctgggccaa | |
| | | (SEQ ID NO: 17) | |
| cluster_ | 244767_ | Gcaagggtctatgaaggtgtttcaggagatccaagcctttttagaatctgtgc | /FEA = EST |
| 11 | at | aaacttctgtgtatgttttttggaggaaaagtccataaatttcaaattttcaaaaat | /CNT = 5 |
| | | cagattttcaaaaggatttattgatttctgaaaactagcaaagatctgcttttataa | /TID = |
| | | agagcaaatagatggatagatataggagaagatgcttgacttgatgaataag | Hs.44037.00.01 |
| | | agaaaggacatatagaaaatgaactgaacataagcaagtattttattgaagat | |
| | | atactattttaaataacatttaaacacggaatgattggcaataaactgcaaaatg | |
| | | agtaatttggtatcattttaaaatggttattatcagagattttccttttattaaacagt | |
| | | tattcattaattccacaaatatttatcaggcttctattatatgtgaggcactgagct | |
| | | gggcatggctgtaaaggaaccatctaggaagtaattatgcaatcatttctgaa | |
| | | cctgtttcagaaaagtaaatcagtgttgggtttatcagtgttt | |
| | | (SEQ ID NO: 18) | |
| cluster_ | 1569290_ | Acaccaaccagaacaccaccgagaagcccttccatttgaattaccacgtag | /TID = iHs.382602.1 |
| l1 | s_at | atcacttggattcctccaatagtttttccgtgacaa | /CNT = 5 |
| | | (SEQ ID NO: 19) | /FEA = mRNA |
| cluster_ | 231992_ | Agcagaggctggtgcaaccaatcacctcctttagtaagtttctccctgggctt | /FEA = mRNA |
| 67 | x_at | cacctcttcacctgtgggctttccacctgtctctctctttttttttttaagacagtctc | /CNT = 13 |
| | | ctctgttgccaggctggaatgccgtggcgcagtctcggctcactgcaacctct | /TID = |
| | | acctcctgggttcaagcgattctcctgcctcaggctcccaagtagctgggatt | Hs.129013.00.02.00.01 |
| | | gcaggtgcccgccaccacaccgggctaatttttgtatttttagtagagtcggg | |
| | | gtttcaccatgttgcccaggctggtctcgaactcctgaccttacgtgatcctca | |
| | | cgcctgtaatcccagcactgtgggaggctgagacgggcagatcaccctggc | |
| | | cagcatggcaaaaccccatctctactaaaaatacagcaattagccgagtgtg | |
| | | gtggcgggcacctgtaatcccaactactcaagaggttgagacaggagaact | |
| | | gcttgaacccggaaggca | |
| | | (SEQ ID NO: 20) | |
| cluster_ | 234521_ | Ttgcgctatgcaactgtgctcaccactgaagtcattgctgcaatgggtttaggt | /FEA = DNA_3 |
| 67 | at | gcagctgctcgaagcttcatcacccttttccctcttccctttcttattaagaggct | /CNT = 1 |
| | | gcctatctgcagatccaatgttctttctcactcctactgcctgcacccagacatg | /TID = |
| | | atgaggcttgcctgtgctgatatcagtatcaacagcatctatggactctttgttct | Hs.302170.00.01 |
| | | tgtatccacctttggcatggacctgttttttatcttcctctcctatgtgctcattctg | |
| | | cgttctgtcatggccactgcttcccgtgaggaacgcctcaaagctctcaacac | |
| | | atgtgtgtcacatatcctggctgtacttgcattttatgtgccaatgattggggtct | |
| | | ccacagtgcaccgctttgggaagcatgtcccatgctacatacatgtcctcatgt | |
| | | caaatgtgtacctatttgtgcctcctgtgctcaaccctctcatttatagcgccaa | |
| | | gacaaaggaaatccgccgagccatt | |
| | | (SEQ ID NO: 21) | |
| cluster_ | 230819_ | Tttggggaggtttccagctcagaatgatgcagaaatgataagactcaaagca | /FEA = EST |
| 67 | at | ggggccaggccaggccagtnccttcgcctctcccggctgctggtgggcac | /CNT = 12 |
| | | ggaggaaccagggcacatctgtggtacccagggacgtcccttgtcagcccg | /TID = |
| | | tttgccacacattgttcctcttgtccaggggagggtggaggagctgcttccca | Hs.223770.00.01 |
| | | ggactggaggagcagctgggcccctgctgcacgtccggtgggacacacct | |
| | | gtgagccctccagagggagagtgcaggccccttctgagcctggtgttgcag | |
| | | ggctccgctctctcccggaagccagggcacccagggcggaggctcctcag | |
| | | gccggggaggcggggagggtgccctgcatggagagagacgccggcgct | |
| | | ccccgccttctntgatgctcacccctcccaggcccngttctccctggggtccc | |
| | | ccgtttantagcccccctgcactctttgatatcttagtgtctgaggttgactgtg | |
| | | ggtaaatctttaagacactccccagctgtgtttgtttataa | |
| | | (SEQ ID NO: 22) | |
| cluster_ | 1563145_ | Gaaactattcagtggccacatgtacccagtaacagagggagcaaagcaaat | /TID = |
| 67 | at | cttatcctcaaagaactgncagctgcttgttagatctacctggtggttccataga | iHs.130474.1 |
| | | gaaactgctcagagaacctgcctttacctcgcctaaaacagaactatcccgg | /CNT = 2 |
| | | agctcagcaaaggagtccattcatcctctataactgctatacaatatctcngtta | /FEA = mRNA |
| | | aaatgctgagaagatttatcctnaaaagaaggcaccaaagcaatggggttca | |
| | | tcaactcagg | |
| | | (SEQ ID NO: 23) | |
| cluster_ | 242411_ | Cacaaactccttccagtagaagcgcaggttctggctgcccccaatttctagca | /FEA = EST |
| 67 | at | ggtccacctcaaagtccttggtgggcagacgcacggagttgaanccccagg | /CNT = 5 |
| | | tggggatgtggccttccagcggtggcttccccgacaacacgcgcaggaacg | /TID = |
| | | tgctcttgcctgcgccatccagccccagcaccagcacctcgcgntgttccag | Hs.169095.00.01 |
| | | ctcctccagcgccggctcctcgtcctcctcgtcctcggggtcccactcgtccc | |
| | | actcggggaggcgggcagcctccgcgccccaccaggcctctccccggtcc | |
| | | cagcnccgctctcggccgcggccgaagtaggt | |
| | | (SEQ ID NO: 24) | |
| cluster_ | 228422_ | Ggtcagttgagtccttctgggaaccggggctatgaaaactttcgtctttgggg | /FEA = EST |
| 67 | at | accggtacccatgaaggaaaactttcctgagggggtgaggaccaaagaatc | /CNT = 22 |
| | | aagatccttttcaggcctgatagccaagatgatgagaacttttagataaggctg | /TID = |
| | | tggggagagtccctggccttttgagcatcctgcttgggcacacggggaataa | Hs.56782.00.01 |
| | | cctactccagcttccagtgtgaactgagaaagagaaagggaaaccctgtcttt | |
| | | ggagaagctgggatcttcccagcaccagaaacttctgcaggcccctgcctg | |
| | | gcccacggctaacctttgggtgggactggagtttcctgaacagggaacaag | |
| | | ggagccttccgcagagctctgatgggcaggcctccgagggcctgtgctgtg | |
| | | tgctgttaggatagcttggtgttgtctataccccattagtaagttttgtctgagtgt | |
| | | gtcctcgctgttcattgtctaatttggtaacatttattttggtcctgaccccttctgc | |
| | | tgctgctgggtttaagcttcagt | |
| | | (SEQ ID NO: 25) | |
| cluster_ | 20921l_ | Ttacagtgcagtttagttaatctattaatactgactcagtgtctgcctttaaatata | /FEA = FLmRNA |
| 67 | at | aatgatatgttgaaaacttaaggaagcaaatgctacatatatgcaatataaaat | /FL = |
| | | agtaatgtgatgctgatgctgttaaccaaagggcagaataaataagcaaaatg | gb: AF132818.1 |
| | | ccaaaaggggtcttaattgaaatgaaaatttaattttgtttttaaaatattgtttatct | gb: AF287272.1 |
| | | ttatttatttgggggtaatattgtaagttttttagaagacaattttcataacttgataa | gb: AB030824.1 |
| | | attatagttttgtttgttagaaaagtagctcttaaaagatgtaaatagatgacaaa | gb: NM_001730.1 |
| | | cgatgtaaataattttgtaagaggcttcaaaatgtttatacgtggaaacacacct | gb: D14520.1 |
| | | acatgaaaagcagaaatcggttgctgttttgcttctttttccctcttatttttgtattg | /CNT = 158 |
| | | tggtcatttcctatgcaaataatggagcaaacagctgtatagttgtagaat | /TID = |
| | | (SEQ ID NO: 26) | Hs.84728.00.01 |
| cluster_ | 216126_ | Cagcaccacacttgtggctttccagggtttagcatctgtagatgctctcaagg | /FEA = mRNA |
| 67 | at | gctggccttgagtacttgtagctttttcaggctgagagtgcaagctgccagtg | /CNT = 2 |
| | | gatctaccattatgatgtcaggaggacagtggttctcttctcatagctccactag | /TID = |
| | | gaagtgctccagtgggactctgtgtgggggctccaaccccacatttcccctcc | Hs.306635.00.01 |
| | | acactgccctggtagagattctccatgagggttccactcgtgcagcaggcttc | |
| | | tgcgtggacatccagacttttccctgaatcttcctaaatctaggtgaaggtttcc | |
| | | aagcttcaactcttgcactttgcactgcaatggtagtgcaggtccactgaacca | |
| | | tcaaagaccaggtacatgcctctgcctggtgttctcaactcatccaccagtgtg | |
| | | gagctgtcatcccacttttcattacggtcatcatcgctgcc | |
| | | (SEQ ID NO: 27) | |
| cluster_ | 205475_ | Tttgcccaaactcacccagtgagtgtgagcatttaagaagcatcctctgccaa | /FEA = FLmRNA |
| 67 | at | gaccaaaaggaaagaagaaaaagggccaaaagccaaaatgaaactgatg | /FL = |
| | | gtacttgttttcaccattgggctaactttgctgctaggagttcaagccatgcctg | gb: NM_007281.1 |
| | | caaatcgcctctcttgctacagaaagatactaaaagatcacaactgtcacaac | /CNT = 81 |
| | | cttccggaaggagtagctgacctgacacagattgatgtcaatgtccaggatca | /TID = |
| | | tttctgggatgggaagggatgtgagatgatctgttactgcaacttcagcgaatt | Hs.7122.00.01 |
| | | gctctgctgcccaaaagacgttttctttggaccaaagatctctttcgtgattcctt | |
| | | gcaacaatcaatgagaatcttcatgtattctggagaacaccattcctgatttc | |
| | | (SEQ ID NO: 28) | |
| cluster_ | 223474_ | Ggtgaaagcttccttctaaactgccccaagtgttgaagtcttcactttattttgtt | /FEA = FLmRNA |
| 67 | at | ctgttttgttttgtttttctgttttgtttgcaaaatggtaagggggtgtcggggggg | /FL = |
| | | atggggtgtattttgttgcaagtttgtgaggggaaaatgttttggtttgtttctact | gb: AF063597.1 |
| | | gacctgaatgtgttggatctacacgtgttgttttgtttttgctttattgatgcacgg | /CNT = 44 |
| | | atgcttttgaacagtagagcgaaatgctagacatggagaatctgctctgtttgt | /TID = |
| | | cctttatacatttctgtagttaacagaacactgtaatgtgccttggagcttagtaa | Hs.179260.00.01.00. |
| | | cttgta | 02.00.01 |
| | | (SEQ ID NO: 29) | |
| cluster_ | 238515_ | Catctcactcacatagacagtctctgggtaggcaggtggggggtgatacaa | /FEA = EST |
| 67 | at | gttcacactctgtgtttctcctcctgttagccattcccaccctgctgatgtttaag | /CNT = 9 |
| | | gaaagccagggatgatgacccacttaagctttccttggccttgttaagtccaat | /TID = |
| | | catctggggcaggaagaagagaaatgctcattgcaatctttgacccccacta | Hs.117897.00.01.00. |
| | | actgctgtggtgactttgacccaagcccttgacctccttttccttatctgaaatgt | 01.00.01 |
| | | tgctgtgattcctgtggtgagatcagatgaggcagcacttgggataagcttgc | |
| | | agagatgcattgagcggtatgaaagtacaggatgctatgtactttcctgcttca | |
| | | cagcacattttgtttcttgcaaggtgagtggcccagccgcctctccacaaaca | |
| | | cgtgtttctgcctttctcagcataatcagcaaga | |
| | | (SEQ ID NO: 30) | |
| cluster_ | 228854_ | Ctccttatctgttctagttccgaagcagtttcactcgaagttgtgcagtcctggtt | /FEA = EST/CNT = 19 |
| 67 | at | gcagctttccgcatctgccttcgtttcgtgtagattgacgcgtttctttgtaatttc | /TID = |
| | | agtgtttctgacaagatttaaaaaaaaaaaaaaggaaaaaaaaagaaaaaat | Hs.117176.00.04.00. |
| | | gaatttactgctgcaggtttttttctctctccatgtgtcactaagtgaagtttgtgc | 01.00.01.00.01 |
| | | cttctatagcaaagagaatattttttacatcctactaacagtagatttttttgtagtg | |
| | | aacattttttgtatttttatttataagtctcataagaaaaatagcaatgttcagttgta | |
| | | taccttgaatctgcagttaga | |
| | | (SEQ ID NO: 31) | |
| cluster_ | 204995_ | Gcttttacggtgatattgtgcatgcaaaccaggagcatttngtgtcttaagaaa | /FEA = FLmRNA |
| 67 | at | aataatcttagaacagatggctgtgaaaattacacccatgcacagaacaagc | /FL = |
| | | cacaggaataatagttcaggatttggtttttctctttttcttgtaaacctggagggt | gb: NM_003885.1 |
| | | tgatatattctttccatgcagttattagaacttagttttgttccaacagttaaacttg | /CNT = 84 |
| | | caatgaaaagaaaatgtgccatttttttcactcagaattattcatagctgtatattt | /TID = |
| | | gaaactgctaattacacacgtgtgatgtatgttggttttttagtgcaatttcttctgt | Hs.93597.00.01 |
| | | agctattctttgaccaaactgtgggtattgttaatattaatttatatttgtctcatttt | |
| | | gtatgtatgtgtagtgtgtttgtgagtatgtgtggtttataatctgacaaagtcatg | |
| | | aagctcagtttggctgtaatttaattccccttcccttatttttatttatttttgtactgt | |
| | | gctgat | |
| | | (SEQ ID NO: 32) | |
| cluster_ | 205883_ | Tctgcagtgagtgcaaccgcaccttccccagccacacggctctcaaacgcc | /FEA = FLmRNA |
| 67 | at | acctgcgctcacatacaggcgaccacccctacgagtgtgagttctgtggcag | /FL = |
| | | ctgcttccgggatgagagcacactcaagagccacaaacgcatccacacgg | gb: NM_006006.1 |
| | | gtgagaaaccctacgagtgcaatggctgtgacaagaagttcagcctcaagc | /CNT = 28 |
| | | atcagctggagacgcactatagggtgcacacaggtgagaagccctttgagt | /TID = |
| | | gtaagctctgccaccagcgctcccgggactactcggccatgatcaagcacct | Hs.37096.00.01 |
| | | gagaacgcacaacggcgcctcgccctaccagtgcaccatctgcacagagta | |
| | | ctgccccagcctctcctccatgcagaagcacatgaagggccacaagcccga | |
| | | ggagatcccgcccgactggaggatagagaagacgtacctctacctgtgctat | |
| | | gtgtgaa | |
| | | (SEQ ID NO: 33) | |
| cluster_ | 219963_ | Tctaccgtggaatgtccctggagtactatggcatcgaggcggacgacaacc | /FEA = FLmRNA |
| 67 | at | ccttcttcgacctcagtgtctactttctgcctgttgctcgatacatccgagctgcc | /FL = |
| | | ctcagtgttccccaaggccgcgtgctggtacactgtgccatgggggtaagcc | gb: NM_016364.1 |
| | | gctctgccacacttgtcctggccttcctcatgatctgtgagaacatgacgctgg | gb: AB027004.1 |
| | | tagaggccatccagacggtgcaggcccaccgcaatatctgccctaactcag | /CNT = 17 |
| | | gcttcctccggcagctccaggttctggacaaccgactggggcgggagacg | /TID = |
| | | gggcggttctgatctggcaggcagccaggatccctgacccttggcccaacc | Hs.178170.00.01 |
| | | ccaccagcctggccctgggaacagcaggctctgctgtttctagtgaccctga | |
| | | gatgtaaacagcaagtgggggctgaggcagaggcagggatagctgggtg | |
| | | gtgacctcttagcgggtggatttccctgacccaattcagagattctttatgcaaa | |
| | | agtgagttcagtccatctctataata | |
| | | (SEQ ID NO: 34) | |
| cluster_ | 233126_ | Tagcaaaggacatggaagcctggaaagatgtaaccagtggaaatgctaaa | /FEA = mRNA |
| 67 | s_at | atttaccagcttccagggggtcacttttatcttctggatcctgcgaacgagaaat | /CNT = 4 |
| | | taatcaagaactacataatcaagtgtctagaagtatcatcgatatccaatttttag | /TID = |
| | | atattttccctttcacttttaaaataatcaaagtaatatcatactcttctcagttattc | Hs.24309.00.02 |
| | | agatatagctcagttttattcagattggaaattacacattttctactgtcagggag | |
| | | attcgttacataaatatatttacgtatctggggacaaaggtcaagccagtaaag | |
| | | aatacttctggcagcactttggga | |
| | | (SEQ ID NO: 35) | |
| cluster_ | 215515_ | Tggctgcgcagggagcacattggaaggggtcttggggtggacagaatttc | /FEA = mRNA |
| 75 | at | cttttgctctaagggtgaaaccagtcaggtctctctctttctgagctctcctccca | /CNT = 3 |
| | | gagcacctggtcaggatatcccagtcatcacctccgggaagatgatgttccct | /TID = |
| | | ggatagcccatacattttctcacctccatacctagctaacactgctgcatcagtc | Hs.202684.00.01 |
| | | ccaatgaccccacttcccatcctttactctctgagatctggatttgccttnnaga | |
| | | tgcaccccccatgccactttcttaaggtagtcttctcaactccccccaaagaat | |
| | | gaactattatttttggggggcttccaaagcaaattgctttgaaattccaaaagat | |
| | | catacattctgttttaatcatagtgggttgttaagctcctgcactagactataang | |
| | | ctacttgtggatagggactatgatttgtttatatctgtaacttccgtctcttgcctct | |
| | | tttccccagcatagagcaga | |
| | | (SEQ ID NO: 36) | |
| cluster_ | 1567540_ | Aatgtgaacaacagcggcctgaagattaacctgtttgatacccccttggaga | /TID = |
| 75 | at | cgcagtatgtgaggctggagcccatcatctgccaccggggctgcacactcc | iHs.404151.1 |
| | | gctttgagctccttggctgtgagctgagtggatgcactgaaccccta | /CNT = 1 |
| | | (SEQ ID NO: 37) | /FEA = mRNA |
| cluster_ | 233958_ | Aggagggatgatcacttgggcccggaagttcaggatcatcctggaaaatat | /FEA = mRNA |
| 75 | at | gtcaagacttcacctctaccagaaatttacaaattagctgggcatggtagaatg | /CNT = 4 |
| | | tacctgtagacctagctacttaggtggaagaatcacttgagcccagcagttca | /TID = |
| | | aggtgacagtgaactacgatcaggccacttgattccagtcttggcaacaggg | Hs.12621.00.01 |
| | | taagaccttgtctttaaaaaaataaaaagcaaaaaataaaatgctagttatatta | |
| | | ggaaaaagcctgactgaggtccaaatgcatgcggaagactgtttcagcaaa | |
| | | ggtaacatccctctatgccacagcttgattgaattttaaataaagatgatgataa | |
| | | aatgtacatttattaaggagataattgatgtaatgtgctcagtacaagttttggca | |
| | | tattacaagcattcaataaaccctacatct | |
| | | (SEQ ID NO: 38) | |
| cluster_ | 215326_ | Tgggcacggggagaggaaggcactcctctttaaggaccgacccagaggtt | /FEA = mRNA |
| 75 | at | ttgccattgcttcactggccagagcttagtcacgcagcctcacccagaggca | /CNT = 4 |
| | | agggaggttggaaaatgtagtgtttgtgtgtgtctaacacaaattctattaccat | /TID = |
| | | gcagtcaggattctccactcttgctctttcattagatttgctgggcttcaccctgg | Hs.20447.00.07 |
| | | actttctgatttagtgacagaacagagaacccagaggcagacccagatgtgt | |
| | | acaagggcttcatatacaatcaggagatttaataatcatgctaggggccgggt | |
| | | gcag | |
| | | (SEQ ID NO: 39) | |
| cluster_ | 235184_ | Gagggttttctctttaatcacaacttaaaaaaagaaacctttaatacctctgcat | /FEA = EST |
| 75 | at | aagttctctgaaagaacttaaattcttagtttatatgaaaactgatatgtatgtctg | /CNT = 12 |
| | | tgtaacaaagcctgttgggtacaggtctacaaggagatactttgtttctaaaaa | /TID = |
| | | aggagttaaatcgtgtcacctgaatttttttttttngagataagtggacattttgg | Hs.126497.00.02.00.01 |
| | | ggattttggttaaaacatatttctctattctaaaaattacagaatatgtattcataaa | |
| | | agggaagaaattgttagaaaatttcctgtgtacgtagtttgnnnnnaaantaa | |
| | | agaatcttgtgacctggnnnaggacattttgcatttgtaacactgcagttttaat | |
| | | atatttgctgttttttttaaaattagaatatgtttaaaatttaatggttatgaggctct | |
| | | gtag | |
| | | (SEQ ID NO: 40) | |
| cluster_ | 226847_ | Atttattggattctctgctgcctgatctgtacatacatgatccctcgggttttgttt | /FEA = EST |
| 75 | at | acaaggaaccttgactgaccaaaaggcattataactctgactcaaatacaag | /CNT = 48 |
| | | gtacagaagataagcatctttgaggaaactcctacttcagttcttttgttatgatg | /TID = |
| | | aagacatttgtgagagaggagatgattagaattctagtaatgtacttttaagatg | Hs.301570.00.02.00.01 |
| | | ttacagatacaaagaaatgatgtgggtgtcaggagactaaaggatgttgaag | |
| | | gctacacattcaaccttttgttaggtgtttcctttaagctactcagctgtacctttta | |
| | | aattagttctttttcaaccagtatatcactaaaagttatatcaaagctttatcagttc | |
| | | aagtttcttgcttttcataatacttttttctgatgcaattttatattttcaaacatggca | |
| | | agttaaaatataaattcatttaaatatatagttttgtacttttctaccatgt | |
| | | (SEQ ID NO: 41) | |
| cluster_ | 222899_ | Atgacacaatccctggggctgtgcattcccacgtcttcttgctgcagcctgcc | /FEA = FLmRNA |
| 75 | at | cctagacatggacgcaccggcctggctgcagctgggcagcaggggtagg | /FL = |
| | | ggtagggagcctcccctccctgtatcaccccctccctacacacacacacaca | gb: NM_012211.1 |
| | | cacacacacacacactgcctcccatccttccctcatgcccgccagtgcacag | gb: AF109681.1 |
| | | ggaagggcttggccagcgctgttgaggggtcccctctggaatgcactgaat | gb: AF137378.2 |
| | | aaagcacgtgcaaggactcccggagcctgtgcagccttggtggcaaatatct | /CNT = 42 |
| | | catctgccggcccccaggacaagtggtatgaccagtgataatgccccaagg | /TID = |
| | | acaaggggcgtgcctggcgcccagtggagtaatttatgccttagtcttgttttg | Hs.256297.00.01 |
| | | aggtagaaatgcaagggggacacatgaaaggcatcagtccccctgtgcata | |
| | | gtacgacctttact | |
| | | (SEQ ID NO: 42) | |
| cluster_ | 242883_ | Gtgggcctgagtcgcagatcagaaagcaccgggaagatgcaggcctgcat | /FEA = EST |
| 75 | at | ggtgccggggctggccctctgcctcctactggggcctcttgcaggggccaa | /CNT = 6 |
| | | gcctgngcaggaggaaggagacccttacgcggagctgccggccatgccct | /TID = |
| | | actggcctttctccacctctgacttctggaactatgtgcagcacttccaggccct | Hs.148586.00.01 |
| | | gggggcctacccccagatcgaggacatggcccgaaccttctttgcccacttc | |
| | | cccntggggagcacgctgggcttccacgttccctatcaggaggactgaatg | |
| | | gtgtccagcntggtgcccgcccaccccgccaggctgcactcggtcgggcct | |
| | | ccacaggcatggagtccccgcaaaaacctggcccctgcaggagtcaggcc | |
| | | tggtctcacgctcaataaactccggactgaagatgca | |
| | | (SEQ ID NO: 43) | |
| cluster_ | 232577_ | Atgtagttgtctaccacttcctagcacacctgggctgcacaaatatgtgggtct | /FEA = mRNA |
| 75 | at | gatataatgtcagaaatgcaggaagctatatgagattccagccctctatttttcc | /CNT = 9 |
| | | aagtgtaaaagaacttatgaatcaagagccgaataaaaaacatagtactctttc | /TID = |
| | | tgataatctgtcaacaaatttgcaatcatgtcaggcatgttatatgattacgaatt | Hs.116072.00.01 |
| | | gctcaatgctattatgaaaagtattttcaacaagtgaaacttctggagttctctgc | |
| | | agttctgggatcaaacctcagtgccttgtcctaacgtcccattaggacagaagt | |
| | | gcccttcctgagagtatggcagcataatgacattctagcacctggaccgatta | |
| | | cactgctctccctgaagtagtggattctttcatcagcagga | |
| | | (SEQ ID NO: 44) | |
| cluster_ | 239693_ | Gtgtctgtacttaatgtgtctactttgagtaatatttcatctacatacaagcagat | /FEA = EST |
| 75 | at | attgtatgtttagtgtacatatatttaatttctcctcttttacaaaaatggtagcacg | /CNT = 5 |
| | | caatacccattgctttctatttttttttatttaacaatatcttggcaatctttctgtatca | /TID = |
| | | gtatataaagtgctattctctttttaaaaaaaaaaagctgtatggatcttctataatt | Hs.168184.00.01 |
| | | tgtgtaaccactaccatattgatagacattttacttttcgatttcactaggcatgcc | |
| | | tggcccatattgctctacaggttgtgcattgcacaagtccaagcagtgtcattc | |
| | | acatggaccacagtgttaatagtattccaagtcatgcttggaaccctgcacttg | |
| | | gggaaatatcaaaaactttaatcattcaaaccatggattcacaggcaat | |
| | | (SEQ ID NO: 45) | |
| cluster_ | 243288_ | Gaggagcagagggcaaactacgttcccattaaagccacaaggtttaaaaac | /FEA = EST |
| 75 | at | ctctaaccttggaaaagcacacttcaaccctctgcacaccanacttctctactg | /CNT = 6 |
| | | tggtttcccctctgccnctttctccttggcgttccccnatcactgcctctagggt | /TID = |
| | | catacaagggacagcgaacgtaaggtttcggagctggcttcgcccccttcta | Hs.201767.00.01 |
| | | tttaccgggggctggtcatccttcgggccaggctgactgtctaggggtggcc | |
| | | ct | |
| | | (SEQ ID NO: 46) | |
| cluster_ | 241451_ | Gaccgaaggcagctttggtgactccacttctttttaaagtcaccctcctctgcc | /FEA = EST |
| 10 | s_at | ctctgactttaagtgacaggcagttccctcccctctctttcaattctgtaaaatgg | /CNT = 8 |
| | | ggataatccggacctcatgcccccagagccttgtaaggaccggctaatgag | /TID = |
| | | ggcaggcgagtgggaaacgaatcgtctgaacaatgatcagtcattctttcgg | Hs.132696.00.01.00. |
| | | gcttgcaaagagggtaaaaaaggttgggtctttagcggggtccgtagaagg | 01.00.01 |
| | | ctttgaagacgaaaagtgctgtagaggtgctaagcagcagccaacggacc | |
| | | (SEQ ID NO: 47) | |
| cluster_ | 1560692_ | Gattggtcatttctgaagcaacacagacttgtacctgtatcagcaatgtttacc | /TID = |
| 10 | at | atgctcataatcaaagacgtatgctagtttggaatgagctactaggctcattgta | iHs.385500.1 |
| | | tcagtgtccaaaataatgaagatttatctgtcactgtgccaccaagagtccaac | /CNT = 3 |
| | | tcactggctactttgagaaagaacatggtgcactatttgcttcacactcaagaa | /FEA = mRNA |
| | | gttaatatggaaccttaaaaattggaacggaaactaaaacaaattaaggagat | |
| | | ccttcagagattttaaccttatattttgtctctgcgactataactttgtaaataacca | |
| | | taactatgaataggaataaagatttaaaaataagttatcagacattctcaacctt | |
| | | gtttccaag | |
| | | (SEQ ID NO: 48) | |
| cluster_ | 219650_ | Gagcctttgtctggtgaacagttggttggttctccccaggataaggcggcag | /FEA = FLmRNA |
| 10 | at | aggctacaaatgactatgagactcttgtaaagcgtggaaaagaactaaaaga | /FL = |
| | | gtgtggaaaaatccaggaggccctaaactgcttagttaaagcgcttgacataa | gb: NM_017669.1 |
| | | aaagtgcagatcctgaagttatgctcttgactttaagtttgtataagcaacttaat | /CNT = 27 |
| | | aacaattgagaatgtaacctgtttattgtattttaaagtgaaactgaatatgagg | /TID = |
| | | gaatttttgttcccataattggattctttgggaacatgaagcattcaggcttaagg | Hs.89306.00.01 |
| | | caagaaagatctcaaaaagcaacttctgccctgcaacgccccccactccata | |
| | | gtctggtattctgagcactagcttaatatttcttcac | |
| | | (SEQ ID NO: 49) | |
| cluster_ | 1560511_ | Gtgtgcacacactcagggcagtgctgacatgccagccccctgccgtctcag | /TID = |
| 10 | at | ccctctccagattttgggcactgatgagcataggaatgaagctgaggaggaa | iHs.436529.1 |
| | | ctgagggcagcttggcagtggcctgcagacgccccttggtacctatagcctg | /CNT = 3 |
| | | ggcgccatgaatggcagcaggaggcagacaggtttctgggcagaagggg | /FEA = mRNA |
| | | gtgagtccctggtgaggcccaccttcaggccagggaggccctgaaggctg | |
| | | ggggccaggctgtcagtgccgtggactggagtgcgaacttgtgttgccttttc | |
| | | tgggcctgcccatggccgcccatggaccagtcagcatgaacttccccctctc | |
| | | tgaggctgacagaagccccaggctcagccagagctgagcagacgtcggat | |
| | | gaccagctgtagtgaggaactgccctctccagggcctcctctgagctattgtc | |
| | | actcaata | |
| | | (SEQ ID NO: 50) | |
| cluster_ | 1561055_ | Agtaacaggcatgctttctgtccttctctccttttagattgtaagctacccaaagt | /TID = |
| 10 | at | ccatctccatgggtttttttccttatgtgcaaactaccatatgacaggtgtgcctg | iHs.407601.1 |
| | | acaataactcaggtatagctgagaatgatcctgtagtccaagaatgttggttct | /CNT = 5 |
| | | gagctctgaactaaggaatctgggagctgccaacccagaggtttactccttat | /FEA = mRNA |
| | | ctatggagcataggtgaacccctggcccatttcttggaacagcatgtgcggg | |
| | | gaaccaaggccctttgttttgagctaggtggaggtggccaggtagaggtcgc | |
| | | caggaagaggtggccaggtggaggttgctaagcaaagattgctatattaact | |
| | | gggtgctttttagaaaccatagtggttaccccattcatc | |
| | | (SEQ ID NO: 51) | |
| cluster_ | 1562455_ | Acgcagatggctttgatcctcagggtggcagaattccaaaatgtcctttccca | /TID = |
| 10 | at | gaagatcctaaataaaagagacaagctttaataatcccagatccatttgtaatta | iHs.434442.1 |
| | | tttgtatactcactgtgatacaacagtgttcatttccatctcctttaactcatctcctt | /CNT = 2 |
| | | tagcctgtcccaccccagattttttgaaaaagtgagtgcaaaatttccctggga | /FEA = mRNA |
| | | gccgtcagagaactggcttcttggtattcactctaagttcttctggcatgctcaa | |
| | | tatccatttctaattttgctaaggcactacatcagtagcttcagaatgcaattttatt | |
| | | tttgtttgtcttggagaggcaaactgcaataaacatactttaataacataaaaag | |
| | | aaagcaaaatgatagcctgaggacagatgtgttgcttatgaaaactggaattg | |
| | | tttaaatgtggaaattgtagctctcctgtggctgaa | |
| | | (SEQ ID NO: 52) | |
| cluster_ | 217417_ | Aaaactatgctcttgtatgggtggtaggacacttggtgttcaggcagctctgg | /FEA = mRNA |
| 10 | at | ggcagaggaaaaacggtacagggtaattgtattttatggctgggataataatt | /CNT = 1 |
| | | ctaagttttcataattagagacaacttctgcaggccagaatttgtattaactactt | /TID = |
| | | aaactagagcttccatgtgacaatagggaaaacaaaacttgtaattcactaac | Hs.170157.00.02 |
| | | cagctttgaaattatgcaatatttgatgattgttttaattcagaagaatgtatgttat | |
| | | tactgatgcctcacatagagggagatgttattaatatttttatttatgtcacactatt | |
| | | tcagataagtataattttaaaaatcccataaagtgtgactacactgtatttctaatc | |
| | | ttgaaagatattatttaattaaaatagatgcattatggttggaaatcaagaaaatc | |
| | | tttatcttacatccctggttacattgtacctagaagtgaccctcaaatt | |
| | | (SEQ ID NO: 53) | |
| cluster_ | 232418_ | Aaacggaaagtctctcatcctgtcctgtcattgcctagggtggagaaacaga | /FEA = mRNA |
| 10 | at | agtggaaggtttgtttcaggtcctctgaggataattagtccattgcagtagtttta | /CNT = 8 |
| | | cttgatggtaccccatgggccagaagagggcatacttaaccttctagagagc | /TID = |
| | | ctgaagtagctcctgatcacaccttttcaaggtaaagtgaagagcatgaaattt | Hs.287630.00.01 |
| | | tggacagngtttattgntggacntttaaagtttgtgatntgcggtaacaaggag | |
| | | aagggtttttaagtttataaaaattatttatcaattagccgggtgtg | |
| | | (SEQ ID NO: 54) | |
| cluster_ | 241542_ | Gcataatgtactctatctgcgatattagcttctcggtcttgcagtgttgcctaac | /FEA = EST |
| l0 | at | acacacagtgatcagcacattttttgagactgcaataatcagaggaatgtaac | /CNT = 4 |
| | | agtgatgtgggaacaagaggaaataacatggaataataatgtacccatcattg | /TID = |
| | | ttctgttgtcatccctcctagccagtttggtttcccttagagcctaacaaaagctt | Hs.135866.00.01 |
| | | cacgaattcaatggaataaaacatggaactgggtgcaaaattaatacatctatt | |
| | | cccaagctccatattcatagaaaaaaggaaaatattgactacatagggaaca | |
| | | gactttccctgaaagctttgtggatctatgcatatgcttatgtaatcttcaaacaa | |
| | | gttgtgcagccttttacaaatgtgtctagcctc | |
| | | (SEQ ID NO: 55) | |
| cluster_ | 231333_ | Agctgggtctgaggagccaagcagaaaaacttcccaaaatcactgggtgg | /FEA = EST |
| 10 | at | ggaggggtcagagacttactgctgccccagctgttctgactctgcccccagc | /CNT = 12 |
| | | ttttggccccacccttttaaagcaccttcagaggttcccaatggtgacagtaaa | /TID = |
| | | caagtctccactgtcctggccatctctgctgtgttcaccctactcctgatctttct | Hs.97764.00.01 |
| | | ggctgctcagggactgacagccaagatgtgaggctgtgatgagcaggaac | |
| | | agggaggcctggagcccccagccattgtcatcacttccctgatctgcctaaat | |
| | | tctgcccagcagtccgtgaaaatggtttgctgatgacatatgtaaggactttaa | |
| | | ctcccctcaagcaatctgctcatctcaaagggtaaaacattggctcactcctaa | |
| | | tgcaat | |
| | | (SEQ ID NO: 56) | |
| cluster_ | 236810_ | Gctctcaccgtctggttgattcggacgtggttgcactgtcctggatcctcagc | /FEA = EST |
| 8 | at | cttaccctccctcttntcaggaccctcacactgggattcgtnagaaatgtggac | /CNT = 7 |
| | | cccaggagggagtgaagagtgttcaagggtcacggtggaagacaggctct | /TID = |
| | | atgggaagagagcgagtggataaccacgtgaaggcagaaaaggactccaa | Hs.208971.00.01 |
| | | ccccaccttatgtcctctccaggtgttcccaattctgccagcaccctgccctct | |
| | | gccacctggggctccttccattctgcccagtcgaggcatttctggagggagg | |
| | | acccgtgagaaccttgcatagaacatacaggatccagaggcctctaatacag | |
| | | catttcagtgcagctgccagcaagggccactgagggtcacaggctggccag | |
| | | gtgctgtaaatgtacagagaccatgtttgtgaagccccacatcaggacacata | |
| | | acct | |
| | | (SEQ ID NO: 57) | |
| cluster_ | 211226_ | Cggcgcgccaagcgcaaggtgacacgcatgatcctcatcgtggccgcgct | /FEA = FLmRNA |
| 8 | at | cttctgcctctgctggatgccccaccacgcgctcatcctctgcgtgtggttcgg | /FL = |
| | | ccagttcccgctcacgcgcgccacttatgcgcttcgcatcctctcgcacctgg | gb: AF080586.1 |
| | | tctcctacgccaactcctgcgtcaaccccatcgtttacgcgctggtctccaagc | gb: AF040630.1 |
| | | acttccgcaaaggcttccgcacgatctgcgcgggcctgctgggccgtgccc | gb: NM_003857.2 |
| | | caggccgagcctcgggccgtgtgtgcgctgccgcgcggggcacccacagt | /CNT = 5 |
| | | ggcagcgtgttggagcgcgagtccagcgacctgttgcacatgagcgaggc | /TID = |
| | | ggcgggggcccttcgtccctgccccggcgcttcccagccatgcatcctcga | Hs.158351.00.01 |
| | | gccctgtcctggcccgtcctggcagggcccaaaggcaggcgacagcatcc | |
| | | tgacggttga | |
| | | (SEQ ID NO: 58) | |
| cluster_ | 1563881_ | Cctactctcaataaatggccaatggatgttctctaaacaaaaagagaattctaa | /TID = |
| 8 | at | aacaataccaaaattctaaaaaaaaaaaacaaccaacaaaaacaatgagga | iHs.377053.1 |
| | | aaagagaagaatggagaaagtaaaactatagataaataaaatacttttcttcat | /CNT = 1 |
| | | cttttgagttttcttttttcccatttttattgagatataattggcatctctttaaattttcc | /FEA = mRNA |
| | | aaattaggtttgagtgttgaagcaataatagtactgtttaatgtttctaaatgtgtg | |
| | | tagagagaatatttaaggtaattcattataagtgagggagggtaaaagaatatc | |
| | | aatggagataaggtttatctacttcagtcaaagcggtaaaatgataatgccagt | |
| | | agactataagatatataaaatatatttatagattatatatatatatataaaatgtgtg | |
| | | catatatatgtaatgtagtacctaaagcagccacttaaaagctatacaaaggag | |
| | | atatactcaacagtactgtag | |
| | | (SEQ ID NO: 59) | |
| cluster_ | 1564070_ | Gctttgagcctcttcggttttccggccagacccggaaaaacgaaaacacagc | /TID = |
| 8 | s_at | ttggggagcccccactagccggcgcctgtgccagctcacctctggccatgg | iHs.320051.1 |
| | | cgcagctgccggtgcacacggcggccaaggccagctccacattcttccctc | /CNT = 1 |
| | | cccctcccacttcaccgtagccccgaaccctgcgcgcagagaaagggtctc | /FEA = mRNA |
| | | agctccacagacgactgggtccctcctcaccaaaaatggtgagacaagattt | |
| | | catctgtcggccgaggagccacaagcaggtttgtctgagagggatggtgct | |
| | | gggggaaggctttggattgcatctcaaattaagctttgctccttaaatgtggcg | |
| | | ctctcgccaagaaaaagcttggggcctgaattcagagatttatggtgcacctt | |
| | | attgatcaaattt | |
| | | (SEQ ID NO: 60) | |
| cluster_ | 230393_ | Ccacgtcacgtgacgcgagggcggggacgcgctcgggagcgagcgtgg | /FEA = EST |
| 8 | at | gagcctggaagcctcggtgggtcccgaggctgcagcgaggccgggaccg | /CNT = 16 |
| | | tgccctctgctggcgggacctggcgttttccggcaccccgccccaaatcccg | /TID = |
| | | gactcggtgttaagggaggtgcattgtcctgaaatgcttacaacagctgtcttc | Hs.101299.00.01.00. |
| | | aataactcgtgcatagaatgcgcccagtaaatatgtgtt | 01.00.01 |
| | | (SEQ ID NO: 61) | |
| cluster_ | 232881_ | Gacgactgatcgtccaaggactggcgncggatccaacacctttccccagct | /FEA = mRNA |
| 8 | at | ctgcgcgtancncgctntttggnaancgaattggtccctgtctgcttccaagg | /CNT = 4 |
| | | gtccnnggaaccttctgncagctgtgcctctccagagctccgcctcattagtg | /TID = |
| | | ccacgttcctggtttgaaaaccatagtacttcaacctcttctagatgggagttaa | Hs.283846.00.01 |
| | | cctttgccctctgaaagaaaggtttgataagcaaagagagtttggtgagcaag | |
| | | atccttgaggtaagagctgatctctgacgtccgctgggaactggcngctctg | |
| | | caggtttctgtatcacattttctgcacatgtccattagaattggagatggggcgt | |
| | | atctagtgttgaataaaggcccggcagnncctcccagatgcaccctgtcnna | |
| | | nanannnnannnnnnannnnnnanaaannacttgactcattcttggtgg | |
| | | cgaccaccccacccacaggcacctaaaatgaa | |
| | | (SEQ ID NO: 62) | |
| cluster_ | 220718_ | Ggtacctaattactagttacacatacatggctttgatgggaaatcaaagaaac | /FEA = FLmRNA |
| 24 | at | attctgacaatacagagattcatcaagcaatttgtctttgaaagttgattattcaa | /FL = |
| | | aaacagagcttgtagcaaaagaagcagaagttagatcccacagtcatcaagt | gb: NM_025005.1 |
| | | ttcagatcctaaggcttgcattcttacaccaatttcttctttgcttaaatcttaatttt | /CNT = 5 |
| | | catcagcattaattaagtgtctgggtactctgccagtcaggagagatgttacca | /TID = |
| | | aaggtacaggatttgagaagtattgtcagaagagccaagttcataatcaggcc | Hs.287563.00.01 |
| | | cataggatcaataatttgggggagtgtttagagcagtttcaaagatgagagca | |
| | | gtagatcaaagtagaatttcaggactgagcacatgccaaggcacccttttatg | |
| | | gatattcaacc | |
| | | (SEQ ID NO: 63) | |
| cluster_ | 244097_ | Ttccttccaaatttactttgataatatataaagataggagtagcacctctggcta | /FEA = EST |
| 24 | at | aacctttttttcatacccacttatttccttagaatagatttctagaattactaaagat | /CNT = 6 |
| | | aagtgcatgagcatttaatatacttgataactattgtcagatgacttgccaggaa | /TID = |
| | | gtttgttcttagtaatatttaatgtactgggatatgtcgtgtttctcaaccccttttcc | Hs.291816.00.01 |
| | | tgcttcattgatttgcctgttccattacaaaccactttgtgtttaattaatacctttat | |
| | | gttattatatctggtagggcaagaattcacactacaattttataggactttc | |
| | | (SEQ ID NO: 64) | |
| cluster_ | 216214_ | Tactaaagttgacctgggatcacaggcgtgagccacggcgtctggcctattt | /FEA = mRNA |
| 24 | at | cccttttaagtaaatatctgggtaggtggtctgagaatagtctgatgtgaaaga | /CNT = 4 |
| | | ccttggctcccagaaactggtacatgatatttctcacnnctcattggccnagaa | /TID = |
| | | aacagtcacatggacaggtaacagcaaacaggcntaggaaatgcaatcntt | Hs.51649.00.01 |
| | | gattatgaaaggccnatttaaccatctaaaattggggtctctaacaaaacaga | |
| | | agagggcaaaggattttgagaaaaactaactgcagtctctaaatatgtaggct | |
| | | caatcattaccttccttttccaaatgaggaaagtgagacatagagatgttaagn | |
| | | ntcatgcctggcattgtacaatattcccttccg | |
| | | (SEQ ID NO: 65) | |
| cluster_ | 1553747_ | Catgttagtgtcatctctattagatgctttggagcaaacatgaacagggtttcct | /TID = iHs.290691.1 |
| 24 | at | tttaagatgtcctgtgattccagattcaggggaatctgagaaaagtttgaagaa | /CNT = 9 |
| | | agaaaattccactcggccagccaaccttgggtgtgcagagcctgccccgcct | /FEA = FLmRNA |
| | | tccccactttgtcctgagaagctgggtcctccccagcaccagagttgctgctg | /FL = |
| | | cttcccctcgcgctcttggctgctctcccggccccaagcctgagtgacactct | gb: NM_032923.1 |
| | | aggattgcagatggcaggct | gb: BC008026.1 |
| | | (SEQ ID NO: 66) | |
| cluster_ | 240342_ | Gaagcagcccacttggtggggttggggtatgagtccttcctcgcgggggct | /FEA = EST |
| 24 | at | cggtgggtcctgagtattctttggccggatttgctgatccgtctgctccagnnn | /CNT = 5 |
| | | agnttnnnaangnncnnnnnnnaggccnncannnncntntgnnannnt | /TID = |
| | | aggaaaaaaccagccctactgagtcagaaactggggatgtggcccaggca | Hs.121364.00.01 |
| | | atcttttaccaagacctccaggtgattataatgcaaggaaggattccctatcttg | |
| | | gacctgaggctgctttcttgaagaaaacttgactttatttcatttagtgggaaga | |
| | | gcagcagcccagctattaagttctaatatgcaataggctgcaggctgtgaagt | |
| | | gttcgtggcagtagactctgaagctaaggagctgagggcttaacaagtttcta | |
| | | gaagctgccatcaacatgccaagtcagtaaaactgatagttgatcagatttca | |
| | | aggtctggggagtatatccactgtgtactgggtcttgagctctagag | |
| | | (SEQ ID NO: 67) | |
| cluster_ | 237000_ | Acataaatagccagaggacttgcctgggccgtacataggggaattcacatg | /FEA = EST |
| 24 | at | atcagttttagtatatactgtcaattttnccaaagaggttgtaccaatttacttccc | /CNT = 6 |
| | | agcagctgtgcagaagcattagtagagtttcagttgttnccacgcccttgtcaa | /TID = |
| | | cgctttgtgcccttgacctttacaacactccattttaaagatgagtgtgtagatgt | Hs.23681.00.01 |
| | | tgaaaagtgcacaaggggaatgtttgctccatgagccaatcacggaaggaa | |
| | | gctgggc | |
| | | (SEQ ID NO: 68) | |
| cluster_ | 1566030_ | Gttgtatttccatcagcacatcgattttaagatattttcctcactccaaaaagaag | /TID = |
| 24 | at | cctctccctctcagctgtatctccagtccctagaatggtactgagtcctgtgggt | iHs.170411.1 |
| | | actcggtgattttgcagctactgctgcagggacgaaggggaaactgcatgg | /CNT = 3 |
| | | gaaggcatctcctaaacatgaccagttattggtgtcaccattccctttgcttcac | /FEA = mRNA |
| | | caacttgatcttcttcagatccttttcttctgcttcggcatcttttcattgtcatcattt | |
| | | tatcttcatcactatcatcaccttcactgcttgtttatcatcatctttgtcattttcatc | |
| | | tttttcttcctcattatctttccatcatcttta | |
| | | (SEQ ID NO: 69) | |

In a particular embodiment, the method comprises measuring the expression level of at least 5 of the genes in a biological sample obtained from a subject, wherein an elevated level of expression of the 5 genes compared to a control level measured in a population of normal subjects is indicative of an increased probability of the presence of coronary atherosclerosis in said subject. In other specific embodiments, expression levels of 10, 15, 20, 30, 40, 50, 60 or 69 of the genes are measured, and an increased level of expression compared to a control level is indicative of increased probability of disease. The predictive ability of the method is more accurate as an increasing number of the gene set is measured. Generally, it is desirable to screen at least about 21 genes in a subject sample for optimal predictive ability.

Table 4 includes a listing of 85 clusters/metagenes representing groups of genes that are affected by atherosclerosis. As a systemic vascular process, atherosclerosis involves the processes of inflammation, immune modulation and stem cell signaling. Therefore, the 85 clusters represent the gene expression signature for a systemic inflammatory process.

TABLE 4

| Cluster | Affymetrix | |
|---|---|---|
| number | ID | Gene Annotation |
| 1 | 243783_at | no current annotation |
| 1 | 216116_at | NCK interacting protein with SH3 domain |
| 1 | 205817_at | sine oculis homeobox homolog 1 |
| | | (Drosophila) |
| 1 | 211440_x_at | cytochrome P450, family 3, subfamily A, |
| | | polypeptide 43 |
| 1 | 240848_at | no current annotation |
| 1 | 226610_at | proline rich 6 |
| 1 | 218629_at | smoothened homolog (Drosophila) |
| 2 | 220927_s_at | heparanase 2 |
| 2 | 206777_s_at | crystallin, beta B2 |
| 2 | 223106_at | transmembrane protein 14C |
| 2 | 1558421_a_at | similar to RIKEN cDNA A530016L24 gene |
| 2 | 214800_x_at | basic transcription factor 3 |
| 2 | 1562217_at | no current annotation |
| 2 | 227584_at | neuron navigator 1 |
| 3 | 1569555_at | guanine deaminase |
| 3 | 1562590_at | hypothetical protein FLJ25756 |
| 3 | 203929_s_at | microtubule-associated protein tau |
| 3 | 224061_at | indolethylamine N-methyltransferase |
| 3 | 240534_at | LIM homeobox transcription factor 1, alpha |
| 3 | 214324_at | glycoprotein 2 (zymogen granule |
| | | membrane) |
| 3 | 215973_at | no current annotation |
| 3 | 231147_at | calcium channel, voltage-dependent, alpha |
| | | 2/delta subunit 4 |
| 3 | 1560614_at | deleted in a mouse model of primary ciliary |
| | | dyskinesia |
| 3 | 1563458_at | parvin, alpha |
| 3 | 220574_at | sema domain, transmembrane domain |
| | | (TM), and cytoplasmic domain, |
| | | (semaphorin) 6D |
| 4 | 240825_at | no current annotation |
| 4 | 243516_at | formin 1 |
| 4 | 216182_at | synaptojanin 2 |
| 4 | 1554601_at | no current annotation |
| 4 | 238372_s_at | epidermal growth factor receptor pathway |
| | | substrate 8 |
| 4 | 206377_at | forkhead box F2 |
| 4 | 215153_at | C-terminal PDZ domain ligand of neuronal |
| | | nitric oxide synthase |
| 4 | 228887_x_at | no current annotation |
| 4 | 228467_at | purine-rich element binding protein B |
| 4 | 235731_at | aryl hydrocarbon receptor interacting |
| | | protein-like 1 |
| 4 | 236290_at | docking protein 6 |
| 4 | 1556771_a_at | ciliary neurotrophic factor receptor |
| 5 | 1569504_at | leukocyte immunoglobulin-like receptor, |
| | | subfamily B (with TM and ITIM domains), |
| | | member 1 |
| 5 | 230071_at | septin 11 |
| 5 | 204864_s_at | interleukin 6 signal transducer (gp130, |
| | | oncostatin M receptor) |
| 5 | 217500_at | no current annotation |
| 5 | 210571_s_at | cytidine monophosphate-N- |
| | | acetylneuraminic acid hydroxylase (CMP-N- |
| | | acetylneuraminate monooxygenase) |
| 5 | 224239_at | defensin, beta 103A |
| 5 | 209785_s_at | phospholipase A2, group IVC (cytosolic, |
| | | calcium-independent) |
| 5 | 220266_s_at | Kruppel-like factor 4 (gut) |
| 5 | 212777_at | son of sevenless homolog 1 (Drosophila) |
| 5 | 213643_s_at | inositol polyphosphate-5-phosphatase, |
| | | 75 kDa |
| 5 | 203372_s_at | suppressor of cytokine signaling 2 |
| 5 | 206079_at | choroideremia-like (Rab escort protein 2) |
| 5 | 241241_at | ribosomal protein S14 |
| 6 | 222024_s_at | A kinase (PRKA) anchor protein 13 |
| 6 | 232845_at | cadherin-like 23 |
| 6 | 241879_at | no current annotation |
| 6 | 206769_at | thymosin, beta 4, Y-linked |
| 6 | 216391_s_at | no current annotation |
| 6 | 230785_at | sal-like 3 (Drosophila) |
| 6 | 225822_at | hypothetical protein MGC17299 |
| 6 | 209534_x_at | A kinase (PRKA) anchor protein 13 |
| 6 | 215697_at | RIM binding protein 2 |
| 6 | 226891_at | chromosome 3 open reading frame 21 |
| 6 | 203825_at | bromodomain containing 3 |
| 6 | 212571_at | chromodomain helicase DNA binding |
| | | protein 8 |
| 6 | 204263_s_at | carnitine palmitoyltransferase II |
| 6 | 232464_at | tripartite motif-containing 34 |
| 7 | 1553437_at | no current annotation |
| 7 | 1568876_a_at | no current annotation |
| 7 | 234049_at | no current annotation |
| 7 | 234203_at | like-glycosyltransferase |
| 7 | 1561263_at | no current annotation |
| 7 | 234394_at | no current annotation |
| 7 | 244736_at | no current annotation |
| 7 | 222618_at | smu-1 suppressor of mec-8 and unc-52 |
| | | homolog (C. elegans) |
| 8 | 236810_at | integrin, beta 7 |
| 8 | 211226_at | galanin receptor 2 |
| 8 | 1563881_at | BAI1-associated protein 1 |
| 8 | 1564070_s_at | no current annotation |
| 8 | 230393_at | no current annotation |
| 8 | 232881_at | GNAS1 antisense |
| 9 | 37201_at | no current annotation |
| 9 | 237398_at | Rho guanine nucleotide exchange factor |
| | | (GEF) 12 |
| 9 | 209211_at | Kruppel-like factor 5 (intestinal) |
| 9 | 231375_at | hypothetical protein LOC202181 |
| 9 | 219963_at | dual specificity phosphatase 13 |
| 9 | 242308_at | mucolipin 3 |
| 10 | 241451_s_at | no current annotation |
| 10 | 1560692_at | hypothetical protein MGC33530 |
| 10 | 219650_at | FLJ20105 protein |
| 10 | 1560511_at | no current annotation |
| 10 | 1561055_at | no current annotation |
| 10 | 1562455_at | no current annotation |
| 10 | 217417_at | myosin VA (heavy polypeptide 12, myoxin) |
| 10 | 232418_at | leucine zipper transcription factor-like 1 |
| 10 | 241542_at | SRY (sex determining region Y)-box 6 |
| 10 | 231333_at | no current annotation |
| 11 | 1563121_at | no current annotation |
| 11 | 244254_at | no current annotation |
| 11 | 237398_at | Rho guanine nucleotide exchange factor |
| | | (GEF) 12 |
| 11 | 224061_at | indolethylamine N-methyltransferase |
| 11 | 217041_at | neuronal pentraxin receptor |
| 11 | 244767_at | no current annotation |
| 11 | 1569290_s_at | glutamate receptor, ionotrophic, AMPA 3 |
| 12 | 244789_at | aldolase A, fructose-bisphosphate |
| | | pseudogene 2 |
| 12 | 201016_at | eukaryotic translation initiation factor 1A, |
| | | X-linked |
| 12 | 244877_at | no current annotation |
| 12 | 236477_at | no current annotation |
| 12 | 237684_at | no current annotation |
| 12 | 203930_s_at | microtubule-associated protein tau |
| 12 | 238882_at | no current annotation |
| 12 | 214678_x_at | zinc finger protein, X-linked |
| 12 | 232429_at | no current annotation |
| 12 | 209540_at | insulin-like growth factor 1 (somatomedin |
| | | C) |
| 12 | 212558_at | sprouty homolog 1, antagonist of FGF |
| | | signaling (Drosophila) |
| 12 | 203991_s_at | ubiquitously transcribed tetratricopeptide |
| | | repeat, X chromosome |
| 13 | 202260_s_at | syntaxin binding protein 1 |
| 13 | 230151_at | chromosome 13 open reading frame 1 |
| 13 | 235331_x_at | polycomb group ring finger 5 |
| 13 | 203738_at | hypothetical protein FLJ11193 |
| 13 | 218853_s_at | motile sperm domain containing 1 |
| 13 | 211440_x_at | cytochrome P450, family 3, subfamily A, |
| | | polypeptide 43 |
| 13 | 226747_at | KIAA1344 |
| 13 | 212760_at | ubiquitin protein ligase E3 component n- |
| | | recognin 2 |
| 13 | 238164_at | USP6 N-terminal like |
| 13 | 201734_at | no current annotation |
| 13 | 212164_at | chromosome 1 open reading frame 37 |
| 13 | 203196_at | ATP-binding cassette, sub-family C |
| | | (CFTR/MRP), member 4 |
| 13 | 1552660_a_at | hypothetical protein FLJ11193 |
| 13 | 219017_at | ethanolamine kinase 1 |
| 13 | 215150_at | no current annotation |
| 13 | 227728_at | no current annotation |
| 13 | 242601_at | hypothetical protein LOC253012 |
| 13 | 202334_s_at | no current annotation |
| 13 | 201407_s_at | protein phosphatase 1, catalytic subunit, |
| | | beta isoform |
| 13 | 208116_s_at | mannosidase, alpha, class 1A, member 1 |
| 13 | 218277_s_at | DEAH (Asp-Glu-Ala-His) box polypeptide 40 |
| 13 | 217880_at | no current annotation |
| 13 | 204237_at | GULP, engulfment adaptor PTB domain |
| | | containing 1 |
| 13 | 226615_at | xenotropic and polytropic retrovirus |
| | | receptor |
| 13 | 211763_s_at | no current annotation |
| 13 | 209298_s_at | intersectin 1 (SH3 domain protein) |
| 13 | 203302_at | deoxycytidine kinase |
| 13 | 225217_s_at | bromodomain and PHD finger containing, 3 |
| 13 | 204506_at | protein phosphatase 3 (formerly 2B), |
| | | regulatory subunit B, 19 kDa, alpha isoform |
| | | (calcineurin B, type I) |
| 13 | 243619_at | FGFR1 oncogene partner 2 |
| 13 | 1552790_a_at | no current annotation |
| 13 | 202460_s_at | lipin 2 |
| 13 | 236994_at | no current annotation |
| 13 | 209316_s_at | HBS1-like (S. cerevisiae) |
| 13 | 201772_at | antizyme inhibitor 1 |
| 13 | 229194_at | polycomb group ring finger 5 |
| 13 | 202055_at | karyopherin alpha 1 (importin alpha 5) |
| 13 | 223624_at | AN1, ubiquitin-like, homolog (Xenopus |
| | | laevis) |
| 13 | 227498_at | no current annotation |
| 13 | 221778_at | KIAA1718 protein |
| 13 | 202459_s_at | lipin 2 |
| 13 | 202076_at | no current annotation |
| 13 | 223005_s_at | chromosome 9 open reading frame 5 |
| 13 | 208264_s_at | eukaryotic translation initiation factor 3, |
| | | subunit 1 alpha, 35 kDa |
| 13 | 227357_at | TAK1-binding protein 3 |
| 13 | 200711_s_at | no current annotation |
| 13 | 226220_at | DORA reverse strand protein 1 |
| 13 | 212219_at | proteasome (prosome, macropain) |
| | | activator subunit 4 |
| 13 | 201174_s_at | telomeric repeat binding factor 2, |
| | | interacting protein |
| 13 | 222605_at | REST corepressor 3 |
| 13 | 201409_s_at | protein phosphatase 1, catalytic subunit, |
| | | beta isoform |
| 14 | 229800_at | doublecortin and CaM kinase-like 1 |
| 14 | 235849_at | hypothetical protein MGC45780 |
| 14 | 1554419_x_at | zinc finger protein 403 |
| 14 | 1552987_a_at | no current annotation |
| 14 | 230425_at | EPH receptor B1 |
| 14 | 1560788_at | myosin IIIB |
| 14 | 1569840_at | no current annotation |
| 14 | 240114_s_at | hypothetical protein MGC13034 |
| 14 | 1554707_at | chromosome 9 open reading frame 68 |
| 14 | 230823_at | no current annotation |
| 15 | 1553550_at | vomeronasal 1 receptor 5 |
| 15 | 209991_x_at | G protein-coupled receptor 51 |
| 15 | 1564149_at | no current annotation |
| 16 | 241357_at | mitogen-activated protein kinase 15 |
| 16 | 207635_s_at | potassium voltage-gated channel, |
| | | subfamily H (eag-related), member 1 |
| 16 | 213990_s_at | p21(CDKN1A)-activated kinase 7 |
| 16 | 233810_x_at | chromodomain helicase DNA binding |
| | | protein 9 |
| 16 | 211809_x_at | collagen, type XIII, alpha 1 |
| 16 | 206291_at | neurotensin |
| 16 | 1553181_at | DEAD (Asp-Glu-Ala-Asp) box polypeptide |
| | | 31 |
| 16 | 203722_at | aldehyde dehydrogenase 4 family, member |
| | | A1 |
| 17 | 212012_at | Melanoma associated gene |
| 17 | 217409_at | myosin VA (heavy polypeptide 12, myoxin) |
| 17 | 215311_at | no current annotation |
| 17 | 232468_at | FERM domain containing 4A |
| 18 | 206568_at | transition protein 1 (during histone to |
| | | protamine replacement) |
| 18 | 1554840_at | no current annotation |
| 18 | 228313_at | G protein-coupled receptor, family C, group |
| | | 5, member B |
| 18 | 217330_at | disrupted in schizophrenia 1 |
| 18 | 1561910_at | no current annotation |
| 18 | 204503_at | envoplakin |
| 18 | 1560430_at | NTPase, KAP family P-loop domain |
| | | containing 1 |
| 18 | 234698_at | chromosome 21 open reading frame 127 |
| 18 | 231304_at | glutamate receptor, ionotropic, N-methyl- |
| | | D-aspartate 3A |
| 19 | 239182_at | hypothetical LOC401022 |
| 19 | 1562093_at | no current annotation |
| 19 | 226192_at | no current annotation |
| 19 | 1554140_at | hypothetical protein FLJ23129 |
| 19 | 237021_at | hypothetical protein LOC144486 |
| 19 | 1556810_a_at | Wiskott-Aldrich syndrome-like |
| 20 | 228291_s_at | chromosome 20 open reading frame 19 |
| 20 | 219288_at | chromosome 3 open reading frame 14 |
| 20 | 222808_at | glycosyltransferase 28 domain containing 1 |
| 20 | 203075_at | SMAD, mothers against DPP homolog 2 |
| | | (Drosophila) |
| 20 | 217845_x_at | likely ortholog of mouse hypoxia induced |
| | | gene 1 |
| 20 | 218856_at | no current annotation |
| 20 | 226837_at | sprouty-related, EVH1 domain containing 1 |
| 20 | 220549_at | no current annotation |
| 20 | 201366_at | annexin A7 |
| 20 | 217870_s_at | UMP-CMP kinase |
| 20 | 209404_s_at | no current annotation |
| 20 | 224892_at | no current annotation |
| 20 | 1560565_at | no current annotation |
| 20 | 207405_s_at | RAD17 homolog (S. pombe) |
| 20 | 225087_at | hypothetical protein FLJ31153 |
| 20 | 236535_at | SMC6 structural maintenance of |
| | | chromosomes 6-like 1 (yeast) |
| 20 | 218603_at | headcase homolog (Drosophila) |
| 20 | 202007_at | nidogen (enactin) |
| 20 | 220103_s_at | mitochondrial ribosomal protein S18C |
| 20 | 238647_at | chromosome 14 open reading frame 28 |
| 20 | 213106_at | ATPase, aminophospholipid transporter |
| | | (APLT), Class I, type 8A, member 1 |
| 20 | 238614_x_at | zinc finger protein 430 |
| 21 | 220652_at | no current annotation |
| 21 | 243918_at | no current annotation |
| 21 | 222974_at | interleukin 22 |
| 21 | 217240_at | no current annotation |
| 21 | 211112_at | solute carrier family 12 (potassium/chloride |
| | | transporters), member 4 |
| 21 | 224950_at | prostaglandin F2 receptor negative |
| | | regulator |
| 21 | 206079_at | choroideremia-like (Rab escort protein 2) |
| 22 | 231525_at | IQ motif containing F1 |
| 22 | 1552322_at | hypothetical protein BC017868 |
| 22 | 213197_at | astrotactin |
| 22 | 243247_at | hypothetical protein MGC27434 |
| 22 | 1555212_at | olfactory receptor, family 8, subfamily B, |
| | | member 8 |
| 22 | 215759_at | no current annotation |
| 22 | 205579_at | histamine receptor H1 |
| 23 | 1558643_s_at | EGF-like repeats and discoidin I-like |
| | | domains 3 |
| 23 | 216927_at | no current annotation |
| 23 | 203930_s_at | microtubule-associated protein tau |
| 23 | 214981_at | periostin, osteoblast specific factor |
| 23 | 218995_s_at | endothelin 1 |
| 23 | 1561703_at | no current annotation |
| 24 | 220718_at | no current annotation |
| 24 | 244097_at | complement component (3d/Epstein Barr |
| | | virus) receptor 2 |
| 24 | 216214_at | no current annotation |
| 24 | 1553747_at | no current annotation |
| 24 | 240342_at | tripartite motif-containing 61 |
| 24 | 237000_at | no current annotation |
| 24 | 1566030_at | phosphatase and actin regulator 3 |
| 25 | 239506_s_at | hypothetical protein LOC151300 |
| 25 | 232277_at | no current annotation |
| 25 | 227932_at | ariadne homolog 2 (Drosophila) |
| 25 | 211801_x_at | mitofusin 1 |
| 25 | 243725_at | no current annotation |
| 26 | 220743_at | PRO0149 protein |
| 26 | 1562093_at | no current annotation |
| 26 | 220502_s_at | solute carrier family 13 (sodium/sulfate |
| | | symporters), member 1 |
| 26 | 227126_at | no current annotation |
| 26 | 244520_at | ubiquitin specific protease 1 |
| 26 | 211634_x_at | netrin 2-like (chicken) |
| 27 | 1560997_at | laminin, alpha 2 (merosin, congenital |
| | | muscular dystrophy) |
| 27 | 229370_at | no current annotation |
| 27 | 1563496_at | Six-twelve leukemia gene |
| 27 | 1552687_a_at | chromosome 20 open reading frame 152 |
| 27 | 1568935_at | no current annotation |
| 27 | 1566115_at | neural precursor cell expressed, |
| | | developmentally down-regulated 4-like |
| 27 | 238835_at | no current annotation |
| 27 | 231098_at | no current annotation |
| 27 | 1562290_at | protein phosphatase 2 (formerly 2A), |
| | | regulatory subunit B (PR 52), gamma |
| | | isoform |
| 28 | 214454_at | a disintegrin-like and metalloprotease |
| | | (reprolysin type) with thrombospondin type |
| | | 1 motif, 2 |
| 28 | 228712_at | WNK lysine deficient protein kinase 1 |
| 28 | 1561532_at | no current annotation |
| 28 | 214603_at | no current annotation |
| 28 | 226836_at | chromosome 6 open reading frame 83 |
| 28 | 206530_at | RAB30, member RAS oncogene family |
| 28 | 216572_at | no current annotation |
| 28 | 215394_at | phosphoinositide-3-kinase, class 3 |
| 29 | 205056_s_at | gene rich cluster, A gene |
| 29 | 1562728_at | no current annotation |
| 29 | 1557328_at | hypothetical protein LOC283665 |
| 29 | 211481_at | solute carrier organic anion transporter |
| | | family, member 1A2 |
| 29 | 1557636_a_at | hypothetical protein LOC136288 |
| 29 | 213303_x_at | zinc finger and BTB domain containing 7A |
| 29 | 232577_at | hypothetical protein LOC145945 |
| 29 | 226612_at | similar to CG4502-PA |
| 29 | 233285_at | hypothetical protein MGC34824 |
| 30 | 1563477_at | no current annotation |
| 30 | 233188_at | casein kinase 2, alpha 1 polypeptide |
| 30 | 1561408_at | no current annotation |
| 30 | 242419_at | SET and MYND domain containing 3 |
| 30 | 232830_at | no current annotation |
| 30 | 239052_at | heterogeneous nuclear ribonucleoprotein D |
| | | (AU-rich element RNA binding protein 1, |
| | | 37 kDa) |
| 30 | 234097_s_at | no current annotation |
| 30 | 208239_at | no current annotation |
| 30 | 210365_at | runt-related transcription factor 1 (acute |
| | | myeloid leukemia 1 |
| 30 | 1559800_a_at | no current annotation |
| 31 | 1557661_at | START domain containing 10 |
| 31 | 233000_x_at | no current annotation |
| 31 | 221945_at | no current annotation |
| 31 | 209490_s_at | EGF-like-domain, multiple 8 |
| 31 | 236098_at | RecQ protein-like 5 |
| 31 | 216240_at | Pvt1 oncogene homolog, MYC activator |
| | | (mouse) |
| 31 | 213281_at | no current annotation |
| 31 | 1560576_at | no current annotation |
| 31 | 1556883_a_at | hypothetical gene supported by AK127288 |
| 31 | 237670_at | hypothetical protein LOC284801 |
| 31 | 243881_at | no current annotation |
| 31 | 234608_at | no current annotation |
| 31 | 241841_at | carnitine palmitoyltransferase 1B (muscle) |
| 32 | 235238_at | rai-like protein |
| 32 | 1555179_at | immunoglobulin heavy variable 7-81 |
| 32 | 244278_at | no current annotation |
| 32 | 1569962_at | KIAA1026 protein |
| 32 | 1552524_at | ADP-ribosyltransferase 5 |
| 32 | 1555224_at | no current annotation |
| 32 | 244285_at | chromosome 6 open reading frame 102 |
| 32 | 1558199_at | fibronectin 1 |
| 32 | 207658_s_at | no current annotation |
| 32 | 204359_at | fibronectin leucine rich transmembrane |
| | | protein 2 |
| 32 | 217440_at | no current annotation |
| 32 | 244775_at | immunoglobulin superfamily, member 4C |
| 33 | 243991_at | no current annotation |
| 33 | 232937_at | leucine-rich repeats and calponin homology |
| | | (CH) domain containing 1 |
| 33 | 227389_x_at | interferon regulatory factor 2 binding |
| | | protein 2 |
| 33 | 216707_at | protocadherin 9 |
| 33 | 225616_at | hypothetical protein LOC283377 |
| 33 | 236895_at | sphingosine-1-phosphate lyase 1 |
| 33 | 231098_at | no current annotation |
| 33 | 206067_s_at | Wilms tumor 1 |
| 34 | 232830_at | no current annotation |
| 34 | 227554_at | no current annotation |
| 34 | 242284_at | hypothetical protein LOC199899 |
| 34 | 241215_at | muscle RAS oncogene homolog |
| 34 | 208367_x_at | no current annotation |
| 34 | 222247_at | putative X-linked retinopathy protein |
| 34 | 234126_at | opioid binding protein/cell adhesion |
| | | molecule-like |
| 34 | 229538_s_at | no current annotation |
| 34 | 236098_at | RecQ protein-like 5 |
| 34 | 244877_at | no current annotation |
| 34 | 244362_at | v-yes-1 Yamaguchi sarcoma viral oncogene |
| | | homolog 1 |
| 34 | 227752_at | serine palmitoyltransferase, long chain |
| | | base subunit 2-like (aminotransferase 2) |
| 34 | 223889_at | no current annotation |
| 34 | 232048_at | hypothetical protein MGC33371 |
| 34 | 1553181_at | DEAD (Asp-Glu-Ala-Asp) box polypeptide |
| | | 31 |
| 34 | 219402_s_at | Der1-like domain family, member 1 |
| 34 | 209053_s_at | Wolf-Hirschhorn syndrome candidate 1 |
| 35 | 242224_at | G patch domain containing 2 |
| 35 | 222736_s_at | transmembrane protein 38B |
| 35 | 226836_at | chromosome 6 open reading frame 83 |
| 35 | 210385_s_at | type 1 tumor necrosis factor receptor |
| | | shedding aminopeptidase regulator |
| 35 | 207045_at | hypothetical protein FLJ20097 |
| 35 | 236315_at | no current annotation |
| 35 | 205794_s_at | no current annotation |
| 35 | 230138_at | no current annotation |
| 35 | 222802_at | no current annotation |
| 35 | 233527_at | endothelial cell adhesion molecule |
| 36 | 218834_s_at | heat shock 70 kDa protein 5 (glucose- |
| | | regulated protein, 78 kDa) binding protein 1 |
| 36 | 1565073_at | no current annotation |
| 36 | 216927_at | no current annotation |
| 36 | 236206_at | dorsal neural-tube nuclear protein |
| 36 | 206291_at | neurotensin |
| 36 | 1562112_at | no current annotation |
| 36 | 1559002_at | hypothetical protein LOC340544 |
| 36 | 1556854_at | ATPase, Class VI, type 11A |
| 36 | 1556810_a_at | Wiskott-Aldrich syndrome-like |
| 37 | 227655_at | no current annotation |
| 37 | 1562086_at | no current annotation |
| 37 | 237598_at | no current annotation |
| 37 | 217440_at | no current annotation |
| 37 | 239220_at | protease, serine, 23 |
| 37 | 234507_at | no current annotation |
| 37 | 222901_s_at | potassium inwardly-rectifying channel, |
| | | subfamily J, member 16 |
| 37 | 233972_s_at | zinc finger protein 312 |
| 37 | 207017_at | RAB27B, member RAS oncogene family |
| 38 | 244789_at | aldolase A, fructose-bisphosphate |
| | | pseudogene 2 |
| 38 | 244103_at | chromosome 1 open reading frame 55 |
| 38 | 217500_at | no current annotation |
| 38 | 219421_at | no current annotation |
| 38 | 209187_at | down-regulator of transcription 1, TBP- |
| | | binding (negative cofactor 2) |
| 38 | 225872_at | solute carrier family 35, member F5 |
| 38 | 233898_s_at | FGFR1 oncogene partner 2 |
| 38 | 236477_at | no current annotation |
| 38 | 204496_at | striatin, calmodulin binding protein 3 |
| 38 | 222408_s_at | yippee-like 5 (Drosophila) |
| 38 | 201435_s_at | eukaryotic translation initiation factor 4E |
| 38 | 1554462_a_at | DnaJ (Hsp40) homolog, subfamily B, |
| | | member 9 |
| 38 | 203689_s_at | fragile X mental retardation 1 |
| 38 | 238856_s_at | pantothenate kinase 2 (Hallervorden-Spatz |
| | | syndrome) |
| 38 | 208316_s_at | no current annotation |
| 38 | 212867_at | no current annotation |
| 38 | 223085_at | ring finger protein 19 |
| 38 | 225133_at | no current annotation |
| 38 | 205518_s_at | no current annotation |
| 38 | 235394_at | no current annotation |
| 39 | 227519_at | placenta-specific 4 |
| 39 | 207771_at | solute carrier family 5 (sodium/glucose |
| | | cotransporter), member 2 |
| 39 | 211398_at | fibroblast growth factor receptor 2 |
| | | (bacteria-expressed kinase, keratinocyte |
| | | growth factor receptor, craniofacial |
| | | dysostosis 1, Crouzon syndrome, Pfeiffer |
| | | syndrome, Jackson-Weiss syndrome) |
| 39 | 1561148_at | no current annotation |
| 39 | 201210_at | DEAD (Asp-Glu-Ala-Asp) box polypeptide 3, |
| | | X-linked |
| 39 | 223069_s_at | echinoderm microtubule associated protein |
| | | like 4 |
| 39 | 242312_x_at | no current annotation |
| 39 | 221873_at | zinc finger protein 143 (clone pHZ-1) |
| 39 | 1554274_a_at | slingshot homolog 1 (Drosophila) |
| 40 | 214324_at | glycoprotein 2 (zymogen granule |
| | | membrane) |
| 40 | 231342_at | no current annotation |
| 40 | 1552897_a_at | potassium voltage-gated channel, |
| | | subfamily G, member 3 |
| 40 | 225627_s_at | KIAA1573 protein |
| 40 | 214372_x_at | no current annotation |
| 40 | 217302_at | no current annotation |
| 40 | 217598_at | no current annotation |
| 41 | 232335_at | no current annotation |
| 41 | 236136_at | pleckstrin homology, Sec7 and coiled-coil |
| | | domains 3 |
| 41 | 1560411_at | ataxin 2-binding protein 1 |
| 41 | 1554744_at | no current annotation |
| 41 | 208220_x_at | amelogenin, Y-linked |
| 41 | 1569634_at | no current annotation |
| 41 | 219691_at | sterile alpha motif domain containing 9 |
| 41 | 232751_at | no current annotation |
| 42 | 1563121_at | no current annotation |
| 42 | 210467_x_at | melanoma antigen family A, 2 |
| 42 | 234905_at | DKFZP434H168 protein |
| 42 | 218752_at | U11/U12 snRNP 20K |
| 42 | 1560609_at | crystallin, zeta (quinone reductase)-like 1 |
| 42 | 205817_at | sine oculis homeobox homolog 1 |
| | | (Drosophila) |
| 43 | 1558649_at | hypothetical protein LOC145757 |
| 43 | 1561460_at | no current annotation |
| 43 | 244231_at | no current annotation |
| 43 | 227804_at | hypothetical protein BC014072 |
| 43 | 241864_x_at | protein phosphatase 4, regulatory subunit 2 |
| 43 | 237522_at | Fas (TNF receptor superfamily, member 6) |
| 43 | 1566638_at | no current annotation |
| 43 | 203158_s_at | glutaminase |
| 44 | 220927_s_at | heparanase 2 |
| 44 | 1560692_at | hypothetical protein MGC33530 |
| 44 | 232937_at | leucine-rich repeats and calponin homology |
| | | (CH) domain containing 1 |
| 44 | 229288_at | no current annotation |
| 44 | 204556_s_at | DAZ interacting protein 1 |
| 44 | 1554707_at | chromosome 9 open reading frame 68 |
| 45 | 211531_x_at | proline-rich protein BstNI subfamily 1 |
| 45 | 1560588_at | no current annotation |
| 45 | 221240_s_at | UDP-GlcNAc:betaGal beta-1,3-N- |
| | | acetylglucosaminyltransferase 4 |
| 45 | 1556986_at | olfactory receptor, family 2, subfamily H, |
| | | member 1 |
| 45 | 229493_at | no current annotation |
| 45 | 1554680_s_at | potassium voltage-gated channel, delayed- |
| | | rectifier, subfamily S, member 2 |
| 45 | 207016_s_at | aldehyde dehydrogenase 1 family, member |
| | | A2 |
| 45 | 1566803_at | no current annotation |
| 45 | 228563_at | no current annotation |
| 45 | 216581_at | no current annotation |
| 46 | 220819_at | FERM domain containing 1 |
| 46 | 1561778_at | no current annotation |
| 46 | 230015_at | cytoglobin |
| 46 | 231051_at | solute carrier family 16 (monocarboxylic |
| | | acid transporters), member 9 |
| 46 | 220032_at | hypothetical protein FLJ21986 |
| 46 | 227441_s_at | E2a-Pbx1-associated protein |
| 46 | 1560833_at | no current annotation |
| 46 | 209540_at | insulin-like growth factor 1 (somatomedin |
| | | C) |
| 46 | 234879_at | no current annotation |
| 46 | 206165_s_at | chloride channel, calcium activated, family |
| | | member 2 |
| 47 | 206070_s_at | EPH receptor A3 |
| 47 | 1555135_at | no current annotation |
| 47 | 231365_at | homeo box A9 |
| 47 | 1555253_at | collagen, type XXV, alpha 1 |
| 47 | 220862_s_at | no current annotation |
| 47 | 237358_at | no current annotation |
| 47 | 206000_at | meprin A, alpha (PABA peptide hydrolase) |
| 47 | 1559641_at | chromosome 10 open reading frame 56 |
| 48 | 215613_at | a disintegrin and metalloproteinase domain |
| | | 12 (meltrin alpha) |
| 48 | 1563496_at | Six-twelve leukemia gene |
| 48 | 1568733_at | chromosome 10 open reading frame 76 |
| 48 | 242820_at | hypothetical protein FLJ37549 |
| 48 | 233658_at | no current annotation |
| 48 | 1553032_at | interleukin 31 receptor A |
| 48 | 217081_at | no current annotation |
| 48 | 222196_at | hypothetical protein LOC286434 |
| 48 | 207611_at | histone 1, H2bI |
| 48 | 230823_at | no current annotation |
| 49 | 1561212_at | no current annotation |
| 49 | 1561290_at | hypothetical protein LOC339622 |
| 49 | 226756_at | no current annotation |
| 49 | 217585_at | nebulette |
| 49 | 211130_x_at | ectodysplasin A |
| 49 | 203962_s_at | nebulette |
| 49 | 218629_at | smoothened homolog (Drosophila) |
| 49 | 208548_at | interferon, alpha 6 |
| 50 | 1562201_x_at | regulator of G-protein signalling 12 |
| 50 | 241942_at | hypothetical protein FLJ25471 |
| 50 | 1565554_at | hypothetical protein LOC127841 |
| 50 | 1560305_x_at | no current annotation |
| 50 | 236967_at | no current annotation |
| 50 | 242067_at | no current annotation |
| 50 | 1557759_at | hypothetical protein FLJ10241 |
| 50 | 1566002_at | ankyrin repeat domain 11 |
| 50 | 240203_at | no current annotation |
| 51 | 213664_at | solute carrier family 1 (neuronal/epithelial |
| | | high affinity glutamate transporter, system |
| | | Xag), member 1 |
| 51 | 1561527_at | no current annotation |
| 51 | 243783_at | no current annotation |
| 51 | 237415_at | no current annotation |
| 51 | 233000_x_at | no current annotation |
| 51 | 236206_at | dorsal neural-tube nuclear protein |
| 51 | 219835_at | PR domain containing 8 |
| 51 | 239776_at | no current annotation |
| 51 | 1558421_a_at | similar to RIKEN cDNA A530016L24 gene |
| 51 | 1560788_at | myosin IIIB |
| 51 | 220152_at | chromosome 10 open reading frame 95 |
| 51 | 237099_at | chromosome 20 open reading frame 70 |
| 51 | 206079_at | choroideremia-like (Rab escort protein 2) |
| 51 | 240250_at | no current annotation |
| 52 | 220449_at | no current annotation |
| 52 | 211437_at | mitogen-activated protein kinase kinase |
| | | kinase 4 |
| 52 | 238717_at | similar to Serine/threonine-protein kinase |
| | | PRKX (Protein kinase PKX1) |
| 52 | 207771_at | solute carrier family 5 (sodium/glucose |
| | | cotransporter), member 2 |
| 52 | 1560482_at | no current annotation |
| 52 | 211793_s_at | abl interactor 2 |
| 52 | 217712_at | no current annotation |
| 52 | 222196_at | hypothetical protein LOC286434 |
| 52 | 242909_at | no current annotation |
| 53 | 1565424_at | chromosome 8 open reading frame 8 |
| 53 | 233389_at | chromosome 20 open reading frame 26 |
| 53 | 205100_at | glutamine-fructose-6-phosphate |
| | | transaminase 2 |
| 53 | 207658_s_at | no current annotation |
| 53 | 216722_at | no current annotation |
| 53 | 234375_x_at | no current annotation |
| 53 | 207981_s_at | estrogen-related receptor gamma |
| 53 | 1555186_at | cyclin-dependent kinase inhibitor 1A (p21, |
| | | Cip1) |
| 53 | 216448_at | no current annotation |
| 53 | 205777_at | dual specificity phosphatase 9 |
| 53 | 215680_at | BCL2-interacting killer (apoptosis-inducing) |
| 53 | 208057_s_at | GLI-Kruppel family member GLI2 |
| 53 | 215643_at | sema domain, immunoglobulin domain |
| | | (Ig), short basic domain, secreted, |
| | | (semaphorin) 3D |
| 53 | 207289_at | matrix metalloproteinase 25 |
| 53 | 210503_at | no current annotation |
| 54 | 221546_at | PRP18 pre-mRNA processing factor 18 |
| | | homolog (yeast) |
| 54 | 231389_at | no current annotation |
| 54 | 243991_at | no current annotation |
| 54 | 240222_at | no current annotation |
| 54 | 218468_s_at | gremlin 1 homolog, cysteine knot |
| | | superfamily (Xenopus laevis) |
| 54 | 1557604_at | hypothetical gene supported by BC039682 |
| 54 | 1560177_at | no current annotation |
| 54 | 209904_at | troponin C, slow |
| 54 | 211909_x_at | no current annotation |
| 54 | 234407_s_at | no current annotation |
| 54 | 236895_at | sphingosine-1-phosphate lyase 1 |
| 55 | 229772_at | defensin, beta 123 |
| 55 | 215815_at | pentatricopeptide repeat domain 1 |
| 55 | 227893_at | chromosome 9 open reading frame 130 |
| 55 | 239235_at | no current annotation |
| 55 | 1557114_a_at | no current annotation |
| 55 | 232751_at | no current annotation |
| 55 | 216586_at | no current annotation |
| 56 | 1561673_at | no current annotation |
| 56 | 208789_at | polymerase I and transcript release factor |
| 56 | 1552602_at | calcium channel, voltage-dependent, |
| | | gamma subunit 5 |
| 56 | 206532_at | SWI/SNF related, matrix associated, actin |
| | | dependent regulator of chromatin, |
| | | subfamily b, member 1 |
| 56 | 227849_at | retinitis pigmentosa 9 (autosomal |
| | | dominant) |
| 57 | 204409_s_at | eukaryotic translation initiation factor 1A, |
| | | Y-linked |
| 57 | 1554042_s_at | chromosome 20 open reading frame 141 |
| 57 | 234135_x_at | palladin |
| 57 | 207553_at | opioid receptor, kappa 1 |
| 57 | 208335_s_at | Duffy blood group |
| 57 | 230393_at | no current annotation |
| 57 | 237263_at | no current annotation |
| 57 | 224321_at | no current annotation |
| 57 | 1561778_at | no current annotation |
| 57 | 221240_s_at | UDP-GlcNAc:betaGal beta-1,3-N- |
| | | acetylglucosaminyltransferase 4 |
| 57 | 1557753_at | no current annotation |
| 57 | 1554646_at | oxysterol binding protein-like 1A |
| 58 | 232192_at | hypothetical protein LOC153811 |
| 58 | 209779_at | hypothetical protein MGC14817 |
| 58 | 1570284_x_at | no current annotation |
| 58 | 1561212_at | no current annotation |
| 58 | 201647_s_at | scavenger receptor class B, member 2 |
| 58 | 220549_at | no current annotation |
| 58 | 223551_at | protein kinase (cAMP-dependent, catalytic) |
| | | inhibitor beta |
| 58 | 1565906_at | no current annotation |
| 59 | 231342_at | no current annotation |
| 59 | 1563725_at | zinc finger protein 583 |
| 59 | 216906_at | no current annotation |
| 59 | 1561055_at | no current annotation |
| 59 | 238222_at | down-regulated in gastric cancer GDDR |
| 59 | 232259_s_at | no current annotation |
| 59 | 230996_at | hypothetical protein LOC339929 |
| 59 | 205579_at | histamine receptor H1 |
| 59 | 224429_x_at | no current annotation |
| 59 | 1562398_at | v-myb myeloblastosis viral oncogene |
| | | homolog (avian) |
| 60 | 1566551_at | PDZ domain containing RING finger 3 |
| 60 | 1562718_at | no current annotation |
| 60 | 229332_at | hypothetical protein MGC15668 |
| 60 | 235627_at | no current annotation |
| 60 | 1553115_at | naked cuticle homolog 1 (Drosophila) |
| 60 | 1553813_s_at | no current annotation |
| 61 | 1569680_at | no current annotation |
| 61 | 223661_at | no current annotation |
| 61 | 223326_s_at | hypothetical protein FLJ90297 |
| 61 | 206173_x_at | GA binding protein transcription factor, |
| | | beta subunit 2, 47 kDa |
| 61 | 201399_s_at | translocation associated membrane protein 1 |
| 61 | 205246_at | peroxisome biogenesis factor 13 |
| 61 | 207472_at | no current annotation |
| 61 | 220156_at | hypothetical protein FLJ11767 |
| 62 | 224061_at | indolethylamine N-methyltransferase |
| 62 | 1561532_at | no current annotation |
| 62 | 242465_at | no current annotation |
| 62 | 234954_at | no current annotation |
| 62 | 1559226_x_at | late cornified envelope 1E |
| 62 | 208460_at | gap junction protein, alpha 7, 45 kDa |
| | | (connexin 45) |
| 63 | 222771_s_at | myelin expression factor 2 |
| 63 | 236099_at | no current annotation |
| 63 | 208712_at | cyclin D1 (PRAD1: parathyroid |
| | | adenomatosis 1) |
| 63 | 229566_at | no current annotation |
| 63 | 242354_at | no current annotation |
| 63 | 1552698_at | alpha tubulin-like |
| 63 | 226670_s_at | no current annotation |
| 63 | 1555731_a_at | adaptor-related protein complex 1, sigma 3 |
| | | subunit |
| 63 | 231985_at | microtubule associated monoxygenase, |
| | | calponin and LIM domain containing 3 |
| 63 | 244508_at | septin 7 |
| 63 | 221030_s_at | Rho GTPase activating protein 24 |
| 63 | 215767_at | chromosome 2 open reading frame 10 |
| 63 | 1561469_at | no current annotation |
| 63 | 224989_at | no current annotation |
| 63 | 210150_s_at | no current annotation |
| 63 | 222996_s_at | CXXC finger 5 |
| 63 | 242365_at | hypothetical protein MGC20481 |
| 63 | 223967_at | no current annotation |
| 63 | 209940_at | poly (ADP-ribose) polymerase family, |
| | | member 3 |
| 63 | 47553_at | deafness, autosomal recessive 31 |
| 63 | 222238_s_at | polymerase (DNA directed), mu |
| 63 | 238987_at | no current annotation |
| 63 | 215688_at | no current annotation |
| 63 | 243450_at | A kinase (PRKA) anchor protein 13 |
| 63 | 240260_at | protein tyrosine phosphatase, non-receptor |
| | | type 1 |
| 63 | 233790_at | guanine nucleotide binding protein (G |
| | | protein), gamma 7 |
| 63 | 1559776_at | GM2 ganglioside activator |
| 63 | 241928_at | cyclin-dependent kinase-like 1 (CDC2- |
| | | related kinase) |
| 63 | 1557172_x_at | NIMA (never in mitosis gene a)-related |
| | | kinase 8 |
| 63 | 1555571_at | IMP2 inner mitochondrial membrane |
| | | protease-like (S. cerevisiae) |
| 63 | 212345_s_at | cAMP responsive element binding protein |
| | | 3-like 2 |
| 63 | 235335_at | ATP-binding cassette, sub-family A (ABC1), |
| | | member 9 |
| 63 | 209598_at | paraneoplastic antigen MA2 |
| 64 | 239812_s_at | hypothetical protein FLJ12476 |
| 64 | 1563797_at | dystonin |
| 64 | 221390_s_at | myotubularin related protein 7 |
| 64 | 221945_at | no current annotation |
| 64 | 1562455_at | no current annotation |
| 64 | 241390_at | no current annotation |
| 64 | 244323_at | basic helix-loop-helix domain containing, |
| | | class B, 5 |
| 64 | 210064_s_at | uroplakin 1B |
| 64 | 206070_s_at | EPH receptor A3 |
| 64 | 239910_at | pregnancy specific beta-1-glycoprotein 1 |
| 64 | 217668_at | similar to hypothetical protein LOC192734 |
| 64 | 236323_at | no current annotation |
| 64 | 230508_at | dickkopf homolog 3 (Xenopus laevis) |
| 64 | 236895_at | sphingosine-1-phosphate lyase 1 |
| 64 | 241230_at | no current annotation |
| 65 | 1569719_at | BCL2-like 14 (apoptosis facilitator) |
| 65 | 234424_at | no current annotation |
| 65 | 215845_x_at | no current annotation |
| 65 | 204029_at | cadherin, EGF LAG seven-pass G-type |
| | | receptor 2 (flamingo homolog, Drosophila) |
| 65 | 230727_at | polycomb group ring finger 2 |
| 65 | 231162_at | hypothetical protein MGC33839 |
| 66 | 237771_s_at | no current annotation |
| 66 | 216182_at | synaptojanin 2 |
| 66 | 223966_at | no current annotation |
| 66 | 239257_at | Mov10l1, Moloney leukemia virus 10-like 1, |
| | | homolog (mouse) |
| 66 | 230686_s_at | solute carrier family 13 (sodium-dependent |
| | | dicarboxylate transporter), member 3 |
| 66 | 217272_s_at | serine (or cysteine) proteinase inhibitor, |
| | | clade B (ovalbumin), member 13 |
| 66 | 215370_at | similar to KIAA0160 gene product is novel |
| 66 | 1561149_at | no current annotation |
| 66 | 232437_at | related to CPSF subunits 68 kDa |
| 66 | 234407_s_at | no current annotation |
| 67 | 231992_x_at | no current annotation |
| 67 | 234521_at | no current annotation |
| 67 | 230819_at | KIAA1957 |
| 67 | 1563145_at | hypothetical protein MGC39681 |
| 67 | 242411_at | ADP-ribosylation factor-like 10A |
| 67 | 228422_at | lipoma HMGIC fusion partner-like protein 4 |
| 67 | 209211_at | Kruppel-like factor 5 (intestinal) |
| 67 | 216126_at | no current annotation |
| 67 | 205475_at | scrapie responsive protein 1 |
| 67 | 223474_at | chromosome 14 open reading frame 4 |
| 67 | 238515_at | no current annotation |
| 67 | 228854_at | no current annotation |
| 67 | 204995_at | cyclin-dependent kinase 5, regulatory |
| | | subunit 1 (p35) |
| 67 | 205883_at | zinc finger and BTB domain containing 16 |
| 67 | 219963_at | dual specificity phosphatase 13 |
| 67 | 233126_s_at | thioesterase domain containing 1 |
| 68 | 215685_s_at | distal-less homeo box 2 |
| 68 | 239575_at | transmembrane protein 10 |
| 68 | 244367_at | LIM domain only 2 (rhombotin-like 1) |
| 68 | 219450_at | hypothetical protein FLJ11017 |
| 68 | 240777_at | spectrin repeat containing, nuclear |
| | | envelope 2 |
| 68 | 240497_at | no current annotation |
| 68 | 231508_s_at | no current annotation |
| 68 | 232751_at | no current annotation |
| 69 | 236353_at | no current annotation |
| 69 | 1553894_at | no current annotation |
| 69 | 220213_at | no current annotation |
| 69 | 226020_s_at | OMA1 homolog, zinc metallopeptidase |
| | | (S. cerevisiae) |
| 69 | 1562939_at | leucine rich repeat containing 16 |
| 69 | 204562_at | interferon regulatory factor 4 |
| 69 | 206337_at | chemokine (C-C motif) receptor 7 |
| 69 | 235353_at | KIAA0746 protein |
| 69 | 208456_s_at | related RAS viral (r-ras) oncogene homolog 2 |
| 69 | 225635_s_at | no current annotation |
| 69 | 224048_at | no current annotation |
| 69 | 213054_at | KIAA0841 |
| 69 | 231964_at | no current annotation |
| 69 | 202585_s_at | nuclear transcription factor, X-box binding 1 |
| 69 | 1558809_s_at | hypothetical protein LOC284408 |
| 69 | 230598_at | no current annotation |
| 69 | 242064_at | sidekick homolog 2 (chicken) |
| 69 | 1555388_s_at | sorting nexin 25 |
| 69 | 202759_s_at | no current annotation |
| 69 | 231472_at | F-box protein 15 |
| 69 | 231418_at | membrane-spanning 4-domains, subfamily |
| | | A, member 1 |
| 69 | 239074_at | GRB2-related adaptor protein |
| 69 | 228392_at | zinc finger protein 302 |
| 69 | 243957_at | no current annotation |
| 70 | 232733_s_at | KIAA1510 protein |
| 70 | 229400_at | homeo box D10 |
| 70 | 1561211_at | no current annotation |
| 70 | 216906_at | no current annotation |
| 70 | 1559804_at | no current annotation |
| 70 | 225566_at | neuropilin 2 |
| 70 | 208220_x_at | amelogenin, Y-linked |
| 70 | 214651_s_at | homeo box A9 |
| 70 | 233472_at | no current annotation |
| 70 | 220595_at | PDZ domain containing RING finger 4 |
| 70 | 222597_at | synaptosomal-associated protein, 29 kDa |
| 70 | 216564_at | no current annotation |
| 70 | 227771_at | leukemia inhibitory factor receptor |
| 70 | 242257_at | no current annotation |
| 71 | 214320_x_at | cytochrome P450, family 2, subfamily A, |
| | | polypeptide 7 |
| 71 | 1563069_at | no current annotation |
| 71 | 217684_at | thymidylate synthetase |
| 71 | 223069_s_at | echinoderm microtubule associated protein |
| | | like 4 |
| 71 | 244757_at | cytochrome P450, family 2, subfamily R, |
| | | polypeptide 1 |
| 72 | 209324_s_at | regulator of G-protein signalling 16 |
| 72 | 227190_at | transmembrane protein 37 |
| 72 | 228821_at | ST6 beta-galactosamide alpha-2,6- |
| | | sialyltranferase 2 |
| 72 | 207937_x_at | fibroblast growth factor receptor 1 (fms- |
| | | related tyrosine kinase 2, Pfeiffer syndrome) |
| 72 | 208335_s_at | Duffy blood group |
| 72 | 230393_at | no current annotation |
| 72 | 224399_at | programmed cell death 1 ligand 2 |
| 72 | 1567558_at | triggering receptor expressed on myeloid |
| | | cells-like 4 |
| 72 | 1561041_at | no current annotation |
| 72 | 1554886_a_at | Mlx interactor |
| 72 | 223745_at | F-box protein 31 |
| 72 | 1569644_at | no current annotation |
| 72 | 1570394_at | 5′-3′ exoribonuclease 1 |
| 72 | 208377_s_at | calcium channel, voltage-dependent, alpha |
| | | 1F subunit |
| 73 | 214090_at | PRKC, apoptosis, WT1, regulator |
| 73 | 1556133_s_at | aldolase A, fructose-bisphosphate |
| | | pseudogene 2 |
| 73 | 215810_x_at | dystonin |
| 73 | 230455_at | protein phosphatase 1, regulatory subunit |
| | | 9B, spinophilin |
| 73 | 227050_at | odz, odd Oz/ten-m homolog 3 (Drosophila) |
| 73 | 207228_at | protein kinase, cAMP-dependent, catalytic, |
| | | gamma |
| 73 | 214105_at | suppressor of cytokine signaling 3 |
| 74 | 236822_at | no current annotation |
| 74 | 1559513_a_at | Fanconi anemia, complementation group C |
| 74 | 216600_x_at | aldolase B, fructose-bisphosphate |
| 74 | 231556_at | glycoprotein, synaptic 2 |
| 74 | 242205_at | no current annotation |
| 74 | 244854_at | leupaxin |
| 74 | 229288_at | no current annotation |
| 74 | 214981_at | periostin, osteoblast specific factor |
| 74 | 237099_at | chromosome 20 open reading frame 70 |
| 74 | 208460_at | gap junction protein, alpha 7, 45 kDa |
| | | (connexin 45) |
| 74 | 1559641_at | chromosome 10 open reading frame 56 |
| 74 | 1556810_a_at | Wiskott-Aldrich syndrome-like |
| 74 | 239519_at | neuropilin 1 |
| 75 | 215515_at | kin of IRRE like (Drosophila) |
| 75 | 1567540_at | no current annotation |
| 75 | 233958_at | no current annotation |
| 75 | 215326_at | p21(CDKN1A)-activated kinase 4 |
| 75 | 235184_at | AE binding protein 2 |
| 75 | 226847_at | follistatin |
| 75 | 222899_at | integrin, alpha 11 |
| 75 | 242883_at | otospiralin |
| 75 | 232577_at | hypothetical protein LOC145945 |
| 75 | 239693_at | sorting nexing 24 |
| 75 | 243288_at | SET and MYND domain containing 2 |
| 76 | 244789_at | aldolase A, fructose-bisphosphate |
| | | pseudogene 2 |
| 76 | 214354_x_at | surfactant, pulmonary-associated protein B |
| 76 | 217351_at | no current annotation |
| 76 | 206109_at | fucosyltransferase 1 (galactoside 2-alpha- |
| | | L-fucosyltransferase) |
| 77 | 220743_at | PRO0149 protein |
| 77 | 237545_at | calmodulin binding transcription activator 1 |
| 77 | 1562093_at | no current annotation |
| 77 | 234449_at | no current annotation |
| 77 | 222675_s_at | BAI1-associated protein 2-like 1 |
| 77 | 1564017_at | chromosome 21 open reading frame 123 |
| 77 | 1560498_at | no current annotation |
| 77 | 1556810_a_at | Wiskott-Aldrich syndrome-like |
| 78 | 1570295_at | vacuolar protein sorting 13A (yeast) |
| 78 | 1559901_s_at | chromosome 21 open reading frame 34 |
| 78 | 1563367_at | intramembrane protease 5 |
| 78 | 1563316_at | neuronal growth regulator 1 |
| 78 | 217081_at | no current annotation |
| 78 | 1565906_at | no current annotation |
| 79 | 1564856_s_at | olfactory receptor, family 4, subfamily N, |
| | | member 4 |
| 79 | 1552865_a_at | likely ortholog of mouse Pas1 candidate 1 |
| 79 | 1556786_at | no current annotation |
| 79 | 1554528_at | chromosome 3 open reading frame 15 |
| 79 | 236098_at | RecQ protein-like 5 |
| 79 | 215623_x_at | SMC4 structural maintenance of |
| | | chromosomes 4-like 1 (yeast) |
| 79 | 232048_at | hypothetical protein MGC33371 |
| 79 | 202752_x_at | solute carrier family 7 (cationic amino acid |
| | | transporter, y+ system), member 8 |
| 79 | 1567376_at | heat shock regulated 1 |
| 79 | 206067_s_at | Wilms tumor 1 |
| 80 | 241301_at | RAB22A, member RAS oncogene family |
| 80 | 237193_s_at | ribosomal protein L21 |
| 80 | 206938_at | steroid-5-alpha-reductase, alpha |
| | | polypeptide 2 (3-oxo-5 alpha-steroid delta |
| | | 4-dehydrogenase alpha 2) |
| 81 | 1562775_at | no current annotation |
| 81 | 242979_at | no current annotation |
| 81 | 219318_x_at | mediator of RNA polymerase II |
| | | transcription, subunit 31 homolog (yeast) |
| 81 | 229332_at | hypothetical protein MGC15668 |
| 81 | 216707_at | protocadherin 9 |
| 81 | 228724_at | no current annotation |
| 81 | 232429_at | no current annotation |
| 81 | 227797_x_at | hypothetical protein dJ122O8.2 |
| 81 | 1561261_at | no current annotation |
| 82 | 1560542_at | MCM3 minichromosome maintenance |
| | | deficient 3 (S. cerevisiae) associated protein |
| 82 | 210712_at | lactate dehydrogenase A-like 6B |
| 82 | 216116_at | NCK interacting protein with SH3 domain |
| 82 | 220927_s_at | heparanase 2 |
| 82 | 214651_s_at | homeo box A9 |
| 82 | 214233_at | golgi associated, gamma adaptin ear |
| | | containing, ARF binding protein 2 |
| 82 | 223736_at | carnitine deficiency-associated, expressed |
| | | in ventricle 1 |
| 82 | 1560550_at | no current annotation |
| 83 | 231350_at | no current annotation |
| 83 | 241260_at | no current annotation |
| 83 | 208566_at | no current annotation |
| 83 | 236357_at | no current annotation |
| 83 | 243991_at | no current annotation |
| 83 | 240222_at | no current annotation |
| 83 | 1552514_at | hypothetical protein MGC26816 |
| 83 | 231911_at | KIAA1189 |
| 83 | 206375_s_at | heat shock 27 kDa protein 3 |
| 84 | 1554983_at | chromosome 21 open reading frame 117 |
| 84 | 207477_at | no current annotation |
| 84 | 208500_x_at | forkhead box D3 |
| 84 | 1554383_a_at | translocation associated membrane protein 2 |
| 84 | 1569545_at | no current annotation |
| 84 | 1560962_at | no current annotation |
| 85 | 1566551_at | PDZ domain containing RING finger 3 |
| 85 | 1554646_at | oxysterol binding protein-like 1A |

Using this superset of metagenes, the inventors have identified a subset of 7 metagenes that are specifically associated with the presence of anatomic coronary artery disease. This subset is listed in Table 2. Within the 85 metagenes, it is expected that there will be subsets associated with the presence of carotid artery atherosclerosis; presence of soft, vulnerable coronary artery plaques prone to cause heart attacks; presence of normal versus dysfunctional stem cell populations for vascular repair of atherosclerosis

It has further been determined that selection of the gene set so that they fall within at least 5 of the 7 groups of metagenes represented by the 69 genes, i.e. metagene groups 32, 11, 67, 75, 10, 8 and 24, preferably within all 7 of the groups, improves the predictive ability.

Depending upon selection of the gene set and individual subject results, the method is expected to identify subjects with at least about 50%, preferably at least 60%, 70%, 75%, 80% or 85% probability of having CAD. The method may be used in conjunction with clinical variables, such as weight, body mass index, cholesterol levels, LDL/HDL ratio and other clinical variables associated with CAD for increased prediction levels.

Gene expression profiling can be measured by any means known in the art, for example using microarrays, such as Affymetrix GeneChip™. Other methods for measuring the presence and/or amounts of nucleic acids in a sample include, e.g., various types of hybridization assays, and quantitative PCR assays, such as quantitative real-time PCR, using suitable probe pairs to amplify cDNA copies of transcribed RNAs. Alternatively, transcriptomics can be used, in which the actual mRNA copy numbers are counted.

In another aspect, the invention provides a method of data reduction for selecting a set of features (genes) associated with a specific condition. The method is particularly useful in the analysis of microarray gene data, and the selection of genetic markers for specific diseases and disorders. In one embodiment, the method comprises the steps of

(a) Using significance analysis of microarrays (SAM) from data obtained from an experimental and a control group of subjects to select an initial set of features;

(b) Using binary prediction tree analysis to select additional features; thereby obtaining a set of features that is predictive of the condition.

“Significance Analysis of Microarrays” (SAM) is a statistical technique for determining whether changes in gene expression are statistically significant. See, e.g., Tusher et al (2001) PNAS 98:5116-5121.) SAM is distributed by Stanford University in a R-package. See, e.g., the world wide web site stat.stanford.edu/˜tibs/SAM.

Specific conditions for which the method may be useful include, for example, pharmacogenomics, ventricular arrhythmias, and identifying signals for stem cell mediated vascular repair. The method for using the feature reduction with multiple methods ending with the use of the binary trees will be very useful for complex disorders for which the gene expression signature may be subtle. By definition, complex disorders are likely resulting from multiple small changes that add up to the disease rather than one or two big changes. By identifying individuals with coronary artery disease, treatment can be provided that can prevent adverse outcomes such as myocardial infarction, sudden cardiac death, heart failure, atrial fibrillation, ventricular fibrillation/tachycardia.

It is also very likely that the blood profile for coronary artery disease will also be useful to detect atherosclerosis in other vascular beds, such as carotid atherosclerosis and atherosclerosis of the lower extremities—peripheral vascular disease. In doing so, we can apply treatments not only to prevent progression of these disorders, but we can also prevent the adverse outcomes that result from these two disorders: cerebrovascular disease, critical limb ischemia leading to amputation, and lower extremity ulceration.

For optimal prediction level, the method can be further refined by including an appropriate set of clinical variables.

One aspect of the invention is a method for method for screening a subject for the presence of coronary atherosclerosis, said method comprising,

measuring the expression level of at least about 5 of the genes of Table 2 (whose properties are also described in Table 3) (e.g., at least 10, 15, 20, 30, 40, 50, 60, or all 69 of the genes) in a biological sample obtained from said subject,

wherein an elevated level of expression (e.g., a significantly increased level, such as a statistically significantly increased level) of said at least 5 genes compared to a control level measured in a population of normal subjects is indicative of an increased probability of the subject having significant atherosclerosis (e.g., subclinical coronary atherosclerosis). In one embodiment of the invention, the subject being tested does not exhibit any clinical manifestations of CAD. In one embodiment, a subject exhibiting such an elevated level of expression is deemed suitable to receive aggressive preventive treatments and/or additional testing. When the genes in Table 2 are referred to herein, the gene characteristics described in Table 3 are also included.

The levels of expression can be determined for any combination of 5 genes from Table 2, or more, and the levels can be determined simultaneously, or in any order.

Another embodiment of the invention is a method for screening a subject for the presence of coronary atherosclerosis, said method comprising

(a) providing a sample obtained from a subject, for example a subject suspected of having, or at risk for having, CAD;

(b) determining in the sample the amount of expression of at least about 5 of the genes of Table 2 (e.g., at least 10, 15, 20, 30, 40, 50, 60, or all 69 of the genes); and

(c) comparing the levels of expression of the genes to a control level measured in a population of normal subjects,

wherein an elevated level of expression (e.g., a significantly increased level, such as a statistically significantly increased level) of said at least 5 genes compared to the control level is indicative of an increased probability of the subject having coronary atherosclerosis (e.g., significant subclinical coronary atherosclerosis).

A sample which is “provided” can be obtained by the person (or machine) conducting the assay, or it can have been obtained by another, and transferred to the person (or machine) carrying out the assay.

By a “sample” (e.g. a test sample) from a subject meant a sample that might be expected to contain elevated levels of the expression markers of the invention in a subject having CAD. Many suitable sample types will be evident to a skilled worker. In one embodiment of the invention, the sample is a blood sample, such as whole blood, plasma, or serum (plasma from which clotting factors have been removed). For example, peripheral, arterial or venous plasma or serum can be used. Methods for obtaining samples and preparing them for analysis (e.g., for detection of the amount of nucleic acid) are conventional and well-known in the art. Some suitable methods are described in the Examples herein or in the references cited herein.

A “subject,” as used herein, includes any animal that has, or is at risk for, or is suspected of having, CAD. Suitable subjects (patients) include laboratory animals (such as mouse, rat, rabbit, guinea pig or pig), farm animals, sporting animals (e.g. dogs or horses) and domestic animals or pets (such as a horse, dog or cat). Non-human primates and human patients are included. For example, human subjects who present with chest pain or other symptoms of cardiac distress, including, e.g. shortness of breath, nausea, vomiting, sweating, weakness, fatigue, or palpitations, can be evaluated by a method of the invention. About ¼ of MI (myocardial infarctions) are silent and without chest pain. Furthermore, patients who have been evaluated in an emergency room or in an ambulance or physician's office and then dismissed as not being ill according to current tests for CAD have an increased risk of having a heart attack in the next 24-48 hours; such patients can be monitored by a method of the invention to determine if and when they begin express markers of the invention, which indicates that, e.g., they are beginning to exhibit CAD. Subjects can also be monitored by a method of the invention to improve the accuracy of current provocative tests for ischemia, such as exercise stress testing. An individual can be monitored by a method of the invention during exercise stress tests to determine if the individual is at risk for ischemia; such monitoring can supplement or replace the test that is currently carried out. Athletes (e.g., humans, racing dogs or race horses) can be monitored during training to ascertain if they are exerting themselves too vigorously and are in danger of undergoing an MI.

A method as above may further comprise measuring in the sample the amount of one or more other well-known markers that have been reported to be diagnostic of CAD, including the expression of cardiac specific isoforms of troponin I (TnI) and/or troponin T (TnT), wherein a significant increase (e.g., at least a statistically significant increase) of the one or more markers compared to the level in a normal control is further indicative that the subject has CAD. A method of the invention can also be combined with any of a variety of clinical tests for CAD, including some of the criteria discussed herein.

Another aspect of the method is a method for deciding how to treat a subject suspected of having CAD, or a subject that is at high risk for having CAD, comprising determining by a method as above if the subject has (or is likely to have) CAD and, (1) if the subject is determined to have, or to be likely to have, CAD, deciding to treat the subject aggressively [such as by seeking more intensive lowering of serum cholesterol and blood pressure with medications, adding antiplatelet medications (e.g., aspirin, clopidogrel), diagnostic testing such as cardiac stress testing, cardiac MRI or coronary angiography] or (2) if the subject is determined not to have (or not to be likely to have) CAD, the current level of preventive cardiovascular management would be maintained.

Another aspect of the invention is a method for treating a subject suspected of having CAD, or a subject that is at high risk for having CAD, comprising determining by a method as above if the subject has (or is likely to have) CAD and, (1) if the subject is determined to have (or to be likely to have) CAD, treating the subject aggressively, as indicated above, or (2) if the subject is determined not to have (or not to be likely to have) CAD, treating the subject non-aggressively, as indicated above.

Another aspect of the invention is a kit for detecting the presence of CAD in a subject, comprising reagents for detecting the levels of expression of at least five (e.g., any combination of, e.g, 5, 10, 20, 30, 40, 50, 60 or all 69) of the genes of Table 2.

When the values of more than one expressed marker are being analyzed, a statistical method such as multi-variant analysis or principal component analysis (PCA) is used which takes into account the levels of the various nucleic acids (e.g., using a linear regression score).

In some embodiments, it is desirable to express the results of an assay in terms of an increase (e.g., a statistically significant increase) in a value (or combination of values) compared to a baseline value.

A “significant” increase in a value, as used herein, can refer to a difference which is reproducible or statistically significant, as determined using statistical methods that are appropriate and well-known in the art, generally with a probability value of less than five percent chance of the change being due to random variation. In general, a statistically significant value is at least two standard deviations from the value in a “normal” healthy control subject. Suitable statistical tests will be evident to a skilled worker. For example, a significant increase in the amount of a nucleic acid marker compared to a baseline value can be about 50%, 2-fold, or more higher. A significantly elevated amount of a nucleic acid expression marker of the invention compared to a suitable baseline value, then, is indicative that a test subject has CAD (indicates that the subject is likely to have CAD). A subject is “likely” to have CAD if the subject has levels of the marker nucleic acids significantly above those of a healthy control or his own baseline (taken at an earlier time point). The extent of the increased levels correlates to the % chance. For example, the subject can have greater than about a 50% chance, e.g., greater than about 70%, 80% 90%, 95% or higher chance, of having CAD. In general, the presence of an elevated amount of a marker of the invention is a strong indication that the subject has CAD.

As used herein, a “baseline value” generally refers to the level (amount) of an expressed nucleic acid in a comparable sample (e.g., from the same type of tissue as the tested tissue, such as blood or serum), from a “normal” healthy subject that does not exhibit CAD. If desired, a pool or population of the same tissues from normal subjects can be used, and the baseline value can be an average or mean of the measurements. Suitable baseline values can be determined by those of skill in the art without undue experimentation. Suitable baseline values may be available in a database compiled from the values and/or may be determined based on published data or on retrospective studies of patients' tissues, and other information as would be apparent to a person of ordinary skill implementing a method of the invention. Suitable baseline values may be selected using statistical tools that provide an appropriate confidence interval so that measured levels that fall outside the standard value can be accepted as being aberrant from a diagnostic perspective, and predictive of CAD.

It is generally not practical in a clinical or research setting to use patient samples as sources for baseline controls. Therefore, one can use any of variety of reference values in which the same or a similar level of expression is found as in a subject that does not have CHD.

It will be appreciated by those of skill in the art that a baseline or normal level need not be established for each assay as the assay is performed but rather, baseline or normal levels can be established by referring to a form of stored information regarding a previously determined baseline levels for a given nucleic acid or panel of nucleic acids, such as a baseline level established by any of the above-described methods. Such a form of stored information can include, for example, a reference chart, listing or electronic file of population or individual data regarding “normal levels” (negative control) or positive controls; a medical chart for the patient recording data from previous evaluations; a receiver-operator characteristic (ROC) curve; or any other source of data regarding baseline levels that is useful for the patient to be diagnosed. In one embodiment of the invention, the amount of the nucleic acids in a combination of nucleic acids, compared to a baseline value, is expressed as a linear regression score, as described, e.g., in Irwin, in Neter, Kutner, Nachtsteim, Wasserman (1996) Applied Linear Statistical Models, 4^{th} edition, page 295.

In an embodiment in which the progress of a treatment is being monitored, a baseline value can be based on earlier measurements taken from the same subject, before the treatment was administered.

In general, molecular biology methods referred to herein are well-known in the art and are described, e.g., in Sambrook et al., Molecular Cloning: A Laboratory Manual, current edition, Cold Spring Harbor Laboratory, Cold Spring Harbor, N.Y., and Ausubel et al., Current Protocols in Molecular Biology, John Wiley & sons, New York, N.Y.

A detection (diagnostic) method of the invention can be adapted for many uses. For example, it can be used to follow the progression of CAD. In one embodiment of the invention, the detection is carried out both before (or at approximately the same time as), and after, the administration of a treatment, and the method is used to monitor the effectiveness of the treatment. A subject can be monitored in this way to determine the effectiveness for that subject of a particular drug regimen, or a drug or other treatment modality can be evaluated in a pre-clinical or clinical trial. If a treatment method is successful, the levels of the nucleic acid markers of the invention are expected to decrease.

A method of the invention can be used to suggest a suitable method of treatment for a subject. For example, if a subject is determined by a method of the invention to be likely to have CAD, a decision can be made to treat the subject with an aggressive form of treatment (e.g. as described elsewhere herein); and, in one embodiment, the treatment is then administered. Methods for carrying out such treatments are conventional and well-known. By contrast, if a subject is determined not to be likely to have CAD, a decision can be made to adopt a less aggressive treatment regimen; and, in one embodiment, the subject is then treated with this less aggressive forms of treatment. Suitable less aggressive forms of treatment include, for example, maintaining the current level of preventive cardiovascular management, using procedures that are conventional and well-known in the art. A subject that does not have CAD is thus spared the unpleasant side-effects associated with the unnecessary, more aggressive forms of treatment. By “treated” is meant that an effective amount of a drug or other anti-heart disease procedure is administered to the subject. An “effective” amount of an agent refers to an amount that elicits a detectable response (e.g. of a therapeutic response) in the subject.

One aspect of the invention is a kit for detecting whether a subject is likely to have CAD, comprising one or more agents for detecting the amount of a nucleic acid marker of the invention. As used herein, the singular forms “a,” “an” and “the” include plural referents unless the context clearly dictates otherwise. For example, “a” nucleic acid of the invention, as used above, includes 2, 3, 4, 5 or more of the nucleic acids. In addition, agents for detecting other markers for CAD (e.g., as discussed elsewhere herein) can also be present in a kit. The kit may also include additional agents suitable for detecting, measuring and/or quantitating the amount of nucleic acid, including conventional analytes for creation of standard curves. Among other uses, kits of the invention can be used in experimental applications. A skilled worker will recognize components of kits suitable for carrying out a method of the invention.

A kit of the invention can comprise a composition of probes or primers that are specific for one or more of the nucleic acids of the invention (e.g., probes arranged in the form of an array, such as a microarray) and, optionally, one or more reagents that facilitate hybridization of the probes or primers in the composition to a test polynucleotide of interest, and/or that facilitate detection of the hybridized polynucleotide(s). Methods for designing and preparing probes that are specific for hybridizing and identifying a nucleic acid marker of the invention, or that can be used as primers (e.g. PCR primers) for specifically amplifying a nucleic acid marker of the invention, are conventional and well-known in the art.

Optionally, a kit of the invention may comprise instructions for performing the method. Optional elements of a kit of the invention include suitable buffers, containers, or packaging materials. The reagents of the kit may be in containers in which the reagents are stable, e.g., in lyophilized form or stabilized liquids. The reagents may also be in single use form, e.g., for the performance of an assay for a single subject.

The present invention also relates to combinations in which the nucleic acids of the invention, or probes or primers that are specific for them, are represented, not by physical molecules, but by computer-implemented databases. For example, the present invention relates to electronic forms of polynucleotides of the present invention, including a computer-readable medium (e.g., magnetic, optical, etc., stored in any suitable format, such as flat files or hierarchical files) which comprise such sequences, or fragments thereof, e-commerce-related means, etc. An investigator may, e.g., compare an expression profile exhibited by a sample from a subject to an electronic form of one of the expression profiles of the invention, and may thereby diagnose whether the subject is likely to have CAD.

In the foregoing and in the following examples, all temperatures are set forth in uncorrected degrees Celsius; and, unless otherwise indicated, all parts and percentages are by weight.

### EXAMPLES

### Example I

### Materials and Methods

### A. Subjects

The discovery cohort was selected from the Duke Cardiac Catheterization Genetics and Genomics (CATHGEN) repository that stores blood samples in PAXgene™ RNA tubes (PreAnalytiX, Valencia, Calif.). Wanting to reflect a general population of patients presenting for cardiac catheterization, we selected a discovery cohort that considered the extent of coronary artery disease (CAD) as the sole selection criterion. This discovery cohort consisted of two groups: 57 subjects with minimal CAD with no stenoses exceeding 25% of the coronary artery lumen diameter, and 49 subjects with severe CAD with at least one stenosis of 75% or greater.

Two additional cohorts were then selected to establish the validity of the genomic findings generated using the discovery cohort. One group was selected from the Duke CATHGEN repository using the same criteria as the discovery cohort, 25 subjects with minimal CAD and 30 subjects with severe CAD.

A second, external validation set was selected to examine whether the genomic predictors identified in the discovery cohort would have predictive value in subjects not treated in the Duke cardiac catheterization laboratory. This data set was from a separate unpublished research study. The microarray data were generated using peripheral blood mononuclear cells (PBMCs) of patients undergoing cardiac catheterization at an outside facility. A Freisinger Index was calculated in these subjects, and we divided the dataset into minimal or severe CAD groups based on the Freisinger Index¹³. In this CAD scoring method, a numeric score for CAD burden was assigned to each of the three epicardial arteries based upon the severity of disease, and the Freisinger Index reflected the sum of the three numeric scores. For the second validation cohort, six subjects had minimal disease, defined as a Freisinger Index score of 1.5 or less, while 18 subjects had moderate to severe disease, defined as a Freisinger Index score of greater than 1.5¹³.

### B. Generation of Microarray Data

For the discovery and validation cohorts selected from CATHGEN, RNA was extracted using the Versagene™ RNA Purification Kit (Gentra Systems, Inc, Minneapolis, Minn.). RNA quality was evaluated using the Agilent 2100 Bioanalyzer (Agilent Technologies). We performed globin reduction with a standard human GLOBINclear™ (Ambion, Austin, Tex.) protocol¹⁴, and quality was reconfirmed by the Agilent 2100 Bioanalyzer. The cRNA probes were generated with the Affymetrix GeneChip™ (Affymetrix, Santa Clara, Calif.) one-cycle in vitro transcription labeling protocol and were hybridized to the Affymetrix U133 2.0 Plus Human array that contains 54,613 transcripts. The microarray hybridization was performed by the Duke Microarray Core Facility (Expression Analysis, Research Triangle Park, N.C.). The data for the second validation cohort had already been generated prior to the initiation of this investigation. The microarray data were obtained using the same methods as above. The globin reduction step was unnecessary since PBMCs were used.

### C. Approach for Classifying Subjects by CAD Burden Using Gene Expression Data

Significance Analysis of Microarrays (SAM) was used for the initial feature selection from among the 54,613 genes represented on the microarray¹⁵. The metagene construction and binary classification tree analysis was utilized for additional feature selection and to build the CAD prediction model¹⁶⁻¹⁸. Affymetrix MASS data was used for this analysis.

Given the heterogeneity of the study subjects, we systematically performed feature selection from the discovery cohort prior to model building. Based upon prior experience with the binary prediction tree approach^{16,17,19}, we wanted to begin the model building with a starting gene set of around 3000-5000. First, we performed SAM on log 2-transformed data and found that a correlation score cut-off of ±1.5 allowed us to reduce the data set to 4,210 genes from the original 54,613 genes.

For the second phase of feature selection in the discovery cohort, we used the classification tree analysis to identify genes with the highest discriminatory power within the 4,210 individual genes. Following quantile normalization, we performed k-means correlation-based clustering to group the 4,210 genes into 300-500 clusters that typically consist of 5-50 non-overlapping genes. In order to use these gene groups in classification trees, singular value decomposition was performed using the expression values of the genes within the clusters to generate a single factor or metagene. The metagene is in essence a composite measure representing the aggregate expression for each cluster. These metagenes were used in classification trees to determine the metagenes that most accurately classified individual samples as minimal or severe CAD. At each node of the tree, the metagene was used as a threshold to partition the samples into the two classes. Each possible metagene combination was tested iteratively to find the metagenes that most accurately classified the samples. We performed multiple rounds of the classification tree analysis to identify different metagene sets and kept those metagenes that could classify the samples with ≧70% accuracy by hold-one-out cross-validation analysis. There were 10 sets of metagenes that met the classification accuracy criteria, with the final set consisting of 85 metagenes. We used these 85 metagenes to classify the discovery cohort with the classification trees using a hold-one-out cross validation analysis.

To adjust for systematic experimental error such as batch differences between the discovery and validation cohorts, each validation cohort was adjusted to the discovery cohort using the Distance Weighted Discrimination (DWD) method²⁰. Each validation cohort underwent quantile normalization using the same factors for quantile normalization of the discovery cohort. We then analyzed the ability of the 85 metagene predictors identified from the analysis of the discovery cohort to classify the subjects in each of the two validation cohorts as having either minimal or severe CAD.

### D. Approach for Classifying Subjects by CAD Burden Using Clinical Data

MatLab (MathWorks, Natick, Mass.) was used to generate multivariate logistic regression models to classify individuals into minimal or severe disease categories using only traditional risk factor data. There were missing values, especially those of systolic blood pressure and lipid levels (up to 20%). Missing values were imputed separately by polynomial linear interpolation²¹ for the discovery and validation cohorts from CATHGEN. Using standard forward stepwise selection, a model of discriminatory variables was built from the 16 clinical variables in the discovery cohort. This model was used to predict the coronary artery disease status in the CATHGEN validation cohort. We lacked sufficient variables in the second validation cohort to apply the clinical prediction model. Because of the variability in the imputation of missing variables, we generated 10 different sets of imputed data and constructed multivariate logistic regression models with each set of data. The final classification accuracy reflected the average of the 10 models.

### E. Approach for Classifying Subjects by Cad Burden Using Combined Clinical and Gene Expression Data

To construct a model that combined both clinical and genomic information, the classification probabilities of a subject having either minimal or severe disease that were generated from the genomic prediction model were used as variables in the clinical prediction model. The multivariate logistic regression model described above that generated disease status predictions from solely clinical variables were refitted to also include the genomic classification probabilities. As before, the models were built in the discovery cohort using now 17 variables, and then tested in the validation cohort. As above, multivariate regression models were generated using each of the 10 different imputed sets of clinical data but now also including the genomic classification probability as an additional variable. The final classification accuracy reflected the average of all 10 models.

### F. Descriptive Statistics

Microsoft Excel was used for descriptive and ANOVA analysis of subject clinical characteristics. Categorical variables were analyzed by Fisher's exact test using MedCalc statistical software. MedCalc was used to calculate model performance—sensitivity, specificity, overall accuracy, positive predictive value, negative predictive value, receiver operating characteristic curve (ROC) and the area under the ROC (AUC or c-index). Model performance was not calculated for the second validation set given the small sample size and the lack of full clinical variables.

### G. Gene Functional Annotation

Gene annotation was performed using: GeneCards, Information Hyperlinked Over Proteins (IHOP), GENATLAS and Ingenuity Pathways Analysis (IPA) (Ingenuity Systems, Redwood City, Calif.). To further characterize genes identified by this study, we also used the IPA software. We used the IPA software to determine statistically over-represented gene ontology terms within our candidate gene lists. As well, IPA was used to determine networks of genes that encompassed the candidate genes to highlight potential biological pathways as well as upstream and downstream associated genes.

### Example II

### Results

### A. Patient Characteristics

Table 1 lists the clinical characteristics of the discovery and the two validation cohorts. Male gender, prior coronary artery bypass grafting (CABG), CAD burden and medication use were significantly different between the subjects with minimal and severe CAD. Systolic blood pressure, lipid profiles, ejection fraction, serum creatinine, active tobacco use and diabetes were not significantly different. There was missing data for some of the clinical variables, particularly systolic blood pressure and lipids, however, the missing data were evenly distributed.

TABLE 1
Clinical characteristics of the discovery and validation cohort subjects

| | Discovery Cohort | | | Validation Cohort | | |
|---|---|---|---|---|---|---|
| | Controls | Cases | | Controls | Cases | |
| Age (yrs) | 56.3 ± 3.1 | 60.3 ± 2.4 | | 56.5 ± 1.8 | 61.5 ± 1.8 | NS* |
| Systolic Blood Pressure | 137.4 ± 5.2 | 142.7 ± 4.7 | | 139.3 ± 3.2 | 131.4 ± 3.3 | NS* |
| Diastolic Blood Pressure | 79.4 ± 3.5 | 73.74 ± 1.7 | | 75.7 ± 1.7 | 73.8 ± 1.7 | NS* |
| Total Cholesterol | 184.7 ± 11.1 | 181.6 ± 13.6 | | 191.6 ± 6.5 | 167.3 ± 7.5 | NS* |
| Triglyceride | 127.0 ± 14.1 | 196.1 ± 337.0 | | 169.4 ± 20.1 | 191.4 ± 23.8 | NS* |
| HDL | 53.4 ± 4.5 | 46.5 ± 3.0 | | 50.9 ± 2.8 | 43.9 ± 2.6 | NS* |
| LDL | 105.1 ± 9.9 | 101.5 ± 10.8 | | 110.7 ± 5.5 | 93.1 ± 7.3 | NS* |
| Ejection Fraction (%) | 49.1 ± 4.4 | 52.9 ± 2.8 | | 56.1 ± 2.6 | 56.0 ± 2.2 | NS* |
| Serum Creatinine | 1.6 ± 0.4 | 1.5 ± 0.3 | | 1.0 ± 0.0 | 1.3 ± 0.2 | NS* |
| Diabetes Mellitus | 22.8 | 32.7 | NS** | 18.5 | 36.7 | NS** |
| Active Smoker | 33.3 | 44.9 | NS** | 37.0 | 50.0 | NS** |
| Male Gender (%) | 0.48 | 0.67 | NS** | 0.42 | 0.74 | p = 0.002** |
| Aspirin (%) | 43.9 | 71.4 | p = 0.006** | 33.3 | 56.7 | NS** |
| Beta Blockers (%) | 21.1 | 61.2 | p < 0.001** | 25.9 | 46.7 | NS** |
| Ace Inhibitors (%) | 17.5 | 42.9 | p = 0.005** | 18.5 | 33.3 | NS** |
| Statins (%) | 24.6 | 55.1 | p = 0.002** | 37.0 | 60.0 | NS** |
| Plavix (%) | 1.8 | 24.5 | p < 0.001** | 3.7 | 23.3 | NS** |
| Any cardiac drug | 52.6 | 77.6 | p = 0.009** | 55.6 | 63.3 | NS** |
| LCX Stenoses (%) | 5.2 ± 2.7 | 74.1 ± 6.2 | | 2.4 ± 0.9 | 79.8 ± 3.7 | P < 0.001* |
| LAD Stenoses (%) | 8.0 ± 2.9 | 81.3 ± 4.4 | | 6.6 ± 1.4 | 86.6 ± 2.4 | P < 0.001* |
| RCA Stenoses (%) | 3.5 ± 1.5 | 64.7 ± 6.8 | | 4.7 ± 1.2 | 75,7 ± 4.6 | P < 0.001* |
| LM Stenoses (%) | 1.9 ± 1.3 | 24.2 ± 5.4 | | 2.3 ± 1.0 | 20.7 ± 4.4 | P < 0.001* |
| Left Main disease (%) | 0.0 | 10.0 | | 0.0 | 10.0 | P < 0.001* |
| 3 vessel disease (%) | 0.0 | 56.0 | | 0.0 | 46.7 | P < 0.001* |
| 2 vessel disease (%) | 0.0 | 18.0 | | 0.0 | 33.3 | P < 0.001* |
| 1 vessel disease (%) | 0.0 | 14.0 | | 0.0 | 10.0 | P < 0.001* |
| History of CABG (%) | 0.0 | 33.3 | | 0.0 | 33.3 | P < 0.001* |

*ANOVA
**Fisher's Exact Test

### B. Predicting CAD Burden Using Blood Gene Expression

Using the 85 metagenes identified in the discovery cohort, we correctly classified 80.0% (44/55) of the subjects in the Duke validation cohort as having either minimal or severe CAD with a sensitivity of 80.0% and specificity of 80.0%. The area under the receiver operator curve (AUC) or c-index was 0.81 indicating the model has good discriminatory value between minimal and severe CAD groups²². The positive and negative predictive values of the model were 82.8% and 76.9%, respectively. There were seven metagenes consisting of 69 genes that provided the majority of the discriminatory power in the classification. In our second validation cohort, the 85-metagene model correctly predicted the CAD status of 79.2% (20/24).

### C. Predicting CAD Burden Using Clinical Variables

In the discovery cohort, multivariate logistic regression models correctly classified subjects as having minimal or severe CAD with an accuracy of 84.1% by cross validation analysis. The models applied to the Duke validation cohort correctly classified subjects by CAD burden with a mean accuracy of 68.3%. The AUC for the prediction was 0.71. The second validation cohort lacked the necessary clinical variables for the clinical prediction model.

### D. Predicting Cad Burden Using Combined Clinical Variables and Gene Expression Data

In the discovery cohort, we generated multivariate logistic regression models that included the prediction probabilities for the presence of severe CAD from the metagene classification trees as a variable along with the clinical variables. The combined genomic and clinical models correctly predicted the classification of subjects by CAD burden in the discovery group with 100% accuracy by cross validation analysis. When the models were applied to the Duke validation group, the average prediction accuracy was 84.1% with AUC of 0.86.

E. Reclassification of Subjects with Intermediate CHD Risk

We simulated how a blood gene expression signature for coronary artery disease might be used to further stratify individuals classified as intermediate CHD risk by the Framingham Risk Score (FRS) using the subjects from the Duke CATHGEN repository. For the simulation, all of the subjects were assumed to be asymptomatic. We calculated a FRS for the entire CATHGEN cohort of 160 subjects and we were blinded to the coronary artery disease burden. If a subject was classified as having intermediate CHD risk and did not have characteristics such as diabetes, which would have automatically moved them to a higher risk category, we examined whether the genomic prediction model could be used to further stratify this group based upon the presence of significant coronary artery disease. In our total group of 160 subjects, we were able to complete the FRS for 108 subjects and 24 of them were classified as having an intermediate CHD risk without having higher risk characteristics such as diabetes. For these 24 subjects, the genomic prediction model would have elevated 10 of the subjects to a higher risk category because they had the blood transcriptome profile associated with severe coronary artery disease. For these 10 patients, when we looked at their coronary disease burden, all of them had severe coronary artery disease. The remaining 14 of 24 subjects would have remained classified as intermediate risk because they had the blood transcriptome profile of minimal coronary artery disease. Each of these 14 individuals actually had minimal coronary atherosclerosis. In the standard treatment paradigm, all of these 24 subjects would be have received the preventive interventions designated for intermediate CHD risk. By using the blood transcriptome profile, 10 of the subjects would have been moved into a higher risk category for more intensive preventive treatments while the remaining 14 would have continued to be treated as having intermediate CHD risk.

### F. Gene Expression Signatures Do Not Predict Gender or Medication Usage

Because we wanted the cohorts to be reflective of a general catheterization laboratory population, the clinical characteristics of the minimal and severe CAD subjects were not matched. Certain characteristics were overrepresented in the severe CAD subjects relative to the minimal CAD subjects, in particular male gender and medication usage. To evaluate the possibility that the genomic model developed was actually detecting male gender or medication usage rather than CAD burden, we reassigned the outcome groups in the validation cohorts by gender or medication usage rather than CAD burden. The predictive accuracies for gender and medication usage were 52.6% and 54.0%, respectively indicating that gender and medication usage were not the dominant characteristics driving the prediction. If these clinical characteristics had been the dominant effects within the predictive model, the classification accuracies should have mirrored the results of the CAD burden prediction.

### G. Predictive Genes for CAD Burden

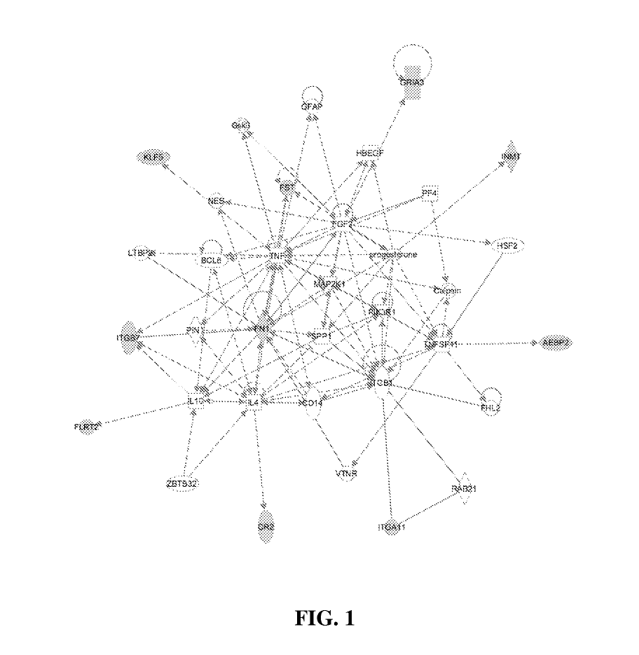

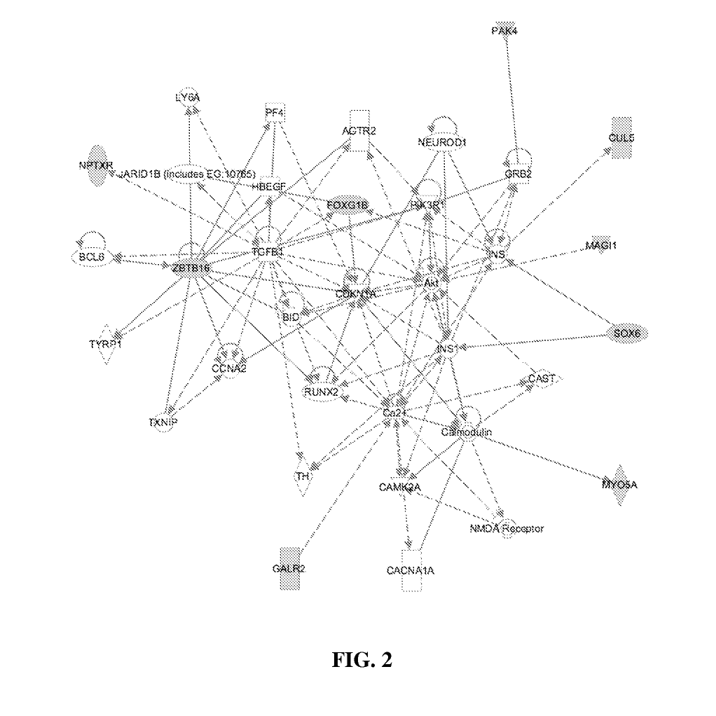

The metagenes that enabled the classification by CAD burden in the Duke validation cohort were derived from 69 genes (Table 2). The molecular and cellular functions that were statistically overrepresented, as defined by gene ontology terms, were: cellular movement, cell-to-cell signaling/communication, cellular assembly/organization and cell morphology. Pathways analysis using IPA identified two statistically significant gene networks within the candidate genes (FIGS. 1 and 2).

Gene network 1 is associated with cell growth and proliferation and cell-to-cell signaling. The association of these genes into this gene network over random chance was statistically significant (p value 10⁻²²) There are 10 genes from the candidate gene list in network 1 (FIG. 1). These include fibronectin 1, which is involved in numerous cell adhesion functions involving platelets and/or leukocytes²³⁻²⁵ and glutamate receptor precursor^{26,27} and integrin, beta 7²⁸, which have been shown to be involved in T cell activation. IPA identified key effectors in the same network that were not in the final gene list such as fibroblast growth factor 2 (FGF2), tumor necrosis factor (TNF), osteopontin (SPP1) and mitogen-activated protein kinase 1 (MAP2K1). Previously, we had described osteopontin as a highly ranked candidate gene in our analysis of aortic atherosclerosis in both humans and mice^{29,30}.

Gene network 2 is associated with cell cycle control. The association of the genes in this network over random chance was statistically significant (p value 10⁻¹⁹). There were nine genes from the final gene list in gene network 2 (FIG. 2). These included zinc finger and btb domain containing 16, which is associated with myeloid cell differentiation^{26,28}, and p21-activated kinase 4, which may be involved in T cell activation^{29,31}. Key effectors in this network that were not in our final gene list, but were identified by IPA, included Akt, phophoinositide-3-kinase, regulatory subunit 1 (PIK3R1), transforming growth factor, beta 1 (TGFB1) and cyclin-dependent kinase inhibitor 1A (CDKN1A).

The inventors have previously identified genes whose gene expression signatures could differentiate between minimal and severe atherosclerosis in freshly collected human and mouse aortas. Now, this new analysis shows that one can also identify genes in the blood whose expression signature can be used to accurately detect the presence of severe coronary atherosclerosis. The CAD gene expression signature was identified in a group of patients undergoing cardiac catheterization and was validated in two separate patient groups, one from the same cardiac catheterization laboratory and another from an outside cardiac catheterization laboratory. When integrated with traditional clinical risk factors in a multivariate regression model, the combined genomic and clinical information correctly classified patients as having minimal or severe CAD with 84.1% accuracy and an AUC of 0.86. These results represent a means for selecting subjects within the intermediate CHD risk for more intensive preventive medical therapies or additional diagnostic testing. In a simulation of how these results might be used clinically, we can consider the 24 subjects in our total study group with intermediate CHD risk by Framingham criteria. Our predictive model combining genomic and clinical data would have correctly stratified all 24 subjects—14 subjects would have remained classified as intermediate risk and receive the appropriate standard of care treatment, but 10 subjects would have been up-staged and reclassified as high risk.

From the foregoing description, one skilled in the art can easily ascertain the essential characteristics of this invention, and without departing from the spirit and scope thereof, can make changes and modifications of the invention to adapt it to various usage and conditions and to utilize the present invention to its fullest extent. The preceding preferred specific embodiments are to be construed as merely illustrative, and not limiting of the scope of the invention in any way whatsoever. The entire disclosure of all applications, patents, and publications (including provisional patent application 61/105,191, filed Oct. 14, 2008) cited above and in the figures are hereby incorporated in their entirety by reference.

### REFERENCES

1. Zerhouni E. Fiscal Year 2004 President's Budget Request. 2003.
2. Rosamond W, Flegal K, Furie K, Go A, Greenlund K. . . . . Disease and Stroke Statistics—2008 Update: A Report From the American Heart Association Statistics . . . Circulation. 2008.
3. Fuster V, Hurst J. Hurst's the heart; 2004.
4. Greenland P, Smith S, Grundy S Improving coronary heart disease risk assessment in asymptomatic people: role of traditional risk factors and noninvasive cardiovascular tests. Circulation. 2001; 104(15):1863-1867.
5. Rosamond W, Folsom A, Chambless L, Wang C, Communities AIARi. Coronary heart disease trends in four United States communities. The Atherosclerosis Risk in Communities (ARIC) study 1987-1996. Int J Epidemiol. 2001; 30 Suppl 1:S17-22.
6. Thaulow E, Erikssen J, Sandvik L, Erikssen G, Jorgensen L, Cohn P. Initial clinical presentation of cardiac disease in asymptomatic men with silent myocardial ischemia and angiographically documented coronary artery disease (the Oslo Ischemia Study). Am J. Cardiol. 1993; 72(9):629-633.
7. Pasternak R, Abrams J, Greenland P, Smaha L, Wilson P, Houston-Miller N. Task force #1—identification of coronary heart disease risk: is there a detection gap? J Am Coll Cardiol. 2003; 41(11):1863-1874.
8. Pignone, Fowler-Brown A, Pletcher M, Tice J. U Department of Health and Human Services 2003.
9. Jacobson T A, Griffiths G G, Varas C, Gause D. Impact of Evidence-Based” Clinical Judgment” on the Number of American Adults Requiring Lipid- . . . Archives of Internal Medicine. 2000.
10. Greenland P, Gaziano J M. Selecting asymptomatic patients for coronary computed tomography or electrocardiographic exercise . . . N Engl J. Med. 2003.
11. Jaffer F A, O'Donnell C J, Larson M G, Chan S K. Age and Sex Distribution of Subclinical Aortic Atherosclerosis A Magnetic Resonance Imaging . . . Arteriosclerosis. 2002.
12. Simon A, Chironi G, Levenson J . . . of subclinical atherosclerosis tests in predicting coronary heart disease in asymptomatic . . . European Heart Journal. 2007.
13. Friesinger G C, Page E E, Ross R S. Prognostic significance of coronary arteriography. Transactions of the Association of American Physicians. 1970; 83:78-92.
14. Field L A, Jordan R M, Hadix J A, Dunn M A, Shriver C D, Ellsworth R E, Ellsworth D L. Functional identity of genes detectable in expression profiling assays following globin mRNA reduction of peripheral blood samples. Clinical biochemistry. 2007; 40(7):499-502.
15. Tusher V, Tibshirani R, Chu G. Significance analysis of microarrays applied to the ionizing radiation response. Proc Natl Acad Sci USA. 2001; 98(9):5116-5121.
16. Pittman J, Huang E, Nevins J, Wang Q, West M. Bayesian analysis of binary prediction tree models for retrospectively sampled outcomes. Biostatistics. 2004; 5(4):587-601.
17. Seo D, Wang T, Dressman H, Herderick E E, Iversen E S, Dong C, Vata K, Milano C A, Rigat F, Pittman J, Nevins J R, West M, Goldschmidt-Clermont P J. Gene expression phenotypes of atherosclerosis. Arterioscler Thromb Vasc Biol. 2004; 24(10):1922-1927.
18. West M, Blanchette C, Dressman H, Huang E, Ishida S, Spang R, Zuzan H, Olson J A, Marks J R, Nevins J R. Predicting the clinical status of human breast cancer by using gene expression profiles. Proc Natl Acad Sci USA. 2001; 98(20):11462-11467.
19. Pittman J, Huang E, Dressman H, Horng C F, Cheng S H, Tsou M H, Chen C M, Bild A, Iversen E S, Huang A T, Nevins J R, West M. Integrated modeling of clinical and gene expression information for personalized prediction of disease outcomes. Proc Natl Acad Sci USA. 2004; 101(22):8431-8436.
20. Benito M, Parker J, Du Q, Wu J, Xiang D, Perou C, Marron J. Adjustment of systematic microarray data biases. Bioinformatics. 2004; 20(1):105-114.
21. Groth E J. Timing of the Crab pulsar. I-Arrival times. The Astrophysical Journal Supplement Series. 1975.
22. Ohman E, Granger C, Harrington R, Lee K. Risk stratification and therapeutic decision making in acute coronary syndromes. JAMA. 2000; 284(7):876-878.
23. Erle D J, Sheppard D, Breuss J, Rüegg C, Pytela R. Novel integrin alpha and beta subunit cDNAs identified in airway epithelial cells and lung leukocytes using the polymerase chain reaction. Am J Respir Cell Mol Biol. 1991; 5(2):170-177.
24. Ganor Y, Besser M, Ben-Zakay N, Unger T, Levite M. Human T cells express a functional ionotropic glutamate receptor GluR3, and glutamate by itself triggers integrin-mediated adhesion to laminin and fibronectin and chemotactic migration. J. Immunol. 2003; 170(8):4362-4372.
25. Ganor Y, Teichberg V I, Levite M. TCR activation eliminates glutamate receptor GluR3 from the cell surface of normal human T cells, via an autocrine/paracrine granzyme B-mediated proteolytic cleavage. J. Immunol. 2007; 178(2):683-692.
26. Koken M H, Reid A, Quignon F, Chelbi-Alix M K, Davies J M, Kabarowski J H, Zhu J, Dong S, Chen S, Chen Z, Tan C C, Licht J, Waxman S, de Thé H, Zelent A. Leukemia-associated retinoic acid receptor alpha fusion partners, PML and PLZF, heterodimerize and colocalize to nuclear bodies. Proc Natl Acad Sci USA. 1997; 94(19):10255-10260.
27. Seo D, Ginsburg G S, Goldschmidt-Clermont P J. Gene expression analysis of cardiovascular diseases: novel insights into biology and clinical applications. J Am Coll Cardiol. 2006; 48(2):227-235.
28. Reid A, Gould A, Brand N, Cook M, Strutt P, Li J, Licht J, Waxman S, Krumlauf R, Zelent A. Leukemia translocation gene, PLZF, is expressed with a speckled nuclear pattern in early hematopoietic progenitors. Blood. 1995; 86(12):4544-4552.
29. Abo A, Qu J, Cammarano M S, Dan C, Fritsch A, Baud V, Belisle B, Minden A. PAK4, a novel effector for Cdc42Hs, is implicated in the reorganization of the actin cytoskeleton and in the formation of filopodia. EMBO J. 1998; 17(22):6527-6540.
30. Kana R, Vemullapalli S, Dong C, Herderick E E, Song X, Slosek K, Nevins J R, West M, Goldschmidt-Clermont P J, Seo D. Molecular evidence for arterial repair in atherosclerosis. Proc Natl Acad Sci USA. 2005; 102(46):16789-16794.
31. del Pozo M A, Vicente-Manzanares M, Tejedor R, Serrador J M, Sánchez-Madrid F. Rho GTPases control migration and polarization of adhesion molecules and cytoskeletal ERM components in T lymphocytes. Eur J. Immunol. 1999; 29(11):3609-3620.

1. A method of screening a subject for the presence of coronary atherosclerosis, said method comprising,
measuring the expression level of at least 5 of the genes of Table 2 in a biological sample obtained from said subject,
wherein an elevated level of expression of said 5 genes compared to a control level measured in a population of normal subjects is indicative of an increased probability of the subject having significant coronary atherosclerosis.

2. The method of claim 1 that comprises measuring the expression level of at least 10 of the genes, wherein an elevated level of expression of at least 10 of said genes is indicative of an increased probability of the presence of coronary atherosclerosis in said subject.

3. The method of claim 1 that comprises measuring the expression level of at least 15 of the genes, wherein an elevated level of expression of at least 15 of said genes is indicative of an increased probability of the presence of coronary atherosclerosis in said subject.

4. The method of claim 1 that comprises measuring the expression level of at least 20 of the genes, wherein an elevated level of expression of at least 20 of said genes is indicative of an increased probability of the presence of coronary atherosclerosis in said subject.

5. The method of claim 1 that comprises measuring the expression level of at least 30 of the genes, wherein an elevated level of expression of at least 30 of said genes is indicative of an increased probability of the presence of coronary atherosclerosis in said subject.

6. The method of claim 1 that comprises measuring the expression level of at least 40 of the genes, wherein an elevated level of expression of at least 40 of said genes is indicative of an increased probability of the presence of coronary atherosclerosis in said subject.

7. The method of claim 2, wherein the genes are selected from at least 5 of the 7 families of the group consisting of metagene groups 32, 11, 67, 75, 10, 8 and 24.

8. The method of claim 1, wherein the probability of having significant subclinical coronary atherosclerosis is at least about 50%.

9. The method of claim 8, wherein the probability is at least about 80%.

10. The method of claim 9, wherein the probability is at least about 4 fold.

11. A method for determining a treatment regimen for a subject suspected of having CAD, comprising determining by a method of claim 1 whether the subject is likely to have CAD and,
if the subject is determined to be likely to have CAD, deciding to treat the subject aggressively for the CAD, and
if the subject is determined not to be likely to have CAD, deciding to treat the subject aggressively for the CAD.

12. The method of claim 1, wherein the biological sample is a blood sample.

13. The method of claim 12, wherein the blood sample is whole blood.

14. The method of claim 1, wherein the subject is human.

15. A method of data reduction for selecting a set of features (genes) associated with a specific condition, said method comprising the steps of
(a) Using significance analysis of microarrays (SAM) from data obtained from an experimental and a control group of subjects to select an initial set of features;
(b) Using binary prediction tree analysis to select additional features; and obtaining a set of features that is predictive of the condition.

16. The method of claim 15, wherein a feature is an expressed gene.

17. The method of claim 15, wherein the specific condition is a disease or disorder.

18. The method of claim 15, wherein the set of features is diagnostic.

19. The method of claim 15, wherein the set of features is prognostic.

20. The method of claim 15, wherein the data is obtained from blood.

21. The method of claim 20 wherein the blood is whole blood.

22. A kit for detecting the presence of CAD in a subject, comprising reagents for detecting the amount of expression of at least five of the genes in Table 2.


SEQUENCE LISTING (69 sequences)

SEQ ID NO: 1 - DNA, 548 bp, Homo sapiens
  modified_base (136)..(136): a, c, t, g, unknown or other
atatgtatgcacggatgtcactttttaaggccatattgcattgataacaagctaaaagcacaactaaaatttcacatgctaacgacaacttgaatgaactgctggggcagtggtatgtgcctttcaacttgataanttgggggacattttcatattgggagattaattctaagtatcttcatgttctatgactatagaaccatttgccaaaaaaaaaagcttttcttgctacaaaaaataagcaattttcttgagccttattgactttattacattttctgtttagcagcatttttcactgcaatgttaaaataaatatgacattgaattcgaactgtgtgtatgtcagtgganatcaaatcaaaagccactaacatggctgtctgtttcactggactgtcccatttgctggttaaaaggattggggcccaaatcctctggcctagcatttctcagtgtttgctattcagactgtctaaatacagcatgtgacaagctgaagaagccaaatctancagtcatttctgatttcattatattctccccct

SEQ ID NO: 2 - DNA, 450 bp, Homo sapiens
gacgggtgctcataagagatccttaacttgcccattttaatgggttttccagaagatgtgagaagccactttgttagcaaagcatgccaaagccatgccctgctccagacacatgtgagcccatttcctgctctttgcttaactgacaagctctcatcagtgcacctgggttaatttcacatcaggtacaggaatatgttctaaaggaaagctaattttataatagcaattcctgcttaataaccttcagcttcattgtttttgtgtaatctatcaacaaattatgttagttcaaggttctcaatgggagtttctaataaatagaagggatgtatagaagttcccctaattaaaacaattgtgaacacaatcttggtattcagctgtgtctccacccttcttaccattcaccacaaagtaattctcacttctggaagctgggttcatttt

SEQ ID NO: 3 - DNA, 346 bp, Homo sapiens
  modified_base (59)..(59): a, c, t, g, unknown or other
catggggatcagtgtgggctgtgctggtcaaggagggcttccagggagaggcaactganggattcactgcaattgttccttgagaagatgaggatcaggtcgggaattggaaacatctgagggctcaattcaacctggcttctaaaacgaacatggtgaacatagatcaactactgaacttcttttaacctctggcatcctatctgtgaattgtggggaggaaacagggtccacccgctgctgcacaagaggggtgtgtgcagaccgtcaccttgtgtctgctgtagcaggagacccctggccatgcgggactgaacccatgattgcagctgatcttactctgtct

SEQ ID NO: 4 - DNA, 273 bp, Homo sapiens
  modified_base (51)..(51): a, c, t, g, unknown or other
gggaggtcctcgcacatgaccttgtctggtagctgcagtttgtccctcgtntgtgccacactttgnaccancaccttcaacagctacctattgaggcccnatctaggtgctggtgcnatcnatggttctgtcttgacatctgggacagcaggctttcctggagcctcatgtacctgccttcccacacaagctcagaggagcagtttagcatttctcagtgactcggggtcaccctgggaacagtcatctttgtactttagaaaatggcagctg

SEQ ID NO: 5 - DNA, 158 bp, Homo sapiens
ggactctgtccgcttgggccagtttgcctccagctccctggataaggcagtggcccacagatttggtaatgccaccctcttctctctaacaacttgctttggggcccctatacaggccttctctgtctttcccaaggagcgcgaggtgctgattcccc

SEQ ID NO: 6 - DNA, 428 bp, Homo sapiens
ggttttacttctaatgcttccatcggaggacaacaatggttacattgacttaagatctgatgcaaatgtttaccttttggggtctgtcataccatgaagcaaacagacagaaaagaaggaaacagatggcacactgaaaattaggataagttaagaagaatgtaataagcggacaaccgacaaaggagggtgggaatgcagggcaaccgcaagggctcatacagtgctgggtgaggaggacccctgacgggagctgagatctttggtgaaggacacaactggtcagtacaaccctgcagggcaaggagctgcagaaacaactatccaaaccccacacctctccctcaccttgatctcccatgttccacttcggctgaaccaaaccaaaagccagagggcaaggaagccatgtgtgaaaactgtgctac

SEQ ID NO: 7 - DNA, 416 bp, Homo sapiens
  modified_base (234)..(234): a, c, t, g, unknown or other
gccccgtggtcactgaaaagccagaatgaatattcttcctttcggaataaaaattgagctgtggaagttttgtttgctttgatgaattacttccaggctgctgtttatttggagagcaaagctccccagctgcagggtgggtagaggctgcggtcactcccctcgtcaatgctggttcctgttcctgaggccgagagaactcctgacagcagagtgggcatatcttggtagttncagcttttcaagacagtgtggcccagtggggagagagcagaaaacctgggttatgctggctctgccatttatcagctgtgtaaccttgggcaagtgatacaacctctgtgtgcctcagtttcctttcctcacctgtccacaggggatcataatcttggccctgcatgccttacaggagcgtt

SEQ ID NO: 8 - DNA, 535 bp, Homo sapiens
gtatcctagtgacagcataaaccctagaggtgacagtctgtattattgcttttcgcttctcttttctgcttctgttgggagccagttttcttcttacgccgcattacagagagaacgtcaaatttagcagccatatctgccatagggtccaaataaagagacaataaaaacattattctctcttttttggatggaatactgcgtgaaatggttatccatacaaagatactttatgtagaatagaaaaaggaggccgggtgcagtggctcacacatgtaatcctagtgctttgggaggctaagccgggagcactgattgaggccaggagttcatgatcagcctgggcaatgaagtgagaccccgtctctacaaaaaaatatgaaaaaattagcgaggtgtggtgacacatgcctgtagtcccagctactcaagaggctgaggtagaggatcacttgagcctacgagttcaaggctgcagtgagctatgataactccactgcactgccgcctggatgacacagagagaccgtttcta

SEQ ID NO: 9 - DNA, 549 bp, Homo sapiens
tgagttacaacgggaccacgtcggcctaccccagccaccccatgccctacagctccgtgttgactcaaaactcgctgggcaacaaccactcctcctccaccgccaacgggctgagcgtggaccggctggtcaacgggggaatcccgtacgccacgcaccacctcacggccgccgcgctaaccgcctcggtgccctgcggcctgctggtgccctgctctgggacctactccctcaacccctgctccgtcaacctgctcgcgggccagaccagttactttttcccccacgtcccgcacccgtcaatgacttcgcagagcagcacgtccatgagcgccagggccgcgtcctcctccacgtcgccggcaggcccccctcgacccctgccctgtgagtctttaagaccctctttgccaagttttacgacgggactgtctgggggactgtctgattatttcacacatcaaaatcaggggtcttcttccaaccctttaatacattaacatccctgggaccagactgtaagtgaacgttttacacacatttgcattg

SEQ ID NO: 10 - DNA, 535 bp, Homo sapiens
ccttctctgatttcttcagcagggtcaaaagacagttactagcaatggggaatgcttgtcactgtggagaaagagttttgtatatgtctgataccgttgttataacaaaacaaatttttttactatagttttttgttttctacctgcacacccaccagaagagcacaaagcaaggccattgcaacaggcatttaaaaattattatcaaacatgcacatgcttgtacacacacacacacacacacacaaacaggggcatttgtaaaggtgtccctggaatgtaagatttataatgtttaaggcaaggtgaaggcattgccaagtgtgtgtcgctcataggactagtgtatattcactgaaagttaacctgatgatttgttattgtttgaaccatatgctgatttgcttctggtttctgtttagtgtgttctctctgataaggggctgaaagattctgcatcacacatcctctgagacctaccatgtcgcacactttgttaatgacaaacttcactctacactatacagtaccttgt

SEQ ID NO: 11 - DNA, 393 bp, Homo sapiens
aagtcagctaattgttatgtgtcatttctttctagattttgtagtttttgtttgtttgttttacattcaatgatttagaagatttggggcttattgtggtttcttaaatattataactctatttcaaaactattctgctatgttgagctatcttatttcatactgtattttaatatgttaggacagttctctccttacgactttcttttgcaaaaattttctagctacactcatttggatattcttcatgatgaactctgagataattttaacacattccaaaagacatatttttgagacttattagaattttgttaaagatactgatttatttccaaagaattacagaatctaatcttttcatctatgtatctctattgaagcatttgttta

SEQ ID NO: 12 - DNA, 314 bp, Homo sapiens
  modified_base (43)..(43): a, c, t, g, unknown or other
aaaatggcgcaaatgcaccccatctcccccgattcctgctggntgggcaagatggggaaatggcgcaaatgcaccccatctcccccatctccccatcttgcccaggaactccaagacatcaagatttcacgatttttaagacgtcaagatgctagcatgctaacaccatcacggttctagaactttaaaggtgtcaagattctaaagccttctggattctagaatcctgtagatgtcagcattctaaagtaccatcaggttctttatttactggattcattagttccaggattctatgagcctggtgtttagcc

SEQ ID NO: 13 - DNA, 534 bp, Homo sapiens
ggcatttccattccagagtgcatcacttcaaaccttacattcctgaggctgttcgtcgaaggcttctcacatctaaactgcagttcatttattgcagagccctgttcacatgggttctcagagacgttttcattctcgcttctcaccacgctggagatgagaactagatgtggttttctagatacagtctacatttccctttgaatctggaagtccggcttcaaggtgatccacaaacatccgagaaggaaagaaacttagaggtaaatgattcaatgattcttaaaacctgactgtggcactcttctccaaatacctctgttctcctccatatttctcagcccctttgaagaggcaggcccatgggatgaattctgaccaatggatttggctaagatttaagagccagtgcaccatccttcagctaactcttctctccacctgctgcaaggacataaacatttcaatggcacaaagatagagcaccttgaattgttactgcaaagaagacatcttttctggagagtcacccaa

SEQ ID NO: 14 - DNA, 392 bp, Homo sapiens
  modified_base (36)..(36): a, c, t, g, unknown or other
cctcctgagaacatgccctgacagaatgaccaatcntggtgtatgtgtgtagaatgattagattatccccaagcaaatatcagatacttgaatgtactaagatttctgggtatagtatactttgtcctccttcacaggcatcctcagaggtttggaaagtttnatataggatgcttgattagtcctttctgatatttgtaaacatttcccaataaagctgcatattcatctgtcctttaataaagcactattgaaatatgatgacatatagggaaagcctgtttgtgctctacaggcttgtgaaaaggtgctagaatcaaatacttgaaaatgagttgaaacatcagagacaccccataagccatatgtggcatgggcatctgaacctaatg

SEQ ID NO: 15 - DNA, 411 bp, Homo sapiens
  modified_base (118)..(118): a, c, t, g, unknown or other
ttaaccttacctgctttccaagagagattttatgttttcttggttttttttttttgtttgtttgtttgtttttagggtagggtcttgtagaatgcaatggtgcaattatagctcactncngcctccaacttctgggttcaagtgatcctcccaccttgttttttgttttttgttttgtcttgtttttttggtngagacagggttttgctgtgttccccaggctgctgtcaaactcctgggctcacccatctcngcctcctaaagcgctgggattacaggcacgagccactatacctggccaagattttatattttctaattgcttcacatactgaatggaaaatagcatgacagttataacagaagtaaagaaagtcacatgagagtccaccacctaaaatataacttcct

SEQ ID NO: 16 - DNA, 355 bp, Homo sapiens
catggaacatgcttaatctaaacaatgatttgttgttcacctgaaattcaaatttagctgggtgtcctgtatttcatctggcaaccctacttcagacccaggtgtaaggtacatggatgtgctttggtcaaggaataggccaaggcagagatccatgcctgcatgactcagtgggtttggtgcacaggcacacacctccacttgttatataacctgtttgtgtaagttcatacttggtctgagccactgttgtctgtaaaaggtaattgtcctgctaatgctgtacaggggctcttggggttcggctcagctcaacatggcttgacatggtgggcacactggcgcccagtaagag

SEQ ID NO: 17 - DNA, 492 bp, Homo sapiens
acaactccagtgcagtgccaggtgggcaggctcccactgttcacttgagacgctcctccccactcaggtggggacaggggacacactcgcagggcagggcattctggaggtgtgggtacaggtgaggggaaatgggaggcacagccaggagtggggcaggagggaaggccagtgcgtgggcaggctgaggagggaatatgacccccctcaagtccccaaagtggcaggcaagggaggggccctggatgaggtggcccctcatgccttggccctccccttgcagacatcgaaggcagcctttgttgcacccccaaaggcctccaccaacttgtcttcccagggaaggacgttgcccagcagtggcgcagtgcagttggcaatgcccaggacctgggctggtgtcagggcgtggtcccacaggttaaactgggcaatgtcaccgacaaaggcctgggtggcatcaaaccggccacccagggtatcctgggccaa

SEQ ID NO: 18 - DNA, 539 bp, Homo sapiens
gcaagggtctatgaaggtgtttcaggagatccaagcctttttagaatctgtgcaaacttctgtgtatgttttttggaggaaaagtccataaatttcaaattttcaaaaatcagattttcaaaaggatttattgatttctgaaaactagcaaagatctgcttttataaagagcaaatagatggatagatataggagaagatgcttgacttgatgaataagagaaaggacatatagaaaatgaactgaacataagcaagtattttattgaagatatactattttaaataacatttaaacacggaatgattggcaataaactgcaaaatgagtaatttggtatcattttaaaatggttattatcagagattttccttttattaaacagttattcattaattccacaaatatttatcaggcttctattatatgtgaggcactgagctgggcatggctgtaaaggaaccatctaggaagtaattatgcaatcatttctgaacctgtttcagaaaagtaaatcagtgttgggtttatcagtgttt

SEQ ID NO: 19 - DNA, 87 bp, Homo sapiens
acaccaaccagaacaccaccgagaagcccttccatttgaattaccacgtagatcacttggattcctccaatagtttttccgtgacaa

SEQ ID NO: 20 - DNA, 497 bp, Homo sapiens
agcagaggctggtgcaaccaatcacctcctttagtaagtttctccctgggcttcacctcttcacctgtgggctttccacctgtctctctctttttttttttaagacagtctcctctgttgccaggctggaatgccgtggcgcagtctcggctcactgcaacctctacctcctgggttcaagcgattctcctgcctcaggctcccaagtagctgggattgcaggtgcccgccaccacaccgggctaatttttgtatttttagtagagtcggggtttcaccatgttgcccaggctggtctcgaactcctgaccttacgtgatcctcacgcctgtaatcccagcactgtgggaggctgagacgggcagatcaccctggccagcatggcaaaaccccatctctactaaaaatacagcaattagccgagtgtggtggcgggcacctgtaatcccaactactcaagaggttgagacaggagaactgcttgaacccggaaggca

SEQ ID NO: 21 - DNA, 522 bp, Homo sapiens
ttgcgctatgcaactgtgctcaccactgaagtcattgctgcaatgggtttaggtgcagctgctcgaagcttcatcacccttttccctcttccctttcttattaagaggctgcctatctgcagatccaatgttctttctcactcctactgcctgcacccagacatgatgaggcttgcctgtgctgatatcagtatcaacagcatctatggactctttgttcttgtatccacctttggcatggacctgttttttatcttcctctcctatgtgctcattctgcgttctgtcatggccactgcttcccgtgaggaacgcctcaaagctctcaacacatgtgtgtcacatatcctggctgtacttgcattttatgtgccaatgattggggtctccacagtgcaccgctttgggaagcatgtcccatgctacatacatgtcctcatgtcaaatgtgtacctatttgtgcctcctgtgctcaaccctctcatttatagcgccaagacaaaggaaatccgccgagccatt

SEQ ID NO: 22 - DNA, 554 bp, Homo sapiens
  modified_base (72)..(72): a, c, t, g, unknown or other
tttggggaggtttccagctcagaatgatgcagaaatgataagactcaaagcaggggccaggccaggccagtnccttcgcctctcccggctgctggtgggcacggaggaaccagggcacatctgtggtacccagggacgtcccttgtcagcccgtttgccacacattgttcctcttgtccaggggagggtggaggagctgcttcccaggactggaggagcagctgggcccctgctgcacgtccggtgggacacacctgtgagccctccagagggagagtgcaggccccttctgagcctggtgttgcagggctccgctctctcccggaagccagggcacccagggcggaggctcctcaggccggggaggcggggagggtgccctgcatggagagagacgccggcgctccccgccttctntgatgctcacccctcccaggcccngttctccctggggtcccccgtttantagcccccctgcactctttgatatcttagtgtctgaggttgactgtgggtaaatctttaagacactccccagctgtgtttgtttataa

SEQ ID NO: 23 - DNA, 275 bp, Homo sapiens
  modified_base (70)..(70): a, c, t, g, unknown or other
gaaactattcagtggccacatgtacccagtaacagagggagcaaagcaaatcttatcctcaaagaactgncagctgcttgttagatctacctggtggttccatagagaaactgctcagagaacctgcctttacctcgcctaaaacagaactatcccggagctcagcaaaggagtccattcatcctctataactgctatacaatatctcngttaaaatgctgagaagatttatcctnaaaagaaggcaccaaagcaatggggttcatcaactcagg

SEQ ID NO: 24 - DNA, 342 bp, Homo sapiens
  modified_base (97)..(97): a, c, t, g, unknown or other
cacaaactccttccagtagaagcgcaggttctggctgcccccaatttctagcaggtccacctcaaagtccttggtgggcagacgcacggagttgaanccccaggtggggatgtggccttccagcggtggcttccccgacaacacgcgcaggaacgtgctcttgcctgcgccatccagccccagcaccagcacctcgcgntgttccagctcctccagcgccggctcctcgtcctcctcgtcctcggggtcccactcgtcccactcggggaggcgggcagcctccgcgccccaccaggcctctccccggtcccagcnccgctctcggccgcggccgaagtaggt

SEQ ID NO: 25 - DNA, 555 bp, Homo sapiens
ggtcagttgagtccttctgggaaccggggctatgaaaactttcgtctttggggaccggtacccatgaaggaaaactttcctgagggggtgaggaccaaagaatcaagatccttttcaggcctgatagccaagatgatgagaacttttagataaggctgtggggagagtccctggccttttgagcatcctgcttgggcacacggggaataacctttctccagcttccagtgtgaactgagaaagagaaagggaaaccctgtctttggagaagctgggatcttcccagcaccagaaacttctgcaggcccctgcctggcccacggctaacctttgggtgggactggagtttcctgaacagggaacaagggagccttccgcagagctctgatgggcaggcctccgagggcctgtgctgtgtgctgttaggatagcttggtgttgtctataccccattagtaagttttgtctgagtgtgtcctcgctgttcattgtctaatttggtaacatttattttggtcctgaccccttctgctgctgctgggtttaagcttcagt

SEQ ID NO: 26 - DNA, 503 bp, Homo sapiens
ttacagtgcagtttagttaatctattaatactgactcagtgtctgcctttaaatataaatgatatgttgaaaacttaaggaagcaaatgctacatatatgcaatataaaatagtaatgtgatgctgatgctgttaaccaaagggcagaataaataagcaaaatgccaaaaggggtcttaattgaaatgaaaatttaattttgtttttaaaatattgtttatctttatttatttgggggtaatattgtaagttttttagaagacaattttcataacttgataaattatagttttgtttgttagaaaagtagctcttaaaagatgtaaatagatgacaaacgatgtaaataattttgtaagaggcttcaaaatgtttatacgtggaaacacacctacatgaaaagcagaaatcggttgctgttttgcttctttttccctcttatttttgtattgtggtcatttcctatgcaaataatggagcaaacagctgtatagttgtagaat

SEQ ID NO: 27 - DNA, 471 bp, Homo sapiens
cagcaccacacttgtggctttccagggtttagcatctgtagatgctctcaagggctggccttgagtacttgtagctttttcaggctgagagtgcaagctgccagtggatctaccattatgatgtcaggaggacagtggttctcttctcatagctccactaggaagtgctccagtgggactctgtgtgggggctccaaccccacatttcccctccacactgccctggtagagattctccatgagggttccactcgtgcagcaggcttctgcgtggacatccagacttttccctgaatcttcctaaatctaggtgaaggtttccaagcttcaactcttgcactttgcactgcaatggtagtgcaggtccactgaaccatcaaagaccaggtacatgcctctgcctggtgttctcaactcatccaccagtgtggagctgtcatcccacttttcattacggtcatcatcgctgcc

SEQ ID NO: 28 - DNA, 426 bp, Homo sapiens
tttgcccaaactcacccagtgagtgtgagcatttaagaagcatcctctgccaagaccaaaaggaaagaagaaaaagggccaaaagccaaaatgaaactgatggtacttgttttcaccattgggctaactttgctgctaggagttcaagccatgcctgcaaatcgcctctcttgctacagaaagatactaaaagatcacaactgtcacaaccttccggaaggagtagctgacctgacacagattgatgtcaatgtccaggatcatttctgggatgggaagggatgtgagatgatctgttactgcaacttcagcgaattgctctgctgcccaaaagacgttttctttggaccaaagatctctttcgtgattccttgcaacaatcaatgagaatcttcatgtattctggagaacaccattcctgatttc

SEQ ID NO: 29 - DNA, 343 bp, Homo sapiens
ggtgaaagcttccttctaaactgccccaagtgttgaagtcttcactttattttgttctgttttgttttgtttttctgttttgtttgcaaaatggtaagggggtgtcgggggggatggggtgtattttgttgcaagtttgtgaggggaaaatgttttggtttgtttctactgacctgaatgtgttggatctacacgtgttgttttgtttttgctttattgatgcacggatgcttttgaacagtagagcgaaatgctagacatggagaatctgctctgtttgtcctttatacatttctgtagttaacagaacactgtaatgtgccttggagcttagtaacttgta

SEQ ID NO: 30 - DNA, 463 bp, Homo sapiens
catctcactcacatagacagtctctgggtaggcaggtggggggtgatacaagttcacactctgtgtttctcctcctgttagccattcccaccctgctgatgtttaaggaaagccagggatgatgacccacttaagctttccttggccttgttaagtccaatcatctggggcaggaagaagagaaatgctcattgcaatctttgacccccactaactgctgtggtgactttgacccaagcccttgacctccttttccttatctgaaatgttgctgtgattcctgtggtgagatcagatgaggcagcacttgggataagcttgcagagatgcattgagcggtatgaaagtacaggatgctatgtactttcctgcttcacagcacattttgtttcttgcaaggtgagtggcccagccgcctctccacaaacacgtgtttctgcctttctcagcataatcagcaaga

SEQ ID NO: 31 - DNA, 360 bp, Homo sapiens
ctccttatctgttctagttccgaagcagtttcactcgaagttgtgcagtcctggttgcagctttccgcatctgccttcgtttcgtgtagattgacgcgtttctttgtaatttcagtgtttctgacaagatttaaaaaaaaaaaaaaggaaaaaaaaagaaaaaatgaatttactgctgcaggtttttttctctctccatgtgtcactaagtgaagtttgtgccttctatagcaaagagaatattttttacatcctactaacagtagatttttttgtagtgaacattttttgtatttttatttataagtctcataagaaaaatagcaatgttcagttgtataccttgaatctgcagttaga

SEQ ID NO: 32 - DNA, 518 bp, Homo sapiens
  modified_base (41)..(41): a, c, t, g, unknown or other
gcttttacggtgatattgtgcatgcaaaccaggagcatttngtgtcttaagaaaaataatcttagaacagatggctgtgaaaattacacccatgcacagaacaagccacaggaataatagttcaggatttggtttttctctttttcttgtaaacctggagggttgatatattctttccatgcagttattagaacttagttttgttccaacagttaaacttgcaatgaaaagaaaatgtgccatttttttcactcagaattattcatagctgtatatttgaaactgctaattacacacgtgtgatgtatgttggttttttagtgcaatttcttctgtagctattctttgaccaaactgtgggtattgttaatattaatttatatttgtctcattttgtatgtatgtgtagtgtgtttgtgagtatgtgtggtttataatctgacaaagtcatgaagctcagtttggctgtaatttaattccccttcccttatttttatttatttttgtactgtgctgat

SEQ ID NO: 33 - DNA, 468 bp, Homo sapiens
tctgcagtgagtgcaaccgcaccttccccagccacacggctctcaaacgccacctgcgctcacatacaggcgaccacccctacgagtgtgagttctgtggcagctgcttccgggatgagagcacactcaagagccacaaacgcatccacacgggtgagaaaccctacgagtgcaatggctgtgacaagaagttcagcctcaagcatcagctggagacgcactatagggtgcacacaggtgagaagccctttgagtgtaagctctgccaccagcgctcccgggactactcggccatgatcaagcacctgagaacgcacaacggcgcctcgccctaccagtgcaccatctgcacagagtactgccccagcctctcctccatgcagaagcacatgaagggccacaagcccgaggagatcccgcccgactggaggatagagaagacgtacctctacctgtgctatgtgtgaa

SEQ ID NO: 34 - DNA, 547 bp, Homo sapiens
tctaccgtggaatgtccctggagtactatggcatcgaggcggacgacaaccccttcttcgacctcagtgtctactttctgcctgttgctcgatacatccgagctgccctcagtgttccccaaggccgcgtgctggtacactgtgccatgggggtaagccgctctgccacacttgtcctggccttcctcatgatctgtgagaacatgacgctggtagaggccatccagacggtgcaggcccaccgcaatatctgccctaactcaggcttcctccggcagctccaggttctggacaaccgactggggcgggagacggggcggttctgatctggcaggcagccaggatccctgacccttggcccaaccccaccagcctggccctgggaacagcaggctctgctgtttctagtgaccctgagatgtaaacagcaagtgggggctgaggcagaggcagggatagctgggtggtgacctcttagcgggtggatttccctgacccaattcagagattctttatgcaaaagtgagttcagtccatctctataata

SEQ ID NO: 35 - DNA, 354 bp, Homo sapiens
tagcaaaggacatggaagcctggaaagatgtaaccagtggaaatgctaaaatttaccagcttccagggggtcacttttatcttctggatcctgcgaacgagaaattaatcaagaactacataatcaagtgtctagaagtatcatcgatatccaatttttagatattttccctttcacttttaaaataatcaaagtaatatcatactcttctcagttattcagatatagctcagttttattcagattggaaattacacattttctactgtcagggagattcgttacataaatatatttacgtatctggggacaaaggtcaagccagtaaagaatacttctggcagcactttggga

SEQ ID NO: 36 - DNA, 512 bp, Homo sapiens
  modified_base (265)..(266): a, c, t, g, unknown or other
tggctgcgcagggagcacattggaaggggtcttggggtggacagaatttccttttgctctaagggtgaaaccagtcaggtctctctctttctgagctctcctcccagagcacctggtcaggatatcccagtcatcacctccgggaagatgatgttccctggatagcccatacattttctcacctccatacctagctaacactgctgcatcagtcccaatgaccccacttcccatcctttactctctgagatctggatttgccttnnagatgcaccccccatgccactttcttaaggtagtcttctcaactccccccaaagaatgaactattatttttggggggcttccaaagcaaattgctttgaaattccaaaagatcatacattctgttttaatcatagtgggttgttaagctcctgcactagactataangctacttgtggatagggactatgatttgtttatatctgtaacttccgtctcttgcctcttttccccagcatagagcaga

SEQ ID NO: 37 - DNA, 150 bp, Homo sapiens
aatgtgaacaacagcggcctgaagattaacctgtttgatacccccttggagacgcagtatgtgaggctggagcccatcatctgccaccggggctgcacactccgctttgagctccttggctgtgagctgagtggatgcactgaaccccta

SEQ ID NO: 38 - DNA, 457 bp, Homo sapiens
aggagggatgatcacttgggcccggaagttcaggatcatcctggaaaatatgtcaagacttcacctctaccagaaatttacaaattagctgggcatggtagaatgtacctgtagacctagctacttaggtggaagaatcacttgagcccagcagttcaaggtgacagtgaactacgatcaggccacttgattccagtcttggcaacagggtaagaccttgtctttaaaaaaataaaaagcaaaaaataaaatgctagttatattaggaaaaagcctgactgaggtccaaatgcatgcggaagactgtttcagcaaaggtaacatccctctatgccacagcttgattgaattttaaataaagatgatgataaaatgtacatttattaaggagataattgatgtaatgtgctcagtacaagttttggcatattacaagcattcaataaaccctacatct

SEQ ID NO: 39 - DNA, 322 bp, Homo sapiens
tgggcacggggagaggaaggcactcctctttaaggaccgacccagaggttttgccattgcttcactggccagagcttagtcacgcagcctcacccagaggcaagggaggttggaaaatgtagtgtttgtgtgtgtctaacacaaattctattaccatgcagtcaggattctccactcttgctctttcattagatttgctgggcttcaccctggactttctgatttagtgacagaacagagaacccagaggcagacccagatgtgtacaagggcttcatatacaatcaggagatttaataatcatgctaggggccgggtgcag

SEQ ID NO: 40 - DNA, 451 bp, Homo sapiens
  modified_base (202)..(202): a, c, t, g, unknown or other
gagggttttctctttaatcacaacttaaaaaaagaaacctttaatacctctgcataagttctctgaaagaacttaaattcttagtttatatgaaaactgatatgtatgtctgtgtaacaaagcctgttgggtacaggtctacaaggagatactttgtttctaaaaaaggagttaaatcgtgtcacctgaatttttttttttngagataagtggacattttggggattttggttaaaacatatttctctattctaaaaattacagaatatgtattcataaaagggaagaaattgttagaaaatttcctgtgtacgtagtttgnnnnnaaantaaagaatcttgtgacctggnnnaggacattttgcatttgtaacactgcagttttaatatatttgctgttttttttaaaattagaatatgtttaaaatttaatggttatgaggctctgtag

SEQ ID NO: 41 - DNA, 500 bp, Homo sapiens
atttattggattctctgctgcctgatctgtacatacatgatccctcgggttttgtttacaaggaaccttgactgaccaaaaggcattataactctgactcaaatacaaggtacagaagataagcatctttgaggaaactcctacttcagttcttttgttatgatgaagacatttgtgagagaggagatgattagaattctagtaatgtacttttaagatgttacagatacaaagaaatgatgtgggtgtcaggagactaaaggatgttgaaggctacacattcaaccttttgttaggtgtttcctttaagctactcagctgtaccttttaaattagttctttttcaaccagtatatcactaaaagttatatcaaagctttatcagttcaagtttcttgcttttcataatacttttttctgatgcaattttatattttcaaacatggcaagttaaaatataaattcatttaaatatatagttttgtacttttctaccatgt

SEQ ID NO: 42 - DNA, 479 bp, Homo sapiens
atgacacaatccctggggctgtgcattcccacgtcttcttgctgcagcctgcccctagacatggacgcaccggcctggctgcagctgggcagcaggggtaggggtagggagcctcccctccctgtatcaccccctccctacacacacacacacacacacacacacacactgcctcccatccttccctcatgcccgccagtgcacagggaagggcttggccagcgctgttgaggggtcccctctggaatgcactgaataaagcacgtgcaaggactcccggagcctgtgcagccttggtggcaaatatctcatctgccggcccccaggacaagtggtatgaccagtgataatgccccaaggacaaggggcgtgcctggcgcccagtggagtaatttatgccttagtcttgttttgaggtagaaatgcaagggggacacatgaaaggcatcagtccccctgtgcatagtacgacctttact

SEQ ID NO: 43 - DNA, 447 bp, Homo sapiens
  modified_base (107)..(107): a, c, t, g, unknown or other
gtgggcctgagtcgcagatcagaaagcaccgggaagatgcaggcctgcatggtgccggggctggccctctgcctcctactggggcctcttgcaggggccaagcctgngcaggaggaaggagacccttacgcggagctgccggccatgccctactggcctttctccacctctgacttctggaactatgtgcagcacttccaggccctgggggcctacccccagatcgaggacatggcccgaaccttctttgcccacttccccntggggagcacgctgggcttccacgttccctatcaggaggactgaatggtgtccagcntggtgcccgcccaccccgccaggctgcactcggtcgggcctccacaggcatggagtccccgcaaaaacctggcccctgcaggagtcaggcctggtctcacgctcaataaactccggactgaagatgca

SEQ ID NO: 44 - DNA, 423 bp, Homo sapiens
atgtagttgtctaccacttcctagcacacctgggctgcacaaatatgtgggtctgatataatgtcagaaatgcaggaagctatatgagattccagccctctatttttccaagtgtaaaagaacttatgaatcaagagccgaataaaaaacatagtactctttctgataatctgtcaacaaatttgcaatcatgtcaggcatgttatatgattacgaattgctcaatgctattatgaaaagtattttcaacaagtgaaacttctggagttctctgcagttctgggatcaaacctcagtgccttgtcctaacgtcccattaggacagaagtgcccttcctgagagtatggcagcataatgacattctagcacctggaccgattacactgctctccctgaagtagtggattctttcatcagcagga

SEQ ID NO: 45 - DNA, 447 bp, Homo sapiens
gtgtctgtacttaatgtgtctactttgagtaatatttcatctacatacaagcagatattgtatgtttagtgtacatatatttaatttctcctcttttacaaaaatggtagcacgcaatacccattgctttctatttttttttatttaacaatatcttggcaatctttctgtatcagtatataaagtgctattctctttttaaaaaaaaaaagctgtatggatcttctataatttgtgtaaccactaccatattgatagacattttacttttcgatttcactaggcatgcctggcccatattgctctacaggttgtgcattgcacaagtccaagcagtgtcattcacatggaccacagtgttaatagtattccaagtcatgcttggaaccctgcacttggggaaatatcaaaaactttaatcattcaaaccatggattcacaggcaat

SEQ ID NO: 46 - DNA, 267 bp, Homo sapiens
  modified_base (93)..(93): a, c, t, g, unknown or other
gaggagcagagggcaaactacgttcccattaaagccacaaggtttaaaaacctctaaccttggaaaagcacacttcaaccctctgcacaccanacttctctactgtggtttcccctctgccnctttctccttggcgttccccnatcactgcctctagggtctttacaagggacagcgaacgtaaggtttcggagctggcttcgcccccttctatttaccgggggctggtcatccttcgggccaggctgactgtctaggggtggccct

SEQ ID NO: 47 - DNA, 314 bp, Homo sapiens
gaccgaaggcagctttggtgactccacttctttttaaagtcaccctcctctgccctctgactttaagtgacaggcagttccctcccctctctttcaattctgtaaaatggggataatccggacctcatgcccccagagccttgtaaggaccggctaatgagggcaggcgagtgggaaacgaatcgtctgaacaatgatcagtcattctttcgggcttgcaaagagggtaaaaaaggttgggtctttagcggggtccgtagaaggctttgaagacgaaaagtgctgtagaggtgctaagcagcagccaacggacc

SEQ ID NO: 48 - DNA, 392 bp, Homo sapiens
gattggtcatttctgaagcaacacagacttgtacctgtatcagcaatgtttaccatgctcataatcaaagacgtatgctagtttggaatgagctactaggctcattgtatcagtgtccaaaataatgaagatttatctgtcactgtgccaccaagagtccaactcactggctactttgagaaagaacatggtgcactatttgcttcacactcaagaagttaatatggaaccttaaaaattggaacggaaactaaaacaaattaaggagatccttcagagattttaaccttatattttgtctctgcgactataactttgtaaataaccataactatgaataggaataaagatttaaaaataagttatcagacattctcaaccttgtttccaag

SEQ ID NO: 49 - DNA, 413 bp, Homo sapiens
gagcctttgtctggtgaacagttggttggttctccccaggataaggcggcagaggctacaaatgactatgagactcttgtaaagcgtggaaaagaactaaaagagtgtggaaaaatccaggaggccctaaactgcttagttaaagcgcttgacataaaaagtgcagatcctgaagttatgctcttgactttaagtttgtataagcaacttaataacaattgagaatgtaacctgtttattgtattttaaagtgaaactgaatatgagggaatttttgttcccataattggattctttgggaacatgaagcattcaggcttaaggcaagaaagatctcaaaaagcaacttctgccctgcaacgccccccactccatagtctggtattctgagcactagcttaatatttcttcac

SEQ ID NO: 50 - DNA, 470 bp, Homo sapiens
gtgtgcacacactcagggcagtgctgacatgccagccccctgccgtctcagccctctccagattttgggcactgatgagcataggaatgaagctgaggaggaactgagggcagcttggcagtggcctgcagacgccccttggtacctatagcctgggcgccatgaatggcagcaggaggcagacaggtttctgggcagaagggggtgagtccctggtgaggcccaccttcaggccagggaggccctgaaggctgggggccaggctgtcagtgccgtggactggagtgcgaacttgtgttgccttttctgggcctgcccatggccgcccatggaccagtcagcatgaacttccccctctctgaggctgacagaagccccaggctcagccagagctgagcagacgtcggatgaccagctgtagtgaggaactgccctctccagggcctcctctgagctattgtcactcaata

SEQ ID NO: 51 - DNA, 414 bp, Homo sapiens
agtaacaggcatgctttctgtccttctctccttttagattgtaagctacccaaagtccatctccatgggtttttttccttatgtgcaaactaccatatgacaggtgtgcctgacaataactcaggtatagctgagaatgatcctgtagtccaagaatgttggttctgagctctgaactaaggaatctgggagctgccaacccagaggtttactccttatctatggagcataggtgaacccctggcccatttcttggaacagcatgtgcggggaaccaaggccctttgttttgagctaggtggaggtggccaggtagaggtcgccaggaagaggtggccaggtggaggttgctaagcaaagattgctatattaactgggtgctttttagaaaccatagtggttaccccattcatc

SEQ ID NO: 52 - DNA, 478 bp, Homo sapiens
acgcagatggctttgatcctcagggtggcagaattccaaaatgtcctttcccagaagatcctaaataaaagagacaagctttaataatcccagatccatttgtaattatttgtatactcactgtgatacaacagtgttcatttccatctcctttaactcatctcctttagcctgtcccaccccagattttttgaaaaagtgagtgcaaaatttccctgggagccgtcagagaactggcttcttggtattcactctaagttcttctggcatgctcaatatccatttctaattttgctaaggcactacatcagtagcttcagaatgcaattttatttttgtttgtcttggagaggcaaactgcaataaacatactttaataacataaaaagaaagcaaaatgatagcctgaggacagatgtgttgcttatgaaaactggaattgtttaaatgtggaaattgtagctctcctgtggctgaa

SEQ ID NO: 53 - DNA, 493 bp, Homo sapiens
aaaactatgctcttgtatgggtggtaggacacttggtgttcaggcagctctggggcagaggaaaaacggtacagggtaattgtattttatggctgggataataattctaagttttcataattagagacaacttctgcaggccagaatttgtattaactacttaaactagagcttccatgtgacaatagggaaaacaaaacttgtaattcactaaccagctttgaaattatgcaatatttgatgattgttttaattcagaagaatgtatgttattactgatgcctcacatagagggagatgttattaatatttttatttatgtcacactatttcagataagtataattttaaaaatcccataaagtgtgactacactgtatttctaatcttgaaagatattatttaattaaaatagatgcattatggttggaaatcaagaaaatctttatcttacatccctggttacattgtacctagaagtgaccctcaaatt

SEQ ID NO: 54 - DNA, 315 bp, Homo sapiens
  modified_base (222)..(222): a, c, t, g, unknown or other
aaacggaaagtctctcatcctgtcctgtcattgcctagggtggagaaacagaagtggaaggtttgtttcaggtcctctgaggataattagtccattgcagtagttttacttgatggtaccccatgggccagaagagggcatacttaaccttctagagagcctgaagtagctcctgatcacaccttttcaaggtaaagtgaagagcatgaaattttggacagngtttattgntggacntttaaagtttgtgatntgcggtaacaaggagaagggtttttaagtttataaaaattatttatcaattagccgggtgtg

SEQ ID NO: 55 - DNA, 412 bp, Homo sapiens
gcataatgtactctatctgcgatattagcttctcggtcttgcagtgttgcctaacacacacagtgatcagcacattttttgagactgcaataatcagaggaatgtaacagtgatgtgggaacaagaggaaataacatggaataataatgtacccatcattgttctgttgtcatccctcctagccagtttggtttcccttagagcctaacaaaagcttcacgaattcaatggaataaaacatggaactgggtgcaaaattaatacatctattcccaagctccatattcatagaaaaaaggaaaatattgactacatagggaacagactttccctgaaagctttgtggatctatgcatatgcttatgtaatcttcaaacaagttgtgcagccttttacaaatgtgtctagcctc

SEQ ID NO: 56 - DNA, 429 bp, Homo sapiens
agctgggtctgaggagccaagcagaaaaacttcccaaaatcactgggtggggaggggtcagagacttactgctgccccagctgttctgactctgcccccagcttttggccccacccttttaaagcaccttcagaggttcccaatggtgacagtaaacaagtctccactgtcctggccatctctgctgtgttcaccctactcctgatctttctggctgctcagggactgacagccaagatgtgaggctgtgatgagcaggaacagggaggcctggagcccccagccattgtcatcacttccctgatctgcctaaattctgcccagcagtccgtgaaaatggtttgctgatgacatatgtaaggactttaactcccctcaagcaatctgctcatctcaaagggtaaaacattggctcactcctaatgcaat

SEQ ID NO: 57 - DNA, 473 bp, Homo sapiens
  modified_base (69)..(69): a, c, t, g, unknown or other
gctctcaccgtctggttgattcggacgtggttgcactgtcctggatcctcagccttaccctccctcttntcaggaccctcacactgggattcgtnagaaatgtggaccccaggagggagtgaagagtgttcaagggtcacggtggaagacaggctctatgggaagagagcgagtggataaccacgtgaaggcagaaaaggactccaaccccaccttatgtcctctccaggtgttcccaattctgccagcaccctgccctctgccacctggggctccttccattctgcccagtcgaggcatttctggagggaggacccgtgagaaccttgcatagaacatacaggatccagaggcctctaatacagcatttcagtgcagctgccagcaagggccactgagggtcacaggctggccaggtgctgtaaatgtacagagaccatgtttgtgaagccccacatcaggacacataacct

SEQ ID NO: 58 - DNA, 473 bp, Homo sapiens
cggcgcgccaagcgcaaggtgacacgcatgatcctcatcgtggccgcgctcttctgcctctgctggatgccccaccacgcgctcatcctctgcgtgtggttcggccagttcccgctcacgcgcgccacttatgcgcttcgcatcctctcgcacctggtctcctacgccaactcctgcgtcaaccccatcgtttacgcgctggtctccaagcacttccgcaaaggcttccgcacgatctgcgcgggcctgctgggccgtgccccaggccgagcctcgggccgtgtgtgcgctgccgcgcggggcacccacagtggcagcgtgttggagcgcgagtccagcgacctgttgcacatgagcgaggcggcgggggcccttcgtccctgccccggcgcttcccagccatgcatcctcgagccctgtcctggcccgtcctggcagggcccaaaggcaggcgacagcatcctgacggttga

SEQ ID NO: 59 - DNA, 519 bp, Homo sapiens
cctactctcaataaatggccaatggatgttctctaaacaaaaagagaattctaaaacaataccaaaattctaaaaaaaaaaaacaaccaacaaaaacaatgaggaaaagagaagaatggagaaagtaaaactatagataaataaaatacttttcttcatcttttgagttttcttttttcccatttttattgagatataattggcatctctttaaattttccaaattaggtttgagtgttgaagcaataatagtactgtttaatgtttctaaatgtgtgtagagagaatatttaaggtaattcattataagtgagggagggtaaaagaatatcaatggagataaggtttatctacttcagtcaaagcggtaaaatgataatgccagtagactataagatatataaaatatatttatagattatatatatatatataaaatgtgtgcatatatatgtaatgtagtacctaaagcagccacttaaaagctatacaaaggagatatactcaacagtactgtag

SEQ ID NO: 60 - DNA, 429 bp, Homo sapiens
gctttgagcctcttcggttttccggccagacccggaaaaacgaaaacacagcttggggagcccccactagccggcgcctgtgccagctcacctctggccatggcgcagctgccggtgcacacggcggccaaggccagctccacattcttccctccccctcccacttcaccgtagccccgaaccctgcgcgcagagaaagggtctcagctccacagacgactgggtccctcctcaccaaaaatggtgagacaagatttcatctgtcggccgaggagccacaagcaggtttgtctgagagggatggtgctgggggaaggctttggattgcatctcaaattaagctttgctccttaaatgtggcgctctcgccaagaaaaagcttggggcctgaattcttgagatttatggtgcaccttattgatcaaattt

SEQ ID NO: 61 - DNA, 242 bp, Homo sapiens
ccacgtcacgtgacgcgagggcggggacgcgctcgggagcgagcgtgggagcctggaagcctcggtgggtcccgaggctgcagcgaggccgggaccgtgccctctgctggcgggacctggcgttttccggcaccccgccccaaatcccggactcggtgttaagggaggtgcattgtcctgaaatgcttacaacagctgtcttcaataactcgtgcatagaatgcgcccagtaaatatgtgtt

SEQ ID NO: 62 - DNA, 505 bp, Homo sapiens
  modified_base (27)..(27): a, c, t, g, unknown or other
gacgactgatcgtccaaggactggcgncggatccaacacctttccccagctctgcgcgtancncgctntttggnaancgaattggtccctgtctgcttccaagggtccnnggaaccttctgncagctgtgcctctccagagctccgcctcattagtgccacgttcctggtttgaaaaccatagtacttcaacctcttctagatgggagttaacctttgccctctgaaagaaaggtttgataagcaaagagagtttggtgagcaagatccttgaggtaagagctgatctctgacgtccgctgggaactggcngctctgcaggtttctgtatcacattttctgcacatgtccattagaattggagatggggcgtatctagtgttgaataaaggcccggcagnncctcccagatgcaccctgtcnnananannnnannnnnnannnnnnanaaannacttgactcattcttggtggcgaccaccccacccacaggcacctaaaatgaa

SEQ ID NO: 63 - DNA, 444 bp, Homo sapiens
ggtacctaattactagttacacatacatggctttgatgggaaatcaaagaaacattctgacaatacagagattcatcaagcaatttgtctttgaaagttgattattcaaaaacagagcttgtagcaaaagaagcagaagttagatcccacagtcatcaagtttcagatcctaaggcttgcattcttacaccaatttcttctttgcttaaatcttaattttcatcagcattaattaagtgtctgggtactctgccagtcaggagagatgttaccaaaggtacaggatttgagaagtattgtcagaagagccaagttcataatcaggcccataggatcaataatttgggggagtgtttagagcagtttcaaagatgagagcagtagatcaaagtagaatttcaggactgagcacatgccaaggcacccttttatggatattcaacc

SEQ ID NO: 64 - DNA, 338 bp, Homo sapiens
ttccttccaaatttactttgataatatataaagataggagtagcacctctggctaaacctttttttcatacccacttatttccttagaatagatttctagaattactaaagataagtgcatgagcatttaatatacttgataactattgtcagatgacttgccaggaagtttgttcttagtaatatttaatgtactgggatatgtcgtgtttctcaaccccttttcctgcttcattgatttgcctgttccattacaaaccactttgtgtttaattaatacctttatgttattatatctggtagggcaagaattcacactacaattttataggactttc

SEQ ID NO: 65 - DNA, 404 bp, Homo sapiens
  modified_base (144)..(145): a, c, t, g, unknown or other
tactaaagttgacctgggatcacaggcgtgagccacggcgtctggcctatttcccttttaagtaaatatctgggtaggtggtctgagaatagtctgatgtgaaagaccttggctcccagaaactggtacatgatatttctcacnnctcattggccnagaaaacagtcacatggacaggtaacagcaaacaggcntaggaaatgcaatcnttgattatgaaaggccnatttaaccatctaaaattggggtctctaacaaaacagaagagggcaaaggattttgagaaaaactaactgcagtctctaaatatgtaggctcaatcattaccttccttttccaaatgaggaaagtgagacatagagatgttaagnntcatgcctggcattgtacaatattcccttccg

SEQ ID NO: 66 - DNA, 288 bp, Homo sapiens
catgttagtgtcatctctattagatgctttggagcaaacatgaacttgggtttccttttaagatgtcctgtgattccagattcaggggaatctgagaaaagtttgaagaaagaaaattccactcggccagccaaccttgggtgtgcagagcctgccccgccttccccactttgtcctgagaagctgggtcctccccagcaccagagttgctgctgcttcccctcgcgctcttggctgctctcccggccccaagcctgagtgacactctaggattgcagatggcaggct

SEQ ID NO: 67 - DNA, 519 bp, Homo sapiens
  modified_base (103)..(105): a, c, t, g, unknown or other
gaagcagcccacttggtggggttggggtatgagtccttcctcgcgggggctcggtgggtcctgagtattctttggccggatttgctgatccgtctgctccagnnnagnttnnnaangnncnnnnnnnaggccnncannnncntntgnnannntaggaaaaaaccagccctactgagtcagaaactggggatgtggcccaggcaatcttttaccaagacctccaggtgattataatgcaaggaaggattccctatcttggacctgaggctgctttcttgaagaaaacttgactttatttcatttagtgggaagagcagcagcccagctattaagttctaatatgcaataggctgcaggctgtgaagtgttcgtggcagtagactctgaagctaaggagctgagggcttaacaagtttctagaagctgccatcaacatgccaagtcagtaaaactgatagttgatcagatttcaaggtctggggagtatatccactgtgtactgggtcttgagctctagag

SEQ ID NO: 68 - DNA, 276 bp, Homo sapiens
  modified_base (80)..(80): a, c, t, g, unknown or other
acataaatagccagaggacttgcctgggccgtacataggggaattcacatgatcagttttagtatatactgtcaattttnccaaagaggttgtaccaatttacttcccagcagctgtgcagaagcattagtagagtttcagttgttnccacgcccttgtcaacgctttgtgcccttgacctttacaacactccattttaaagatgagtgtgtagatgttgaaaagtgcacaaggggaatgtttgctccatgagccaatcacggaaggaagctgggc

SEQ ID NO: 69 - DNA, 370 bp, Homo sapiens
gttgtatttccatcagcacatcgattttaagatattttcctcactccaaaaagaagcctctccctctcagctgtatctccagtccctagaatggtactgagtcctgtgggtactcggtgattttgcagctactgctgcagggacgaaggggaaactgcatgggaaggcatctcctaaacatgaccagttattggtgtcaccattccctttgcttcaccaacttgatcttcttcagatccttttcttctgcttcggcatcttttcattgtcatcattttatcttcatcactatcatcaccttcactgcttgtttatcatcatctttgtcattttcatctttttcttcctcattatctttccatcatcttta